(19) United States
(12) Patent Application Publication
(10) Pub. No.: US 2019/0066724 A1
(43) Pub. Date: Feb. 28, 2019

(54) SUBSTRATE FOR A MAGNETIC DISK

(71) Applicants: UACJ CORPORATION, Tokyo (JP); FURUKAWA ELECTRIC CO., LTD., Tokyo (JP)

(72) Inventors: Toshihiro NAKAMURA, Tokyo (JP); Takashi NAKAYAMA, Tokyo (JP); Kimie IMAKAWA, Tokyo (JP); Wataru KUMAGAI, Tokyo (JP); Sadayuki TODA, Tokyo (JP); Kotaro KITAWAKI, Tokyo (JP); Takuya MURATA, Tokyo (JP); Yu MATSUI, Tokyo (JP); Makoto YONEMITSU, Tokyo (JP); Hideyuki HATAKEYAMA, Tokyo (JP)

(73) Assignees: UACJ CORPORATION, Tokyo (JP); FURUKAWA ELECTRIC CO., LTD., Tokyo (JP)

(21) Appl. No.: 16/171,005

(22) Filed: Oct. 25, 2018

Related U.S. Application Data
(63) Continuation of application No. PCT/JP2017/016563, filed on Apr. 26, 2017.

(30) Foreign Application Priority Data
Apr. 27, 2016 (JP) 2016-088719
May 13, 2016 (JP) 2016-097439

(51) Int. Cl. G11B 5/73; C22F 1/04; C22C 21/00; G11B 5/84

(52) U.S. Cl. CPC G11B 5/7315; G11B 5/84; C22C 21/00; C22F 1/04

(57) ABSTRACT

An aluminum alloy substrate for a magnetic disk, wherein the sum of the circumferences of second phase particles having the longest diameter of 4 μm or more and 30 μm or less in the metal microstructure is 10 mm/mm² or more.

### CROSS-REFERENCE TO RELATED APPLICATIONS

This application is a Continuation of PCT International Application No. PCT/JP2017/016563 filed on Apr. 26, 2017, which claims priority under 35 U.S.C. § 119 (a) to Japanese Patent Application No. 2016-088719 filed in Japan on Apr. 27, 2016 and Japanese Patent Application No. 2016-097439 filed in Japan on May 13, 2016. Each of the above applications is hereby expressly incorporated by reference, in its entirety, into the present application.

### TECHNICAL FIELD

The present invention relates to a substrate for a magnetic disk.

### BACKGROUND ART

Magnetic disks (for example, magnetic disks made of any of aluminum (Al) alloys) that are used in storage devices for computers are produced using substrates having satisfactory plateability as well as excellent mechanical characteristics and workability. For example, magnetic disks are produced with a substrate based on an aluminum alloy according to JIS 5086 (3.5% by mass or more and 4.5% by mass or less of Mg, 0.50% by mass or less of Fe, 0.40% by mass or less of Si, 0.20% by mass or more and 0.70% by mass or less of Mn, 0.05% by mass or more and 0.25% by mass or less of Cr, 0.10% by mass or less of Cu, 0.15% by mass or less of Ti, and 0.25% by mass or less of Zn, with the balance being Al and inevitable impurities).

Common production of magnetic disks has been carried out by first producing an annular-shaped aluminum alloy substrate, subjecting the aluminum alloy substrate to plating, and then attaching magnetic materials to the surface of the aluminum alloy substrate.

For example, a magnetic disk made of an aluminum alloy based on the JIS 5086 alloy is produced by the following production process. First, a raw aluminum alloy material containing predetermined chemical components is cast, the ingot is hot-rolled and then subjected to cold-rolling, and thus a rolled material having a thickness that is necessary as a magnetic disk is produced. It is preferable that this rolled material is subjected to annealing as necessary, in the middle of cold-rolling or the like. Next, this rolled material is punched into an annular shape, and in order to eliminate strains and the like occurred by the production processes described above, an aluminum alloy sheet that has been punched into an annular shape is laminated on the rolled material. The laminate is subjected to compressed annealing, by which the laminate is annealed while the laminate is compressed from both surface, and thereby the laminate is flattened, and an annular-shaped aluminum alloy substrate is produced.

The annular-shaped aluminum alloy substrate produced as described above is subjected to cutting work, grinding work, a degreasing treatment, an etching treatment, and a zincate treatment (Zn-substitution treatment), as preliminary treatments, and then the aluminum alloy substrate is electroless plated with Ni—P, which are hard non-magnetic metals, as a substrate treatment. The plated surface is subjected to polishing, and then magnetic materials are sputtered onto the plated surface. Thus, a magnetic disk made of an aluminum alloy is produced.

However, in recent years, magnetic disks are required to have improvements in capacity increase, recording density increase, and speed increase, due to the demands from the fields of multimedia and the like. Because of capacity increase, the number of sheets of magnetic disks mounted in storage devices is ever increasing, and accordingly, there is also a demand for thickness reduction of magnetic disks.

However, rigidity decreases as a result of thickness reduction and speeding-up, or the exciting force increases as a result of an increase in the fluid force caused by high-speed rotation, and thus disk flutter is likely to occur. This is attributed to the fact that when magnetic disks are rotated at high speed, an unstable air flow is generated between the disks, and vibration (fluttering) of the magnetic disks occurs due to the air flow. This is considered to be because, if the substrate has low rigidity, vibration of the magnetic disk increases, and the head cannot comply with the variations. When fluttering occurs, positioning error of the head, which is a readout unit, increases. Therefore, there is a strong demand for the reduction of disk flutter.

Furthermore, due to the attempt to increase the density of magnetic disks, the magnetic domain per bit is further micronized.

Under such circumstances, in recent years, aluminum alloy substrates for magnetic disks having characteristics with reduced disk flutter are strongly desired, and investigations have been conducted. For example, it has been suggested that an air flow suppressing component having a sheet that is disposed to face a disk is mounted inside a hard disk drive. For example, in Patent Literature 1, a magnetic disk device having an air spoiler installed on the upstream side of an actuator. This air spoiler weakens the air stream directed toward the actuator on the magnetic disk and reduces the windage vibration of the magnetic head. Furthermore, the air spoiler suppresses disk flutter by weakening the air flow on the magnetic disk.

In order to obtain plating with high smoothness, for example, it has been suggested to form a metal coating film on an aluminum alloy substrate before plating for the purpose of suppressing pits. For example, in Patent Literature 2, an aluminum alloy substrate for a magnetic recording medium is disclosed, the aluminum alloy substrate having an Al alloy thin film (metal coating film) formed by physical vapor deposition on the substrate surface. It is disclosed that the film thickness of this Al alloy thin film is 50 to 1,000 nm.

Furthermore, in Patent Literature 3, a method of producing an aluminum alloy substrate for a magnetic recording medium is disclosed, the method including a step of forming a metal thin film containing at least one of Zn and Ni by physical vapor deposition on the surface of a substrate made of an aluminum alloy; and a step of subjecting the substrate made of an aluminum alloy with a metal thin film formed thereon, to electroless plating of Ni—P. It is disclosed that the film thickness of this metal coating film is 10 to 200 nm.

### CITATION LIST

### Patent Literatures

Patent Literature 1: JP-A-2002-313061 (“JP-A” means unexamined published Japanese patent application)
Patent Literature 2: JP-A-2006-302358
Patent Literature 3: JP-A-2008-282432

### SUMMARY OF INVENTION

### Technical Problem

However, in the method disclosed in Patent Literature 1, the fluttering suppressive effect varies depending on the difference in the distance between the installed air spoiler and the substrate for a magnetic disk, and component precision is required. Thus, the method brings about an increase in the component cost.

An object of the means disclosed in Patent Literature 2 is to provide an aluminum alloy substrate for a magnetic recording medium, which can reduce surface defects after Ni—P plating compared to conventional aluminum alloy substrates for magnetic recording media, and to provide a magnetic recording medium that uses this aluminum alloy substrate. However, nothing is described in connection with the problem of disk flutter.

Furthermore, it is an object of the means disclosed in Patent Literature 3 to provide an aluminum alloy substrate for a magnetic recording medium, which can suppress the occurrence of defects in the Ni—P plating film at a high level. However, nothing is described in connection with the problem of disk flutter.

The present invention was achieved in view of such circumstances, and the present invention is contemplated for providing an aluminum alloy substrate for a magnetic disk, the aluminum alloy substrate having characteristics with reduced occurrence of disk flutter.

### Solution to Problem

The aluminum alloy substrate for a magnetic disk of the present invention is such that

the sum of the circumferences of second phase particles having the longest diameter of 4 μm or more and 30 μm or less in the metal microstructure is 10 mm/mm² or more.

The aluminum alloy substrate for a magnetic disk of the present invention may contain at least one or two or more elements selected from the group consisting of 0.10 mass % or more and 24.00 mass % or less of Si, 0.05 mass % or more and 10.00 mass % or less of Fe, 0.10 mass % or more and 15.00 mass % or less of Mn, and 0.10 mass % or more and 20.00 mass % or less of Ni, with the balance being aluminum and inevitable impurities; and satisfy the relationship of (Si+Fe+Mn+Ni)≥0.20 mass %.

The aluminum alloy substrate for a magnetic disk may further contain one or two or more elements selected from the group consisting of the following (1) to (6):

(1) one or two or more elements selected from the group consisting of:

0.005% by mass or more and 10.000% by mass or less of Cu,

0.100% by mass or more and 6.000% by mass or less of Mg,

0.010% by mass or more and 5.000% by mass or less of Cr, and

0.010% by mass or more and 5.000% by mass or less of Zr;

(2) 0.0001% by mass or more and 0.1000% by mass or less of Be;

(3) one or two or more elements selected from the group consisting of

0.001% by mass or more and 0.100% by mass or less of Na,

0.001% by mass or more and 0.100% by mass or less of Sr, and

0.001% by mass or more and 0.100% by mass or less of P;

(4) one or two or more elements selected from the group consisting of Pb, Sn, In, Cd, Bi, and Ge, each at a content of 0.1% by mass or more and 5.0% by mass or less;

(5) 0.005% by mass or more and 10.000% by mass or less of Zn; and/or

(6) one or two or more elements selected from the group consisting of Ti, B, and V at a total content of 0.005% by mass or more and 0.500% by mass or less.

The aluminum alloy substrate for a magnetic disk may be such that

the average value of the crystal grain size at the surface is 70 μm or less.

The aluminum alloy substrate for a magnetic disk may have

a pure Al coating film or an Al—Mg-based alloy coating film on both surfaces.

The aluminum alloy substrate for a magnetic disk may have

a metal coating film having a thickness of 10 nm or more and 3,000 nm or less on both surfaces.

The aluminum alloy substrate for a magnetic disk may have

an electroless Ni—P plating-treated layer and a magnetic layer thereon, on the surface.

A method of producing the aluminum alloy substrate for a magnetic disk includes:

a casting step of casting an ingot using the aluminum alloy; a hot-rolling step of subjecting the ingot to hot-rolling; a cold-rolling step of subjecting the thus hot-rolled sheet to cold-rolling; a disk blank punching step of punching the thus cold-rolled sheet into an annular shape; and a compressed annealing step of subjecting the thus punched disk blank to compressed annealing.

The method may further include a homogenization heat treatment step of subjecting the ingot to a homogenization heat treatment, between the casting step and the hot-rolling step.

The method may further include an annealing treatment step of annealing the rolled sheet before or in the middle of the cold-rolling.

A method of producing the aluminum alloy substrate for a magnetic disk includes: a core alloy casting step of casting an ingot for a core alloy using the aluminum alloy; a skin alloy casting step of casting an ingot for a skin alloy using pure Al or an Al—Mg-based alloy; a skin alloy step of subjecting the ingot for the skin alloy to a homogenization treatment and then to hot-rolling, and thereby obtaining the skin alloy; a laminated material step of cladding both surfaces of the ingot for the core alloy respectively with the skin alloy, and thereby obtaining a laminated material; a hot-rolling step of hot-rolling the laminated material; a cold-rolling step of cold-rolling the hot-rolled sheet; a disk blank punching step of punching the cold-rolled sheet into an annular shape; and a compressed annealing step of subjecting the punched blank to compressed annealing.

The method may further include a homogenization heat treatment step of subjecting the laminated material to a homogenization heat treatment, between the laminated material step and the hot-rolling step.

The method may further include an annealing treatment step of annealing the rolled sheet before or in the middle of the cold-rolling.

### Effects of Invention

According to the present invention, it is possible to provide the substrate for a magnetic disk, the substrate having characteristics with reduced occurrence of disk flutter.

Other and further features and advantages of the invention will appear more fully from the following description, appropriately referring to the accompanying drawings.

### BRIEF DESCRIPTION OF THE DRAWINGS

FIG. 1 is a graph showing the relationship between the circumference and the fluttering characteristics (maximum displacement of fluttering), for the aluminum alloy thus formed.

FIG. 2 is a diagram showing the flow of a method of producing a magnetic disk, the method including a method of producing an aluminum alloy substrate for a magnetic disk as a bare material according to an embodiment of the present invention. In the present invention, the flow of the production method will be described mainly based on an aluminum alloy substrate.

FIG. 3 is a diagram showing the flow of a method of producing a magnetic disk, the method including a method of producing an aluminum alloy substrate for a magnetic disk as a clad material according to an embodiment of the present invention.

FIG. 4 is a diagram showing the flow of a method of producing a magnetic disk, the method including a method of producing a coated aluminum alloy substrate for a magnetic disk according to an embodiment of the present invention.

### MODE FOR CARRYING OUT THE INVENTION

The inventors of the present invention paid attention to the relationship between the fluttering characteristics of a substrate and the material of the substrate, and conducted a thorough investigation on the relationship between these characteristics and the characteristics of the substrate (magnetic disk material). As a result, the inventors found that the sum of the circumferences of second phase particles in the metal microstructure of an aluminum alloy substrate affects significantly the fluttering characteristics of the magnetic disk measured in air or in helium. As a result, the inventors of the present invention found that in regard to an aluminum alloy substrate for a magnetic disk, in which the sum of the circumferences of second phase particles having the longest diameter of 4 μm or more and 30 μm or less in the metal microstructure is 10 mm/mm² or more, the fluttering characteristics are enhanced. The inventors of the present invention completed the present invention based on these findings.

According to the present invention, without being particularly limited, the aluminum alloy substrate for a magnetic disk is such that the existence density of second phase particles having the longest diameter of 4 μm or more and 30 μm or less in the metal microstructure is 100 to 50,000 particles/mm².

Here, the second phase particles mean precipitated products or crystallized products. Specific examples of the second phase particles include Si particles, Al—Fe-based compounds (e.g., Al₃Fe, Al₆Fe, Al₆(Fe, Mn), Al—Fe—Si, Al—Fe—Mn—Si, Al—Fe—Ni, and Al—Cu—Fe), Al—Mn-based compounds (e.g., Al₆Mn, and Al—Mn—Si), Al—Ni-based compounds (e.g., Al₃Ni), Al—Cu-based compounds (e.g., Al₂Cu), Mg—Si-based compounds (e.g., Mg₂Si) Al—Cr-based compounds (e.g., Al₇Cr), Al—Zr-based compounds (e.g., Al₃Zr), Pb particles, Sn particles, In particles, Cd particles, Bi particles, and Ge particles.

Hereinafter the aluminum alloy substrate for a magnetic disk according to an embodiment of the present invention will be described in detail.

The aluminum alloy substrate for a magnetic disk is used as a single-layered bare material or as a three-layered clad material. A clad material is an alloy sheet obtained by metallurgically joining two or more different alloy sheets, and here, the intermediate material of the three-layered clad material is designated as core alloy, and the material on both surfaces of the core alloy is designated as skin alloy. Furthermore, unless particularly stated otherwise, the aluminum alloy substrate includes a bare material and a clad material. Furthermore, it is also acceptable that a metal coating film is physically vapor-deposited on the substrate surface.

Hereinafter, the distribution state of the second phase particles in the core alloy of the clad material and the bare material of the aluminum alloy substrate for a magnetic disk according to the embodiment of the present invention will be explained.

(The Sum of the Circumferences of Second Phase Particles Having the Longest Diameter of 4 μm or More and 30 μm or Less being 10 mm/mm² or More)

In the case where the sum of the circumferences of second phase particles having the longest diameter of 4 μm or more and 30 μm or less existing in the metal microstructure of an aluminum alloy substrate is 10 mm/mm² or more, there is an effect of enhancing the fluttering characteristics of the aluminum alloy substrate, that is, an effect of reducing the maximum displacement of fluttering. It is considered that an enhancement of the fluttering characteristics is brought about when the surface area of the second phase particles increases. This is speculated to be because the vibration generated by air flow has been absorbed and attenuated at the interface between the aluminum alloy matrix and the second phase particles during the course of being propagated through the disk. Furthermore, it is considered that the maximum displacement of fluttering is proportional to the surface area of the second phase particles that are dispersed in the aluminum alloy matrix, and it is considered that the maximum displacement of fluttering is proportional to the square of the circumference of the second phase particles.

In the case where the longest diameter of the second phase particles existing in the metal microstructure of the aluminum alloy substrate is less than 4 μm, the vibration energy absorbed at the interface between the aluminum alloy matrix and the second phase particles is small, and therefore, the fluttering characteristics are not enhanced. Therefore, the longest diameter of the second phase particles existing in the metal microstructure of the aluminum alloy substrate is set to be in the range of 4 μm or more. The longest diameter of the second phase particles is preferably in the range of 5 μm or more, in view of the balance with the fluttering characteristics. On the other hand, if the longest diameter of the second phase particles is more than 30 μm, in the case of a bare material, the second phase particles fall off at the time of etching, at the time of performing zincate treatment, or at the time of cutting or grinding work, large pits are generated, and there is a possibility that peeling of the plating may occur. Furthermore, in the case of the core alloy of the clad material, coarse second phase particles on the substrate side surface fall off at the time of etching, at the time of a zincate treatment, or at the time of cutting, large pits are generated, and there is a possibility that peeling of the plating may occur at the boundaries between the core alloy and the skin alloy of the substrate side surface. Therefore, the upper limit of the longest diameter of the second phase particles is set to 30 μm.

In the case where the sum of the circumferences of the second phase particles existing in the metal microstructure of the aluminum alloy substrate is less than 10 mm/mm², the vibration energy absorbed at the interface between the aluminum alloy matrix and the second phase particles is small, and therefore, the fluttering characteristics are not enhanced. Therefore, the sum of the circumferences of the second phase particles existing in the metal microstructure of the aluminum alloy substrate is set to be in the range of 10 mm/mm² or more.

The sum of the circumferences of the second phase particles is preferably in the range of 30 mm/mm² or more, in view of the balance with the fluttering characteristics. The upper limit of the sum of the circumferences is not particularly limited; however, when the sum of the circumferences of the second phase particles increases, workability in the rolling process gradually deteriorates. When the sum of the circumferences is more than 1,000 mm/mm², rolling becomes difficult, and there is a possibility that production of the aluminum alloy substrate may become difficult. Furthermore, in the case of the bare material, the second phase particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse second phase particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Therefore, the upper limit of the sum of the circumferences of the second phase particles is preferably 1,000 mm/mm².

The longest diameter according to the present invention refers to the following length in a planar image of the second phase particles observed with an optical microscope. First, the maximum value of the distance between one point on the contour line and another point on the contour line is measured, and subsequently, this maximum value is measured for all the points on the contour line. Finally, the largest value selected from among all of these maximum values is designated as the longest diameter. The sum of the circumferences refers to the sum of the circumferential lengths in an image of second phase particles taken with an optical microscope.

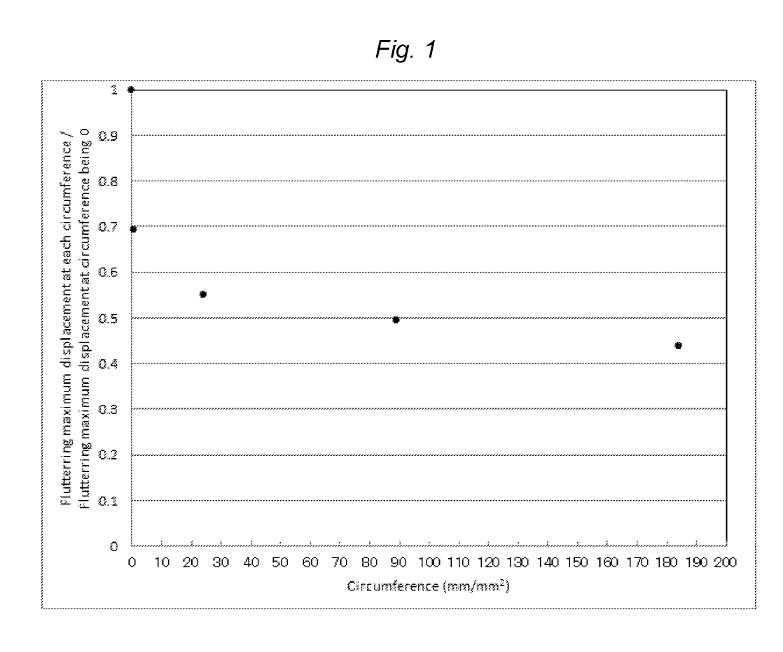

FIG. 1 is a graph showing the relationship between the circumferences of second phase particles in an aluminum alloy substrate and the fluttering characteristics. Since the fluttering characteristics vary depending on the sheet thickness, the fluttering characteristics in the case of the sum of the respective circumferences of second phase particles were divided by the fluttering characteristics of the alloy in the case where the circumference was 0, that is, in the case where second phase particles could not be observed, and thus the resultants were expressed as dimensionless values. It can be seen that as the sum of the circumferences increases, the fluttering characteristics are enhanced. In FIG. 1, it can be seen that when the sum of the circumferences is 10 mm/mm² or more, the fluttering characteristics are enhanced. Since the form of generation of the second phase particles varies depending on the casting method or a subsequent heating method, the distribution of the second phase particles may be controlled such that the final substrate alloy has necessary fluttering characteristics with respect to the sheet thickness.

The fluttering characteristics are also affected by the motor characteristics of the hard disk drive. In this embodiment of the present invention, the fluttering characteristics are preferably 50 nm or less, and more preferably 30 nm or less, in air. When the fluttering characteristics are less than or equal to these values, it was considered that the aluminum alloy substrate for a magnetic disk can endure a use directed at general hard disk drives (HDD).

Furthermore, it is preferable that the fluttering characteristics are 30 nm or less in helium. When the fluttering characteristics are less than or equal to this value, it was considered that the aluminum alloy substrate for a magnetic disk can endure a use directed at hard disk drives having higher-density storage capacities.

However, since there will be differences depending on the hard disk drive used, the distribution state of the second phase particles may be determined as appropriate for the required fluttering characteristics. These are obtained by appropriately adjusting the contents of the additive elements that will be described below, the casting method including the cooling speed at the time of casting, and the thermal history and working history based on the subsequent heat treatment and working, respectively.

In this embodiment of the present invention, the sheet thickness is preferably 0.45 mm or more. If the sheet thickness is less than 0.45 mm, there is a risk that the substrate may be deformed by the acceleration force caused by dropping that occurs at the time of installing the hard disk drive, or the like. However, there will be exemptions if deformation can be suppressed by increasing the proof stress. When the sheet thickness is larger than 1.3 mm, the fluttering characteristics may be improved; however, the number of disks that can be mounted in the hard disk will be decreased, which is not suitable.

Furthermore, it is known that the fluid force can be decreased by filling the interior of the hard disk with helium. This is because since the gas viscosity of helium is as small as about ⅛ of the gas viscosity of air, the force of gas flow that causes fluttering, which occurs as a result of a gas flow resulting from the rotation of the hard disk, can be reduced.

### (Compositions of Bare Material and Core Alloy of Clad Material)

Hereinafter, the aluminum alloy components and contents thereof in the bare materials and the core alloys of the clad materials, which constitute the Al—Si-based, Al—Fe-based, Al—Mn-based, Al—Ni-based, or Al—Si—Fe—Mn—Ni-based aluminum alloy substrates for magnetic disks according to this embodiment of the present invention, will be explained.

In order to further enhance the fluttering characteristics of an aluminum alloy substrate for a magnetic disk, an aluminum alloy containing (1) one kind or two or more kinds of additive elements selected from preferably 0.10% by mass or more and 24.00% by mass or less of Si, preferably 0.05% by mass or more and 10.00% by mass or less of Fe, preferably 0.10% by mass or more and 15.00% by mass or less of Mn, and preferably 0.10% by mass or more and 20.00% by mass or less of Ni, the additive elements being in the following relationship: Si+Fe+Mn+Ni≥0.20% by mass, and if necessary, further containing one or two or more selective elements selected from the group consisting of the following (2) to (7): (2) one or two or more elements selected from the group consisting of preferably 0.005% by mass or more and 10.000% by mass or less of Cu, preferably 0.100% by mass or more and 6.000% by mass or less of Mg, preferably 0.010% by mass or more and 5.000% by mass or less of Cr, and preferably 0.010% by mass or more and 5.000% by mass or less of Zr; (3) preferably 0.0001% by mass or more and 0.1000% by mass or less of Be; (4) one or two or more elements selected from the group consisting of preferably 0.001% by mass or more and 0.100% by mass or less of Na, preferably 0.001% by mass or more and 0.100% by mass or less of Sr, and preferably 0.001% by mass or more and 0.100% by mass or less of P; (5) one or two or more elements selected from the group consisting of Pb, Sn, In, Cd, Bi, and Ge, each at a content of preferably 0.1% by mass or more and 5.0% by mass or less; (6) preferably 0.005% by mass or more and 10.000% by mass or less of Zn; and/or (7) one or two or more elements selected from the group consisting of Ti, B, and V at a total content of preferably 0.005% by mass or more and 0.500% by mass or less, can also be used. In the following description, these additive elements and selective elements will be explained.

### (Silicon)

Si exists mainly as the second phase particles (Si particles or the like) and has an effect of enhancing the fluttering characteristics of an aluminum alloy substrate. When vibration is applied to such a material, the vibration energy is rapidly absorbed due to the viscous flow at the interface between the second phase particles and the matrix, and very high fluttering characteristics are obtained. When the content of Si in the aluminum alloy is 0.10% by mass or more, an effect of enhancing the fluttering characteristics of the aluminum alloy substrate can be further obtained. Also, when the content of Si in the aluminum alloy is 24.00% by mass or less, production of a large number of coarse Si particles is suppressed. In the case of the bare material, the Si particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Si particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Furthermore, deterioration of workability in rolling can be further suppressed. Therefore, the Si content in the aluminum alloy is preferably in the range of 0.10 mass % or more and 24.00 mass % or less, more preferably in the range of 0.10 mass % or more and less than 18.00 mass %, further preferably in the range of 0.10 mass % or more and less than 5.00 mass %, and furthermore preferably in the range of 0.10 mass % or more and less than 0.50 mass %.

### (Iron)

Fe exists mainly as the second phase particles (Al—Fe-based compounds and the like) and has an effect of enhancing the fluttering characteristics of an aluminum alloy substrate. When vibration is applied to such a material, the vibration energy is rapidly absorbed due to the viscous flow at the interface between the second phase particles and the matrix, and very high fluttering characteristics are obtained. When the content of Fe in the aluminum alloy is 0.05% by mass or more, an effect of enhancing the fluttering characteristics of the aluminum alloy substrate can be further obtained. Also, when the content of Fe in the aluminum alloy is 10.00% by mass or less, production of a large number of coarse Al—Fe-based compounds is suppressed. In the case of the bare material, the Al—Fe-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Fe-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Furthermore, deterioration of workability in rolling can be further suppressed. Therefore, the Fe content in the aluminum alloy is preferably in the range of 0.05 mass % or more and 10.00 mass % or less, and more preferably in the range of 0.50 mass % or more and 5.00 mass % or less.

### (Manganese)

Mn exists mainly as the second phase particles (Al—Mn-based compounds and the like) and has an effect of enhancing the fluttering characteristics of an aluminum alloy substrate. When vibration is applied to such a material, the vibration energy is rapidly absorbed due to the viscous flow at the interface between the second phase particles and the matrix, and very high fluttering characteristics are obtained. When the content of Mn in the aluminum alloy is 0.10% by mass or more, an effect of enhancing the fluttering characteristics of the aluminum alloy substrate can be further obtained. Also, when the content of Mn in the aluminum alloy is 15.00% by mass or less, production of a large number of coarse Al—Mn-based compounds is suppressed. In the case of the bare material, the Al—Mn-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Mn-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Furthermore, deterioration of workability in rolling can be further suppressed. Therefore, the Mn content in the aluminum alloy is preferably in the range of 0.10 mass % or more and 15.00 mass % or less, and more preferably in the range of 0.50 mass % or more and 5.00 mass % or less.

### (Nickel)

Ni exists mainly as the second phase particles (Al—Ni-based compounds and the like) and has an effect of enhancing the fluttering characteristics of an aluminum alloy substrate. When vibration is applied to such a material, the vibration energy is rapidly absorbed due to the viscous flow at the interface between the second phase particles and the matrix, and very high fluttering characteristics are obtained. When the content of Ni in the aluminum alloy is 0.10% by mass or more, an effect of enhancing the fluttering characteristics of the aluminum alloy substrate can be further obtained. Also, when the content of Ni in the aluminum alloy is 20.00% by mass or less, production of a large number of coarse Al—Ni-based compounds is suppressed. In the case of the bare material, the Al—Ni-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Ni-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Furthermore, deterioration of workability in rolling can be further suppressed. Therefore, the Ni content in the aluminum alloy is preferably in the range of 0.10 mass % or more and 20.00 mass % or less, and more preferably in the range of 0.50 mass % or more and 10.00 mass % or less.

(Si+Fe+Mn+Ni≥0.20 mass %)

According to the present invention, when the aluminum alloy contains one kind or two or more kinds among Si, Fe, Mn, and Ni respectively at the predetermined amounts described above, and satisfies the relationship formula: Si+Fe+Mn+Ni≥0.20% by mass, an effect of enhancing the fluttering characteristics of the aluminum alloy substrate is obtained. When the relationship formula mentioned above is satisfied, a large number of second phase particles come to exist in the matrix, and the vibration energy is rapidly absorbed due to the viscous flow at the interface between the second phase particles and the matrix. Thus, very high fluttering characteristics can be obtained. Therefore, the (Si+Fe+Mn+Ni) in the aluminum alloy is preferably in the range of 0.20 mass % or more, and more preferably in the range of 0.40 mass % or more and 20.00 mass % or less.

### (Copper)

Cu exists mainly as the second phase particles (Al—Cu-based compounds and the like) and has an effect of enhancing the fluttering characteristics of an aluminum alloy substrate. Further, Cu has an effect of reducing the dissolved amount of Al at the time of a zincate treatment, attaching a zincate coating film uniformly, thinly, and compactly, and thereby enhancing the smoothness of plating in the subsequent process. When the content of Cu in the aluminum alloy is 0.005% by mass or more, an effect of enhancing the fluttering characteristics and an effect of enhancing smoothness can be further obtained. When the content of Cu in the aluminum alloy is 10.00% by mass or more, production of a large number of coarse Al—Cu-based compounds is suppressed. In the case of the bare material, the Al—Cu-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Cu-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Also, when the content of Cu is 10.000% by mass or less, rolling is facilitated. Therefore, the Cu content in the aluminum alloy is preferably in the range of 0.005 mass % or more and 10.000 mass % or less, and more preferably in the range of 0.005 mass % or more and 0.400 mass % or less.

### (Magnesium)

Mg exists mainly as the second phase particles (Mg—Si-based compounds and the like) and has an effect of enhancing the fluttering characteristics of an aluminum alloy substrate. When the content of Mg in the aluminum alloy is 0.100% by mass or more, an effect of enhancing the fluttering characteristics can be further obtained. When the content of Mg in the aluminum alloy is 6.000% by mass or less, production of a large number of coarse Mg—Si-based compounds is suppressed. In the case of the bare material, the Mg—Si-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Mg—Si-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Also, when the content of Mg is 6.000% by mass or less, rolling is facilitated. Therefore, the Mg content in the aluminum alloy is preferably in the range of 0.100 mass % or more and 6.000 mass % or less, and more preferably in the range of 0.300 mass % or more and less than 1.000 mass %.

### (Chromium)

Cr exists mainly as the second phase particles (Al—Cr-based compounds and the like) and has an effect of enhancing the fluttering characteristics of an aluminum alloy substrate. When the content of Cr in the aluminum alloy is 0.010% by mass or more, an effect of enhancing the fluttering characteristics can be further obtained. When the content of Cr in the aluminum alloy is 5.000% by mass or less, production of a large number of coarse Al—Cr-based compounds is suppressed. In the case of the bare material, the Al—Cr-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Cr-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Also, when the content of Cr is 5.000% by mass or less, rolling is facilitated. Therefore, the Cr content in the aluminum alloy is preferably in the range of 0.010 mass % or more and 5.000 mass % or less, and more preferably in the range of 0.100 mass % or more and 2.000 mass % or less.

### (Zirconium)

Zr exists mainly as the second phase particles (Al—Zr-based compounds and the like) and has an effect of enhancing the fluttering characteristics of an aluminum alloy substrate. When the content of Zr in the aluminum alloy is 0.010% by mass or more, an effect of enhancing the fluttering characteristics can be further obtained. When the content of Zr in the aluminum alloy is 5.000% by mass or less, production of a large number of coarse Al—Zr-based compounds is suppressed. In the case of the bare material, the Al—Zr-based compound particles falling off at the time of etching, at the time of a zincate treatment, or at the time of cutting or grinding work, and large pits being generated can be suppressed, and the occurrence of peeling of the plating can be further suppressed. In the case of the core alloy of the clad material, coarse Al—Zr-based compound particles in the substrate side surface falling off at the time of etching, at the time of a zincate treatment, or at the time of cutting, and large pits being generated can be suppressed, and the occurrence of peeling of the plating at the boundaries between the core alloy and the skin alloy of the substrate side surface can be further suppressed. Also, when the content of Zr is 5.000% by mass or less, rolling is facilitated. Therefore, the Zr content in the aluminum alloy is preferably in the range of 0.010 mass % or more and 5.000 mass % or less, and more preferably in the range of 0.100 mass % or more and 2.000 mass % or less.

### (Beryllium)

Be has an effect of forming second phase particles with other additive elements and enhancing the fluttering characteristics. Therefore, Be may be selectively incorporated into the aluminum alloy at a content of preferably 0.0001% by mass or more and 0.1000% by mass or less. However, when the content of Be is less than 0.0001% by mass, the above-described effect is not obtained. Meanwhile, even if Be is incorporated at a content of more than 0.1000% by mass, the effects are saturated, and a further noticeable improvement effect is not obtained. The Be content is preferably in the range of 0.0003 mass % or more and 0.0250 mass % or less.

### (Sodium, Strontium, and Phosphorus)

Any of Na, Sr, and P has an effect of micronizing the second phase particles (mainly Si particles) in the aluminum alloy substrate and improving plateability. Furthermore, any of these elements has an effect of reducing the non-uniformity of the size of the second phase particles in the aluminum alloy substrate and reducing the fluctuations of the fluttering characteristics in the aluminum alloy substrate. Therefore, one or two or more elements selected from the group consisting of preferably 0.001% by mass or more and 0.100% by mass or less of Na, preferably 0.001% by mass or more and 0.100% by mass or less of Sr, and preferably 0.001% by mass or more and 0.100% by mass or less of P may be selectively incorporated into the aluminum alloy. However, when the respective contents of any of Na, Sr, and P is less than 0.001% by mass or less, the above-described effect is not obtained. On the other hand, even if the aluminum alloy contains any of Na, Sr, and P each at a content of more than 0.100% by mass, the effects are saturated, and a further noticeable improvement effect is not obtained. Furthermore, the contents of any of Na, Sr, and P in the case of adding any of Na, Sr, and P is each more preferably in the range of 0.003% by mass or more and 0.025% by mass or less.

### (Lead, Tin, Indium, Cadmium, Bismuth, and Germanium)

Any of Pb, Sn, In, Cd, Bi, and Ge is distributed as second phase particles (particles of Pb, Sn, In, Cd, Bi, or Ge, or compounds thereof) in the aluminum matrix. When vibration is applied to such a material, the vibration energy is rapidly absorbed due to the viscous flow at the interface between the metal particles or the compound phase and the matrix, and very high fluttering characteristics are obtained. When the content of one or two or more elements selected from the group consisting of Pb, Sn, In, Cd, Bi, and Ge in the aluminum alloy each is 0.10% by mass or more, an effect of enhancing the fluttering characteristics can be further obtained. Also, when the content of one or two or more elements selected from the group consisting of Pb, Sn, In, Cd, Bi, and Ge each is 5.00% by mass or less, rolling is facilitated. Therefore, the content of one or two or more elements selected from the group consisting of Pb, Sn, In, Cd, Bi, and Ge in the aluminum alloy each is preferably in the range of 0.10 mass % or more and 5.00 mass % or less, and more preferably in the range of 0.50 mass % or more and less than 2.00 mass %.

### (Zinc)

Zn has an effect of reducing the dissolved amount of Al at the time of a zincate treatment, attaching a zincate coating film uniformly, thinly, and compactly, and thereby enhancing the adhesiveness of plating in the subsequent process. Furthermore, Zn has an effect of forming second phase particles with other additive elements and enhancing the fluttering characteristics. When the content of Zn in the aluminum alloy is 0.005% by mass or more, the dissolved amount of Al at the time of the zincate treatment is reduced. When the content of Zn in the aluminum alloy is 10.000% by mass or less, in the case of a bare material, the zincate coating film becomes uniform, and the occurrence of peeling of the plating can be further suppressed. In the case of a clad material, the zincate coating film on the substrate side surface becomes uniform, deterioration of the plating adhesiveness is suppressed, and the occurrence of peeling of the plating at the boundaries between the core alloy and the skin alloy on the substrate side surface can be further suppressed. Also, when the content of Zn is 10.000% by mass or less, rolling is facilitated. Therefore, the Zn content in the aluminum alloy is preferably in the range of 0.005 mass % or more and 10.000 mass % or less, and more preferably in the range of 0.100 mass % or more and 2.000 mass % or less.

### (Titanium, Boron, and Vanadium)

Any of Ti, B, and V forms second phase particles (borides such as TiB₂, or Al₃Ti or Ti-V-B particles) in the course of solidification at the time of casting, and since these particles become the nuclei of crystal grains, it is possible to micronized crystal grains. Thereby, plateability is improved. Furthermore, when the crystal grains are micronized, there is an effect of reducing the non-uniformity of the size of the second phase particles and reducing fluctuations of the fluttering characteristics in the aluminum alloy substrate. However, when the sum of the contents of any of Ti, B, and V is less than 0.005% by mass, the above-described effects are not obtained. Meanwhile, even if the sum of the contents of any of Ti, B, and V is more than 0.500% by mass, the effects are saturated, and a further noticeable improvement effect is not obtained. Therefore, the sum of the contents of any of Ti, B, and V in the case of incorporating any of Ti, B, and V is preferably in the range of 0.005% by mass or more and 0.500% by mass or less, and more preferably in the range of 0.005% by mass or more and 0.100% by mass or less.

### (Other Elements)

Furthermore, the balance of the aluminum alloy according to this embodiment of the present invention comprises aluminum and inevitable impurities. Here, when the contents of any of the inevitable impurities is each less than 0.1% by mass, and the sum of the contents is less than 0.2% by mass, the characteristics of the aluminum alloy substrate obtainable by the present invention are not impaired.

### (Skin Alloy Composition)

Next, the alloy components of the skin alloy of the clad material that constitutes the aluminum alloy substrate for a magnetic disk according to this embodiment of the present invention and contents of the alloy components will be explained.

In the aluminum alloy substrate according to the embodiment of the present invention, it is possible to obtain excellent smoothness of the plating surface with the bare material only. However, the plating surface becomes even smoother by attaching a skin alloy having fewer second phase particles on both surfaces of a core alloy and producing a clad material.

In the aluminum alloy substrate according to this embodiment of the present invention, any of pure Al and an Al—Mg-based alloy may be used as the skin alloy. Pure Al and an Al—Mg-based alloy has relatively fewer coarse second phase particles compared to other alloys, and has excellent plateability.

The pure Al skin alloy to be used in the aluminum alloy substrate according to this embodiment of the present invention preferably contains: 0.005 mass % or more and 0.600 mass % or less of Cu, 0.005 mass % or more and 0.600 mass % or less of Zn, 0.001 mass % or more and 0.300 mass % or less of Si, 0.001 mass % or more and 0.300 mass % or less of Fe, 0.001 mass % or more and less than 1.000 mass % of Mg, 0.300 mass % or less of Cr, and 0.300 mass % or less of Mn, with the balance being Al and inevitable impurities. Examples thereof include JIS A 1000-based Al alloys and the like.

Further, the Al—Mg-based alloy skin alloy to be used in the aluminum alloy substrate according to this embodiment of the present invention preferably contains: 1.000 mass % or more and 8.000 mass % or less of Mg, 0.005 mass % or more and 0.600 mass % or less of Cu, 0.005 mass % or more and 0.600 mass % or less of Zn, 0.010 mass % or more and 0.300 mass % or less of Cr, 0.001 mass % or more and 0.300 mass % or less of Si, 0.001 mass % or more and 0.300 mass % or less of Fe, and 0.300 mass % or less of Mn, with the balance being Al and inevitable impurities.

Hereinafter, the crystal grain size at the surface in the core alloy of the clad material and the bare material of the aluminum alloy substrate for a magnetic disk according to this embodiment of the present invention will be explained.

(The Average Value of the Crystal Grain Size at the Surface being 70 μm or Less)

In the case where the average value of the crystal grain size at the surface of the aluminum alloy substrate is 70 μm or less, there is an effect of further enhancing the fluttering characteristics of the aluminum alloy substrate. This is speculated to be because the vibration generated by the air flow is absorbed and attenuated at the crystal grain boundaries in the course of being propagated through the disk. Since the number of crystal grain boundaries becomes larger as the particle size is smaller, it is preferable that the average value of the crystal grain size at the surface of the aluminum alloy substrate is 70 μm or less. Furthermore, the average value of the crystal grain size at the surface of the aluminum alloy substrate is more preferably 50 μm or less. Meanwhile, the surface represents the L-LT surface (rolled surface). The lower limit of the crystal grain size at the surface is not particularly limited; however, the lower limit is usually 1 μm or more.

Furthermore, the plating surface becomes smoother by attaching a metal coating film having fewer second phase particles to the entire surface of the aluminum alloy substrate. A pure Al coating film or an Al—Mg-based alloy coating film has relatively fewer rough second phase particles compared to other alloys and is preferable as a metal coating. Furthermore, since pure Al or an Al—Mg-based alloy has high adhesiveness to an aluminum alloy substrate for a magnetic disk, and the difference in the thermal expansion coefficient is also small, the change in the degree of flatness of the coated aluminum alloy substrate for a magnetic disk caused by coating a different alloy can be suppressed. Furthermore, the pure Al coating film or Al—Mg-based alloy coating film may also be employed as a substitute for a zincate treatment that is carried out in a subsequent process by forming a film of Zn or the like.

The metallic alloy coating film that can be used in the aluminum alloy substrate according to this embodiment of the present invention preferably contains: 0.005 mass % or more and 0.600 mass % or less of Cu, 0.005 mass % or more and 0.600 mass % or less of Zn, 0.001 mass % or more and 0.300 mass % or less of Si, 0.001 mass % or more and 0.300 mass % or less of Fe, 0.001 mass % or more and less than 1.000 mass % of Mg, 0.300 mass % or less of Cr, and 0.300 mass % or less of Mn, with the balance being Al and inevitable impurities. Examples thereof include JIS 1000-based Al alloys and the like.

Further, the metallic alloy coating film to be used in the aluminum alloy substrate preferably contains: 1.000 mass % or more and 8.000 mass % or less of Mg, 0.005 mass % or more and 0.600 mass % or less of Cu, 0.005 mass % or more and 0.600 mass % or less of Zn, 0.010 mass % or more and 0.300 mass % or less of Cr, 0.001 mass % or more and 0.300 mass % or less of Si, 0.001 mass % or more and 0.300 mass % or less of Fe, and 0.300 mass % or less of Mn, with the balance being Al and inevitable impurities. Examples thereof include JIS 5000-based Al alloys and the like.

Furthermore, in regard to the metal coating film that constitutes the aluminum alloy metal-coated substrate for a magnetic disk substrate, when the film thickness is 10 nm or more, coating with a uniform metal coating film is enabled, and peeling of the plating can be improved by eliminating the influence of the second phase particles in the aluminum alloy substrate for a magnetic disk. When the film thickness is 3,000 nm or less, since the change in the degree of flatness can be suppressed by coating the substrate with an alloy having a different thermal expansion coefficient, peeling of the plating accompanied by any change in the degree of flatness can be further suppressed. Therefore, it is preferable to have a metal coating film having a film thickness of 10 nm or more and 3,000 nm or less. Furthermore, as a technique of coating with a uniform metal coating film having a thickness of 10 nm or more and 3,000 nm or less, it is more preferable to use physical vapor deposition.

### (Method of Producing Substrate for Magnetic Disk)

Hereinafter, various steps and process conditions of the production process for the substrate for a magnetic disk according to the embodiment of the present invention will be explained in detail.

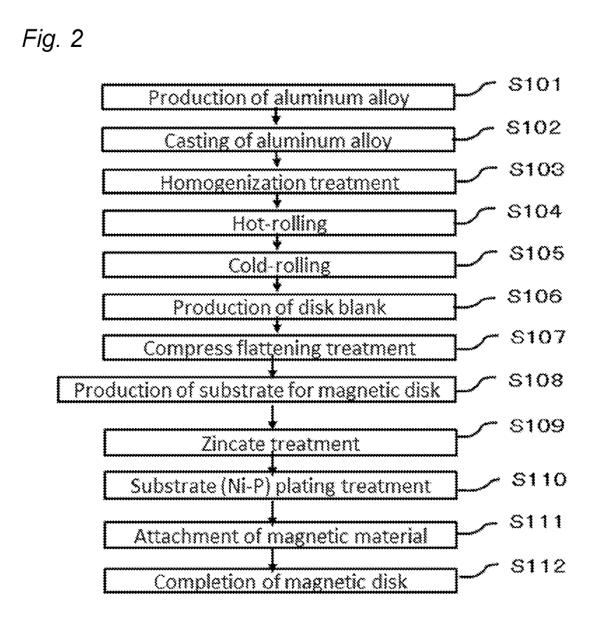

A method of producing a magnetic disk using a bare material of the aluminum alloy substrate for a magnetic disk will be explained with reference to the process flow shown in FIG. 2. Here, Production of aluminum alloy (Step S101) to Cold-rolling (Step S105) are processes for producing an aluminum alloy sheet, and Production of disk blank (Step S106) to Attachment of magnetic material (Step S111) are processes for making the aluminum alloy sheet thus produced into a magnetic disk. First, the processes for producing an aluminum alloy substrate for a magnetic disk from a bare material will be explained.

First, a molten metal of an aluminum alloy material having the above-mentioned element composition is produced by heating and melting the components according to a usual manner (Step S101). Next, an aluminum alloy is cast from the molten metal of the aluminum alloy material thus produced, by a semi-continuous casting (DC casting) method, a continuous casting (CC casting) method, or the like (Step S102). Here, the DC casting method and the CC casting method are as follows.

DC casting: A molten metal poured through a spout is deprived of heat by the bottom block, walls of a water-cooled mold, and cooling water that is directly jetted out to the outer periphery of an ingot, and is solidified. Thus, the solidified molten metal is drawn downward as an ingot.

CC casting: A molten metal is supplied through a casting nozzle between a pair of rolls (or a belt caster or a block caster), and a thin sheet is directly cast as a result of heat dissipation through the rolls.

A major difference between the DC casting method and the CC casting method is the cooling speed at the time of casting, and it is characteristic that in CC casting with a high cooling speed, the size of the second phase particles is smaller, as compared to the case of DC casting. Preferably, the cooling speed at the time of casting is in the range from 0.1° C. to 1,000° C./s. When the cooling speed at the time of casting is set to 0.1° C. to 1,000° C./s, a large number of second phase particles having the longest diameter of 4 μm or more and 30 μm or less are produced, the sum of the circumferences of the second phase particles becomes long, and an effect of enhancing the fluttering characteristics can be obtained. When the cooling speed at the time of casting is less than 0.1° C./s, there is a possibility that the sum of the circumferences of the second phase particles having the longest diameter of 4 μm or more and 30 μm or less may become more than 1,000 mm/mm². In this case, the second phase particles fall off at the time of etching, at the time of a zincate treatment, or at the time of cutting or grinding work, large pits are generated, and there is a possibility that peeling of the plating may also occur. On the other hand, in the case where the cooling speed at the time of casting is more than 1,000° C./s, there is a possibility that the sum of the circumferences of the second phase particles having the longest diameter of 4 μm or more and 30 μm or less may become less than 10 mm/mm². In this case, there is a possibility that sufficient fluttering characteristics may not be obtained.

Next, a homogenization treatment of the cast aluminum alloys is performed (Step S103). The homogenization treatment is preferably carried out in two stages by performing a heating treatment at 400° C. to 470° C. for 0.5 hours or more and less than 50 hours, and then further performing another heating treatment at a temperature of higher than 470° C. and lower than 630° C. for 1 hour or more and less than 30 hours. When the homogenization treatment is carried out by a two-stage heating treatment, by which a heating treatment is performed at 400° C. to 470° C. for 0.5 hours or more and less than 50 hours and then another heating treatment is performed at a temperature of higher than 470° C. and lower than 630° C. for 1 hour or more and less than 30 hours, a large number of second phase particles having the longest diameter of 4 μm or more and 30 μm or less are produced, the sum of the circumferences of the second phase particles is increased, and thus an effect of enhancing the fluttering characteristics can be obtained. If the heating temperature or time at the time of the first stage homogenization treatment is lower than less than 400° C. or less than 0.5 hours, there is a possibility that the sum of the circumferences of the second phase particles having the longest diameter of 4 μm or more and 30 μm or less may become less than 10 mm/mm², and there is a possibility that sufficient fluttering characteristics may not be obtained. If the heating temperature or time at the time of the first stage homogenization treatment is higher than 470° C. or 50 hours or more, there is a possibility that the sum of the circumferences of the second phase particles having the longest diameter of 4 μm or more and 30 μm or less may become more than 1,000 mm/mm². In this case, the second phase particles fall off at the time of etching, at the time of a zincate treatment, or at the time of cutting or grinding work, large pits are generated, and there is a possibility that peeling of the plating may occur. On the other hand, if the heating temperature or time at the time of the second stage homogenization treatment is 470° C. or lower or less than 1 hours, there is a possibility that the sum of the circumferences of the second phase particles having the longest diameter of 4 μm or more and 30 μm or less may become less than 10 mm/mm², and there is a possibility that sufficient fluttering characteristics may not be obtained. If the heating temperature or time at the time of the second stage homogenization treatment is 630° C. or higher or 30 hours or more, there is a possibility that the sum of the circumferences of the second phase particles having the longest diameter of 4 μm or more and 30 μm or less may become more than 1,000 mm/mm². In this case, the second phase particles fall off at the time of etching, at the time of a zincate treatment, or at the time of cutting or grinding work, large pits are generated, and there is a possibility that peeling of the plating may occur.

Next, the aluminum alloy that has been subjected to a homogenization treatment is hot-rolled, and thus a sheet material is obtained (Step S104). On the occasion of performing hot-rolling, the conditions are not particularly limited, and the hot-rolling initiation temperature is preferably 300° C. to 600° C., while the hot-rolling completion temperature is preferably 260° C. to 400° C. Next, the hot-rolled sheet is subjected to cold-rolling, and thus an aluminum alloy sheet having a thickness of from about 1.3 mm to 0.45 mm is produced (Step S105). After completion of the hot-rolling, a manufactured product having a required thickness is completed by cold-rolling. The conditions for cold-rolling are not particularly limited and may be set according to the required product sheet strength or sheet thickness. The rolling ratio is preferably 10% or higher and 95% or lower. Before cold-rolling or in the middle of cold-rolling, an annealing treatment may be performed in order to secure cold-rolling workability. In the case of performing an annealing treatment, for example, if batch type heating is to be performed, it is preferable to perform the annealing treatment under the conditions of 300° C. or higher and 390° C. or lower for 0.1 hours or more and 10 hours or less. Furthermore, in the case of continuous type heating, it is preferable to perform heating under the conditions of maintaining at 400° C. to 500° C. for 0 to 60 seconds.

In order to process the aluminum alloy sheet for the use as a magnetic disk, the aluminum alloy sheet is punched into an annular shape, and a disk blank is produced (Step S106). Next, the disk blank is subjected to compressed annealing in the air at a temperature of, for example, 100° C. or higher and 390° C. or lower for 30 minutes or longer, and a flattened blank is produced (Step S107). Next, cutting work and grinding work of the blank are performed, and thus an aluminum alloy substrate is produced (Step S108). Next, the aluminum alloy substrate surface is subjected to degreasing, etching, and a zincate treatment (Zn-substitution treatment) (Step S109). Next, the zincate-treated surface is subjected to a substrate treatment (Ni—P plating), and thus an aluminum alloy substrate is produced (Step S110). Next, a magnetic material is attached to the substrate-treated surface by sputtering to obtain a magnetic disk (Step S111).

Incidentally, after the bare material and the clad material are both produced into aluminum alloy sheets, there is no change for the bare material and the clad material to be exposed to a temperature higher than 390° C., and therefore, the distribution (microstructure) or components of the second phase particles will not be changed. Therefore, instead of the aluminum alloy substrate, an evaluation of the distribution or components of the second phase particles may be carried out using an aluminum alloy sheet, a disk blank, an aluminum alloy substrate, or a magnetic disk.

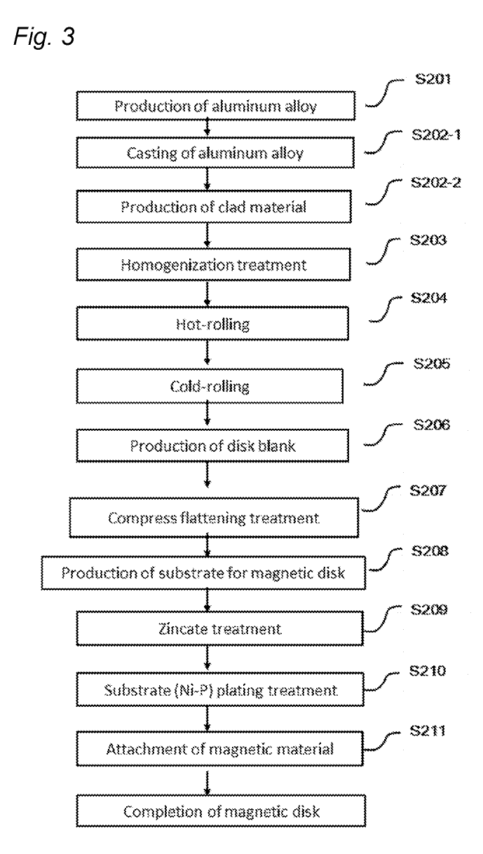

Next, a method of producing a magnetic disk using a clad material of the aluminum alloy substrate for a magnetic disk will be explained with reference to the process flow shown in FIG. 3. Here, Production of aluminum alloy (Step S201) to Cold-rolling (Step S205) are processes for producing an aluminum alloy sheet, and Production of disk blank (Step S206) to Attachment of magnetic material (Step S211) are processes for making the aluminum alloy sheet thus produced into a magnetic disk.

First, for the core alloy and the skin alloy, molten metals of aluminum alloy materials having the element composition described above are produced by heating and melting the components according to a usual manner (Step S201). Next, aluminum alloys are cast from the molten metals of the aluminum alloy materials that have been mixed at the desired compositions, by a semi-continuous casting (DC casting) method or a continuous casting (CC casting) method (Step S202-1). Next, a step of performing a homogenization treatment of an ingot for the skin alloy and performing hot-rolling to obtain a desired skin alloy, and a step of face milling an ingot for the core alloy to obtain a core alloy having a desired sheet thickness, laminating the skin alloy on both surfaces of the core alloy, and thereby obtaining a laminated material, is carried out (Step S202-2).

In the case of producing an aluminum alloy substrate for a magnetic disk of the clad material by a rolling-pressure welding method, an ingot produced by, for example, a semi-continuous casting (DC casting) method or a continuous casting (CC casting) method is used for the core alloy. After casting, by having an oxide film removed by performing mechanical removal, such as face milling or cutting, or chemical removal, such as alkali washing, subsequent pressure welding between the core alloy and the skin alloy is satisfactorily achieved (Steps S202-1 and S202-2).

Regarding the skin alloy, an ingot obtained by a DC casting method or a CC casting method is face milled and hot-rolled, and thus a sheet material having a predetermined dimension is obtained. It is acceptable not to perform homogenization treatment before hot-rolling; however, in the case of performing the homogenization treatment, it is preferable to perform the treatment under the conditions of 350° C. or higher and 550° C. or lower for 1 hour or longer. Upon performing hot-rolling in order to produce the skin alloy to have a desired thickness, the conditions are not particularly limited, and it is preferable to adjust the hot-rolling initiation temperature to be 350° C. or higher and 500° C. or lower, and to adjust the hot-rolling completion temperature to be 260° C. or higher and 380° C. or lower. Furthermore, when the raw sheet obtained after hot-rolling in order to adjust the skin alloy to a desired thickness is washed with nitric acid, caustic soda, or the like, an oxide film produced by the hot-rolling is removed, and pressure welding between the core alloy and the skin alloy is satisfactorily achieved (Steps S202-1 and S202-2).

According to the embodiment of the present invention, on the occasion of cladding the core alloy and the skin alloy, the cladding ratio of the skin alloy (ratio of the skin alloy thickness with respect to the total thickness of the clad material) is not particularly limited; however, the cladding ratio is set as appropriate according to the required product sheet strength, the degree of flatness, and the amount of grinding. Thus, the cladding ratio is preferably set to 3% or higher and 30% or lower, and more preferably set to 5% or higher and 20% or lower.

For example, a step of performing hot-rolling to obtain a skin alloy having a sheet thickness of about 15 mm, an ingot for core alloy is face milled into a core alloy having a sheet thickness of about 270 mm, and laminating the skin alloy on both surfaces of the core alloy to obtain a laminated material.

Next, a homogenization treatment of the cast aluminum alloys is performed (Step S203). The homogenization treatment for the laminated material of the core alloy and the skin alloy is preferably carried out in two stages by performing a heating treatment at 400° C. to 470° C. for 0.5 hours or more and less than 50 hours, and then further performing another heating treatment at a temperature of higher than 470° C. and lower than 630° C. for 1 hour or more and less than 30 hours.

When the laminated material of the core alloy and the skin alloy is subjected to a homogenization treatment, it is necessary to suppress as far as possible the production of an oxide film at the interface between the core alloy and the skin alloy. In order to do so, in the case of performing a homogenization treatment on an aluminum alloy having a composition that is likely to produce an oxide film, it is preferable to perform the homogenization treatment in a non-oxidative atmosphere, such as, for example, an inert gas, such as nitrogen gas or argon gas, a reducing gas, such as carbon monoxide, or a gas at reduced pressure, such as a vacuum.

Next, the aluminum alloy that has been subjected to a homogenization treatment is hot-rolled, and thus a sheet material is obtained (Step S204). By performing hot-rolling, cladding of the core alloy and the skin alloy is achieved. On the occasion of performing hot-rolling, the conditions are not particularly limited, and the hot-rolling initiation temperature is preferably 300° C. or higher and 600° C. or lower, while the hot-rolling completion temperature is preferably 260° C. or higher and 400° C. or lower. Here, the sheet thickness is adjusted to be about 3.0 mm.

The aluminum alloy sheet obtained by hot-rolling can be completed into a desired product sheet thickness by cold-rolling (Step S205). The conditions for cold-rolling are not particularly limited and may be set according to the required product sheet strength or sheet thickness. The rolling ratio is preferably 10% or higher and 95% or lower.

Before cold-rolling or in the middle of cold-rolling, an annealing treatment may be performed in order to secure cold-rolling workability. In the case of performing an annealing treatment, for example, if batch type heating is to be performed, it is preferable to perform the annealing treatment under the conditions of 300° C. or higher and 390° C. or lower for 0.1 hours or more and 10 hours or less.

In this embodiment of the present invention, the sheet thickness is preferably in the range of from about 1.3 mm to about 0.45 mm.

The various steps described above all relate to the production of second phase particles; however, the characteristics of the aluminum alloy substrate for a magnetic disk of the core alloy according to this embodiment of the present invention are significantly affected particularly by the cooling speed at the time of casting of the core alloy of Step S202-1. Regarding the cooling speed at the time of casting the core alloy, in order to obtain a desired distribution of the second phase particles, it is preferable that the cooling speed is set to be 0.1° C./s or higher and 1,000° C./s or lower.

When the cooling speed at the time of casting of the core alloy is set to be 0.1° C./s to 1,000° C./s, a large number of second phase particles having the longest diameter of 4 μm or more and 30 μm or less are produced in the core alloy, the sum of the circumferences of the second phase particles is increased, and an effect of enhancing the fluttering characteristics can be obtained. If the cooling speed at the time of casting the core alloy is lower than 0.1° C./s, there is a possibility that the sum of the circumferences of the second phase particles having the longest diameter of 4 μm or more and 30 μm or less may become more than 1,000 mm/mm². In this case, coarse second phase particles on the substrate side surface fall off at the time of etching, at the time of a zincate treatment, or at the time of cutting or grinding work, large pits are generated, and there is a possibility that peeling of the plating may occur at the boundaries between the core alloy and the skin alloy on the substrate side surface. Meanwhile, in the case where the cooling speed at the time of casting is higher than 1,000° C./s, there is a possibility that the sum of the circumferences of the second phase particles having the longest diameter of 4 μm or more and 30 μm or less may become less than 10 mm/mm², and there is a possibility that sufficient fluttering characteristics may not be obtained.

In this embodiment of the present invention, various methods can be applied in order to clad the core alloy and the skin alloy. For example, a rolling-pressure welding method that is usually used in the production of a brazing sheet or the like may be mentioned. This rolling-pressure welding method is carried out by subjecting a laminated material of a core alloy and a skin alloy to a homogenization treatment (Step S203), hot-rolling (Step S204), and cold-rolling (Step S205) in this order.

It is preferable that the homogenization treatment of the laminated material by performing a two-stage heat treatment, in which a heating treatment is performed at 400° C. to 470° C. for 0.5 hours or more and less than 50 hours, and then another heating treatment is performed at a temperature of higher than 470° C. and lower than 630° C. for 1 hour or more and less than 30 hours. When the homogenization treatment is carried out by a two-stage heating treatment of performing a heating treatment at 400° C. to 470° C. for 0.5 hours or more and less than 50 hours and then performing another heating treatment at a temperature of higher than 470° C. and lower than 630° C. for 1 hour or more and less than 30 hours, a large number of second phase particles having the longest diameter of 4 μm or more and 30 μm or less are produced in the core alloy, the sum of the circumferences of the second phase particles is increased, and an effect of enhancing the fluttering characteristics can be obtained. If the heating temperature or time at the time of the first stage homogenization treatment is lower than 400° C. or less than 0.5 hours, there is a possibility that the sum of the circumferences of the second phase particles having the longest diameter of 4 μm or more and 30 μm or less in the core alloy may become less than 10 mm/mm², and there is a possibility that sufficient fluttering characteristics may not be obtained. If the heating temperature or time at the time of the first stage homogenization treatment is higher than 470° C. or 50 hours or more, there is a possibility that the sum of the circumferences of the second phase particles having the longest diameter of 4 μm or more and 30 μm or less in the core alloy may become more than 1,000 mm/mm². In this case, coarse second phase particles on the substrate side surface fall off at the time of etching, at the time of a zincate treatment, or at the time of cutting or grinding work, large pits are generated, and there is a possibility that peeling of the plating may occur at the boundaries between the core alloy and the skin alloy on the substrate side surface. On the other hand, if the heating temperature or time at the time of the second stage homogenization treatment is 470° C. or lower or less than 1 hour, there is a possibility that the sum of the circumferences of the second phase particles having the longest diameter of 4 μm or more and 30 μm or less in the core alloy may become less than 10 mm/mm². In this case, there is a possibility that sufficient fluttering characteristics may not be obtained. If the heating temperature or time at the time of the second stage homogenization treatment is 630° C. or higher or 30 hours or more, there is a possibility that the sum of the circumferences of the second phase particles having the longest diameter of 4 μm or more and 30 μm or less in the core alloy may become more than 1,000 mm/mm². In this case, coarse second phase particles on the substrate side surface fall off at the time of etching, at the time of a zincate treatment, or at the time of cutting or grinding work, large pits are generated, and there is a possibility that peeling of the plating may occur at the boundaries between the core alloy and the skin alloy on the substrate side surface.

In order to process the aluminum alloy sheet of a dad material for the use as a magnetic disk, steps of production of a disk blank (Step S206) to attachment of a magnetic material (Step S211) are carried out. The steps of production of a disk blank (Step S206) to attachment of a magnetic material (Step S211) are similar to the steps of production of a disk blank (Step S106) to attachment of a magnetic material (Step S111), which are steps for processing an aluminum alloy sheet as a bare material for the use as a magnetic disk.

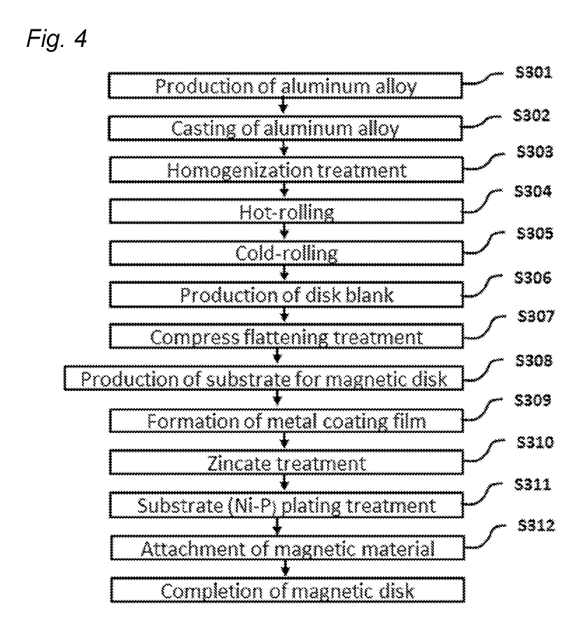

Furthermore, the process flow in the case of forming a metal thin film is shown in FIG. 4. Here, production of an aluminum alloy (Step S301) to cold-rolling (Step S305) are steps for producing an aluminum alloy sheet, and production of a disk blank (Step S306) to attachment of a magnetic material (Step S312) are steps for processing the aluminum alloy sheet thus produced into a magnetic disk. The various steps of production of an aluminum alloy (Step S301) to cold-rolling (Step S305) are similar to the various steps of production of an aluminum alloy (Step S101) to cold-rolling (Step S105), which are various steps for producing and processing an aluminum alloy substrate for a magnetic disk as a bare material.

In the production of a disk blank (Step S306) to attachment of a magnetic material (Step S312), first, an aluminum alloy sheet is punched into an annular shape, and a disk blank is produced (Step S306). Next, the disk blank is subjected to pressure annealing in the air at a temperature of, for example, 100° C. or higher and 390° C. or lower for 30 minutes or more, and a flattened blank is produced (Step S307). Next, the blank is subjected to cutting work and/or grinding work, and thus an aluminum alloy substrate is obtained (Step S308). Next, the surface of the aluminum alloy substrate is subjected to degreasing and etching as necessary, and the disk blank is coated with a metal coating film by physical vapor deposition (Step S309). Next, the surface of the disk blank that has been coated with the metal coating film by physical vapor deposition is subjected to degreasing, an etching treatment, and two times of a zincate treatment (Zn-substitution treatment) (Step S310). The surface that has been subjected to the two times of the zincate treatment as such is subjected to a substrate treatment (Ni—P plating), and thus a coated aluminum alloy substrate is produced (Step S311). Next, a magnetic material is attached to the substrate-treated surface by sputtering, and thus a magnetic disk is produced (Step S312).

In this embodiment of the present invention, various methods can be applied to the formation of a metal coating film by physical vapor deposition. For example, formation of a metal coating film can be carried out by vacuum vapor deposition, molecular beam epitaxy (MBE), ion plating, ion beam epitaxy, conventional sputtering, magnetron sputtering, ion beam sputtering, ECR sputtering, or the like. When a metal thin film is formed, peeling of the plating does not easily occur, and the resultant magnetic disk can be used more suitably.

### Examples

The present invention will be described in more detail based on examples given below, but the invention is not meant to be limited by these.

### (Aluminum Alloy Substrate for a Magnetic Disk, as the Bare Material)

First, Examples of an aluminum alloy substrate for a magnetic disk, as a bare material, will be explained. Various alloy raw-materials having the element compositions indicated in Table 1 to Table 3 were melted according to a usual manner, and aluminum alloy molten metals were produced (Step S101). In Table 1 to Table 3, the symbol “-” implies that the result was below the detection limit.

TABLE 1

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| A1 | 0.20 | — | — | — | — | — | — | — | — | — | — | — | — | — | — |
| A2 | 0.40 | — | — | — | — | — | — | — | — | — | — | — | — | — | — |
| A3 | 5.00 | — | — | — | — | — | — | — | — | — | — | — | — | — | — |
| A4 | 18.00 | — | — | — | — | — | — | — | — | — | — | — | — | — | — |
| A5 | 24.00 | — | — | — | — | — | — | — | — | — | — | — | — | — | — |
| A6 | — | 0.20 | — | — | — | — | — | — | — | — | — | — | — | — | — |
| A7 | — | 0.50 | — | — | — | — | — | — | — | — | — | — | — | — | — |
| A8 | — | 5.00 | — | — | — | — | — | — | — | — | — | — | — | — | — |
| A9 | — | 10.00 | — | — | — | — | — | — | — | — | — | — | — | — | — |
| A10 | — | — | 0.20 | — | — | — | — | — | — | — | — | — | — | — | — |
| A11 | — | — | 0.50 | — | — | — | — | — | — | — | — | — | — | — | — |
| A12 | — | — | 5.00 | — | — | — | — | — | — | — | — | — | — | — | — |
| A13 | — | — | 15.00 | — | — | — | — | — | — | — | — | — | — | — | — |
| A14 | — | — | — | 0.20 | — | — | — | — | — | — | — | — | — | — | — |
| A15 | — | — | — | 0.50 | — | — | — | — | — | — | — | — | — | — | — |
| A16 | — | — | — | 10.00 | — | — | — | — | — | — | — | — | — | — | — |
| A17 | — | — | — | 20.00 | — | — | — | — | — | — | — | — | — | — | — |
| A18 | 0.40 | 1.50 | 0.50 | 0.50 | 0.005 | — | — | — | — | — | — | — | — | — | — |
| A19 | 0.40 | 1.50 | 0.50 | 0.50 | 10.000 | — | — | — | — | — | — | — | — | — | — |
| A20 | 0.40 | 1.50 | 0.50 | 0.50 | — | 0.105 | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | Si + Fe + | | unavoidable |
| No. | Cd | Bi | Ge | Zn | Ti | B | V | Mn + Ni | Ti + B + V | impurities |
| A1 | — | — | — | — | — | — | — | 0.20 | 0.000 | Balance |
| A2 | — | — | — | — | — | — | — | 0.40 | 0.000 | Balance |
| A3 | — | — | — | — | — | — | — | 5.00 | 0.000 | Balance |
| A4 | — | — | — | — | — | — | — | 18.00 | 0.000 | Balance |
| A5 | — | — | — | — | — | — | — | 24.00 | 0.000 | Balance |
| A6 | — | — | — | — | — | — | — | 0.20 | 0.000 | Balance |
| A7 | — | — | — | — | — | — | — | 0.50 | 0.000 | Balance |
| A8 | — | — | — | — | — | — | — | 5.00 | 0.000 | Balance |
| A9 | — | — | — | — | — | — | — | 10.00 | 0.000 | Balance |
| A10 | — | — | — | — | — | — | — | 0.20 | 0.000 | Balance |
| A11 | — | — | — | — | — | — | — | 0.50 | 0.000 | Balance |
| A12 | — | — | — | — | — | — | — | 5.00 | 0.000 | Balance |
| A13 | — | — | — | — | — | — | — | 15.00 | 0.000 | Balance |
| A14 | — | — | — | — | — | — | — | 0.20 | 0.000 | Balance |
| A15 | — | — | — | — | — | — | — | 0.50 | 0.000 | Balance |
| A16 | — | — | — | — | — | — | — | 10.00 | 0.000 | Balance |
| A17 | — | — | — | — | — | — | — | 20.00 | 0.000 | Balance |
| A18 | — | — | — | — | — | — | — | 2.90 | 0.000 | Balance |
| A19 | — | — | — | — | — | — | — | 2.90 | 0.000 | Balance |
| A20 | — | — | — | — | — | — | — | 2.90 | 0.000 | Balance |

TABLE 2

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| A21 | 0.40 | 1.50 | 0.50 | 0.50 | — | 0.905 | — | — | — | — | — | — | — | — | — |
| A22 | 0.40 | — | — | — | — | 6.008 | — | — | — | — | — | — | — | — | — |
| A23 | 0.40 | 1.50 | — | — | — | — | 0.010 | — | — | 0.002 | — | — | — | — | — |
| A24 | 0.40 | 1.50 | — | — | — | — | 5.000 | — | — | — | 0.002 | — | — | — | — |
| A25 | 0.40 | 1.50 | — | — | — | — | — | 0.010 | — | — | — | 0.002 | — | — | — |
| A26 | 0.40 | 1.50 | — | — | — | — | — | 5.000 | — | 0.090 | — | — | — | — | — |
| A27 | 0.40 | 1.50 | — | — | — | — | — | — | 0.0001 | — | 0.090 | — | — | — | — |
| A28 | 0.40 | 1.50 | — | — | — | — | — | — | 0.1000 | — | — | 0.090 | — | — | — |
| A29 | 0.20 | 1.50 | — | — | — | — | — | — | — | — | — | — | 5.0 | — | — |
| A30 | 0.20 | 1.50 | 0.10 | — | — | — | — | — | — | — | — | — | — | 5.0 | — |
| A31 | 0.20 | 1.50 | — | 0.10 | — | — | — | — | — | — | — | — | — | — | 5.0 |
| A32 | 0.20 | 1.50 | — | — | — | — | — | — | — | — | — | — | — | — | — |
| A33 | 0.20 | 1.50 | — | — | — | — | — | — | — | — | — | — | — | — | — |
| A34 | 0.20 | 1.50 | — | — | — | — | — | — | — | — | — | — | — | — | — |
| A35 | 0.10 | 0.05 | 0.10 | 0.10 | — | — | — | — | — | — | — | — | — | — | — |
| A36 | 0.10 | 0.10 | — | — | — | — | — | — | — | — | — | — | — | — | — |
| A37 | 0.40 | 0.20 | 0.10 | 0.10 | 0.010 | 0.300 | — | — | — | — | — | — | 0.1 | — | — |
| A38 | 0.10 | 1.50 | 0.50 | 0.10 | 0.010 | 0.300 | — | — | — | — | — | — | — | 0.1 | — |
| A39 | 0.10 | 0.20 | 1.00 | — | 0.010 | 0.300 | — | — | — | — | — | — | — | — | 0.1 |
| A40 | 0.10 | 0.20 | — | 1.50 | 0.010 | 0.300 | — | — | — | — | — | — | — | — | — |
| A41 | 0.40 | 1.50 | 0.50 | 0.50 | 0.400 | — | — | — | — | — | — | — | — | — | — |
| A42 | 0.40 | 0.20 | — | — | 0.300 | 0.900 | — | — | — | — | — | — | — | — | — |
| A43 | 0.20 | 0.20 | 0.10 | 0.10 | 0.300 | 0.900 | 0.200 | 0.010 | 0.0001 | 0.001 | 0.001 | 0.001 | 0.1 | 0.1 | 0.1 |
| A44 | 25.00 | — | — | — | — | — | — | — | — | — | — | — | — | — | — |
| A45 | — | 11.00 | — | — | — | — | — | — | — | — | — | — | — | — | — |
| A46 | — | — | 16.00 | — | — | — | — | — | — | — | — | — | — | — | — |
| A47 | — | — | — | 21.0 | — | — | — | — | — | — | — | — | — | — | — |
| A48 | — | — | — | 21.0 | — | — | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | Si + Fe + | | unavoidable |
| No. | Cd | Bi | Ge | Zn | Ti | B | V | Mn + Ni | Ti + B + V | impurities |
| A21 | — | — | — | — | — | — | — | 2.90 | 0.000 | Balance |
| A22 | — | — | — | — | — | — | — | 0.40 | 0.000 | Balance |
| A23 | — | — | — | — | — | — | — | 1.90 | 0.000 | Balance |
| A24 | — | — | — | — | — | — | — | 1.90 | 0.000 | Balance |
| A25 | — | — | — | — | — | — | — | 1.90 | 0.000 | Balance |
| A26 | — | — | — | — | — | — | — | 1.90 | 0.000 | Balance |
| A27 | — | — | — | 0.005 | 0.005 | 0.001 | 0.001 | 1.90 | 0.007 | Balance |
| A28 | — | — | — | 10.000 | 0.454 | 0.023 | 0.012 | 1.90 | 0.489 | Balance |
| A29 | — | — | — | — | — | — | — | 1.70 | 0.000 | Balance |
| A30 | — | — | — | — | — | — | — | 1.80 | 0.000 | Balance |
| A31 | — | — | — | — | — | — | — | 1.80 | 0.000 | Balance |
| A32 | 5.0 | — | — | — | — | — | — | 1.70 | 0.000 | Balance |
| A33 | — | 5.0 | — | — | — | — | — | 1.70 | 0.000 | Balance |
| A34 | — | — | 1.0 | — | — | — | — | 1.70 | 0.000 | Balance |
| A35 | — | — | — | — | — | — | — | 0.35 | 0.000 | Balance |
| A36 | — | — | — | — | — | — | — | 0.20 | 0.000 | Balance |
| A37 | — | — | — | 0.300 | — | — | — | 0.80 | 0.000 | Balance |
| A38 | — | — | — | 0.300 | — | — | — | 2.20 | 0.000 | Balance |
| A39 | — | — | — | 0.300 | — | — | — | 1.30 | 0.000 | Balance |
| A40 | 0.1 | — | — | — | — | — | — | 1.80 | 0.000 | Balance |
| A41 | — | 0.1 | — | — | — | — | — | 2.90 | 0.000 | Balance |
| A42 | — | — | 0.1 | 5.500 | — | — | — | 0.60 | 0.000 | Balance |
| A43 | 0.1 | 0.1 | 0.1 | — | 0.070 | 0.001 | 0.021 | 0.60 | 0.092 | Balance |
| A44 | — | — | — | — | — | — | — | 25.00 | 0.000 | Balance |
| A45 | — | — | — | — | — | — | — | 11.00 | 0.000 | Balance |
| A46 | — | — | — | — | — | — | — | 16.00 | 0.000 | Balance |
| A47 | — | — | — | — | — | — | — | 21.00 | 0.000 | Balance |
| A48 | — | — | — | — | — | — | — | 21.00 | 0.000 | Balance |

TABLE 3

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| AC1 | 0.05 | — | — | — | — | — | — | — | — | — | — | — | — | — | — |
| AC2 | — | 0.02 | — | — | — | — | — | — | — | — | — | — | — | — | — |
| AC3 | — | — | 0.05 | — | — | — | — | — | — | — | — | — | — | — | — |
| AC4 | — | — | — | 0.05 | — | — | — | — | — | — | — | — | — | — | — |
| AC5 | 0.10 | 0.05 | — | — | — | — | — | — | — | — | — | — | — | — | — |
| AC6 | — | 0.05 | 0.10 | — | — | — | — | — | — | — | — | — | — | — | — |
| AC7 | — | 0.05 | — | 0.10 | — | — | — | — | — | — | — | — | — | — | — |
| AC8 | 0.10 | 0.10 | — | — | — | — | — | — | — | — | — | — | — | — | — |
| AC9 | 0.10 | — | 0.10 | — | — | — | — | — | — | — | — | — | — | — | — |
| AC10 | 0.10 | — | — | 0.10 | — | — | — | — | — | — | — | — | — | — | — |
| AC11 | — | — | 0.10 | 0.10 | — | — | — | — | — | — | — | — | — | — | — |
| AC12 | — | — | 0.10 | 0.10 | — | — | — | — | — | — | — | — | — | — | — |
| AC13 | 0.01 | 0.01 | — | — | 0.010 | 4.506 | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | Si + Fe + | | unavoidable |
| No. | Cd | Bi | Ge | Zn | Ti | B | V | Mn + Ni | Ti + B + V | impurities |
| AC1 | — | — | — | — | — | — | — | 0.05 | 0.000 | Balance |
| AC2 | — | — | — | — | — | — | — | 0.02 | 0.000 | Balance |
| AC3 | — | — | — | — | — | — | — | 0.05 | 0.000 | Balance |
| AC4 | — | — | — | — | — | — | — | 0.05 | 0.000 | Balance |
| AC5 | — | — | — | — | — | — | — | 0.15 | 0.000 | Balance |
| AC6 | — | — | — | — | — | — | — | 0.15 | 0.000 | Balance |
| AC7 | — | — | — | — | — | — | — | 0.15 | 0.000 | Balance |
| AC8 | — | — | — | — | — | — | — | 0.20 | 0.000 | Balance |
| AC9 | — | — | — | — | — | — | — | 0.20 | 0.000 | Balance |
| AC10 | — | — | — | — | — | — | — | 0.20 | 0.000 | Balance |
| AC11 | — | — | — | — | — | — | — | 0.20 | 0.000 | Balance |
| AC12 | — | — | — | — | — | — | — | 0.20 | 0.000 | Balance |
| AC13 | — | — | — | 0.300 | — | — | — | 0.02 | 0.000 | Balance |

Next, as shown in Table 4 to Table 6, ingots were produced by casting alloy Nos. A1 to A18, A20, A21, A23 to A31, A35 to A48, AC1 to AC7, and AC9 to AC13 by subjecting aluminum alloy molten metals to a DC casting method, and by casting alloy Nos. A19, A22, A32 to A34, and AC8 by subjecting aluminum alloy molten metals to a CC casting method (Step S102).

The ingots of alloy Nos. A1 to A18, A20, A21, A23 to A31, A35 to A48, AC1 to AC7, and AC9 to AC13 were subjected to face milling of 15 mm on both surfaces. Next, a homogenization treatment was applied under the conditions indicated in Table 4 to Table 6 (Step S103). Meanwhile, alloy No. A47 was retained for 5 hours at 630° C. to 640° C. after the second stage homogenization treatment. Furthermore, alloy No. AC11 was retained for 5 hours at 380° C. to 390° C. Next, hot-rolling was performed at a rolling initiation temperature of 370° C. and a rolling completion temperature of 310° C., and thus hot-rolled sheets having a sheet thickness of 3.0 mm were produced (Step S104). The hot-rolled sheets of alloy Nos. A1 to A6, A8 to A36, and AC1 to AC4 were subjected to annealing (batch type) under the conditions of 360° C. and for 2 hours. All of the sheet materials were rolled to a final sheet thickness of 0.8 mm by cold-rolling (rolling ratio 73.3%), and thus aluminum alloy sheets were obtained (Step S105). The aluminum alloy sheets were punched into an annular shape having an outer diameter of 96 mm and an inner diameter of 24 mm, and disk blanks were produced (Step S106).

The disk blanks were subjected to pressure annealing for 3 hours at 350° C. (Step S107). End surface processing was performed to adjust the outer diameter to 95 mm and the inner diameter to 25 mm, and grinding work (grinding of 10 μm from the surface) was performed (Step S108). Subsequently, degreasing was performed at 60° C. for 5 minutes by means of AD-68F (trade name, manufactured by C. Uyemura & Co., Ltd.), and then etching was performed at 65° C. for 1 minute by means of AD-107F (trade name, manufactured by C. Uyemura & Co., Ltd.). Furthermore, desmutting was performed for 20 seconds using a 30% aqueous solution of HNO₃ (room temperature) (Step S109). After the surface state was cleaned up as such, the disk blanks were subjected to a zincate treatment on the surface by immersing the disk blanks in a zincate treatment liquid at 20° C. of AD-301 F-3X (trade name, manufactured by C. Uyemura & Co., Ltd.) for 0.5 minutes (Step S109). The zincate treatment was performed two times in total, and the disk blanks were immersed in a 30% aqueous solution of HNO₃ at room temperature for 20 seconds between the zincate treatments so as to subject the surface to a peeling treatment. The surface that had been subjected to two times of a zincate treatment, was subjected to electroless plating with Ni—P to a thickness of 21 μm using an electroless Ni—P plating treatment liquid (NIMUDEN HDX (trade name, manufactured by C. Uyemura & Co., Ltd.)). The plated surface thus obtained were subjected to rough polishing using an alumina slurry having an average particle size of 800 nm and a polishing pad made of foamed or expanded urethane. The working amount of the rough polishing was set to 3.8 μm. Subsequently, finish polishing work was performed using a colloidal silica having a particle size of 20 to 200 nm and a polishing pad made of foamed or expanded urethane. The working amount of the finish polishing work was set to 0.2 μm. Furthermore, removal of the polishing grains, chips, and other attached foreign materials was performed by sufficiently scrubbing and washing the surface of the plated surface using an alkali cleaner and a PVA sponge, and sufficiently rinsing using deionized water having a resistivity of 18 MΩ·cm or more (Step S110).

The aluminum alloy ingots after the casting (Step S102) step, the aluminum alloy substrates after the grinding work (Step S108) step, and the aluminum alloy substrates after the plating treatment polishing (Step S110) step were subjected to the following evaluations. Meanwhile, ten disks of each alloy were processed up to the plating treatment. However, in some of the disks of Examples 3 to 5 and 44 to 48, peeling of the plating occurred. The number of disks in which peeling of the plating occurred was one sheet in Example 3; two sheets in Example 4; three sheets in Example 5; five sheets in Example 44; four sheets in Example 45; four sheets in Example 46; four sheets in Example 47; and four sheets in Example 48. In those Examples, evaluations were performed using the disks in which peeling of the plating did not occur.

TABLE 4

| | | | | | Homogenization | |
|---|---|---|---|---|---|---|
| | | | | | treatment conditions | |
| | | | | | | Keeping |
| | | | | | | time (hr) |
| | | | | | | at 2nd |
| | | | | | | stage at |
| | | | | | Keeping | higher |
| | | | | | time (hr) | than |
| | | Casting conditions | | Ingot | at 1st | 470° C. |
| | | | Casting | sheet | stage at | but |
| | Alloy | Casting | speed | thickness | 400 to | less than |
| | No. | method | (mm/min) | (mm) | 470° C. | 630° C. |
| Ex 1 | A1 | DC | 30 | 300 | 49 | 5 |
| Ex 2 | A2 | DC | 30 | 300 | 25 | 5 |
| Ex 3 | A3 | DC | 30 | 300 | 0.5 | 5 |
| Ex 4 | A4 | DC | 30 | 300 | 5 | 5 |
| Ex 5 | A5 | DC | 30 | 300 | 5 | 5 |
| Ex 6 | A6 | DC | 30 | 300 | 5 | 29 |
| Ex 7 | A7 | DC | 30 | 300 | 5 | 15 |
| Ex 8 | A8 | DC | 30 | 300 | 5 | 1 |
| Ex 9 | A9 | DC | 30 | 300 | 5 | 5 |
| Ex 10 | A10 | DC | 30 | 300 | 5 | 5 |
| Ex 11 | A11 | DC | 40 | 300 | 5 | 5 |
| Ex 12 | A12 | DC | 40 | 300 | 5 | 5 |
| Ex 13 | A13 | DC | 40 | 300 | 5 | 5 |
| Ex 14 | A14 | DC | 40 | 300 | 5 | 5 |
| Ex 15 | A15 | DC | 20 | 300 | 5 | 5 |
| Ex 16 | A16 | DC | 20 | 300 | 5 | 5 |
| Ex 17 | A17 | DC | 20 | 300 | 5 | 5 |
| Ex 18 | A18 | DC | 40 | 300 | 5 | 5 |
| Ex 19 | A19 | CC | 1000 | 4 | 5 | 5 |
| Ex 20 | A20 | DC | 40 | 300 | 5 | 5 |

Note:
″Ex″ means Example according to this invention (the same will be applied herein).

TABLE 5

| | | | | | Homogenization | |
|---|---|---|---|---|---|---|
| | | | | | treatment conditions | |
| | | | | | | Keeping |
| | | | | | | time (hr) |
| | | | | | | at 2nd |
| | | | | | | stage at |
| | | | | | Keeping | higher |
| | | | | | time (hr) | than |
| | | Casting conditions | | Ingot | at 1st | 470° C. |
| | | | Casting | sheet | stage at | but |
| | Alloy | Casting | speed | thickness | 400 to | less than |
| | No. | method | (mm/min) | (mm) | 470° C. | 630° C. |
| Ex 21 | A21 | DC | 50 | 300 | 5 | 5 |
| Ex 22 | A22 | CC | 1000 | 3 | 5 | 5 |
| Ex 23 | A23 | DC | 50 | 300 | 5 | 5 |
| Ex 24 | A24 | DC | 50 | 300 | 5 | 5 |
| Ex 25 | A25 | DC | 50 | 300 | 5 | 5 |
| Ex 26 | A26 | DC | 50 | 300 | 5 | 5 |
| Ex 27 | A27 | DC | 50 | 300 | 5 | 5 |
| Ex 28 | A28 | DC | 50 | 300 | 5 | 5 |
| Ex 29 | A29 | DC | 50 | 300 | 5 | 5 |
| Ex 30 | A30 | DC | 50 | 300 | 5 | 5 |
| Ex 31 | A31 | DC | 50 | 300 | 5 | 5 |
| Ex 32 | A32 | CC | 1400 | 6 | 5 | 5 |
| Ex 33 | A33 | CC | 1000 | 4 | 5 | 5 |
| Ex 34 | A34 | CC | 800 | 4 | 5 | 5 |
| Ex 35 | A35 | DC | 60 | 300 | 5 | 5 |
| Ex 36 | A36 | DC | 60 | 300 | 5 | 5 |
| Ex 37 | A37 | DC | 50 | 300 | 5 | 5 |
| Ex 38 | A38 | DC | 50 | 300 | 5 | 5 |
| Ex 39 | A39 | DC | 50 | 300 | 5 | 5 |
| Ex 40 | A40 | DC | 50 | 300 | 5 | 5 |
| Ex 41 | A41 | DC | 50 | 300 | 5 | 5 |
| Ex 42 | A42 | DC | 50 | 300 | 5 | 5 |
| Ex 43 | A43 | DC | 50 | 300 | 5 | 5 |
| Ex 44 | A44 | DC | 50 | 300 | 53 | 5 |
| Ex 45 | A45 | DC | 50 | 300 | 5 | 33 |
| Ex 46 | A46 | DC | 50 | 300 | 0.3 | 33 |
| Ex 47 | A47 | DC | 50 | 300 | 5 | 5 |
| Ex 48 | A48 | DC | 10 | 300 | 5 | 5 |

TABLE 6

| | | | | | Homogenization | |
|---|---|---|---|---|---|---|
| | | | | | treatment conditions | |
| | | | | | | Keeping |
| | | | | | | time (hr) |
| | | | | | | at 2nd |
| | | | | | | stage at |
| | | | | | Keeping | higher |
| | | | | | time (hr) | than |
| | | Casting conditions | | Ingot | at 1st | 470° C. |
| | | | Casting | sheet | stage at | but |
| | Alloy | Casting | speed | thickness | 400 to | less than |
| | No. | method | (mm/min) | (mm) | 470° C. | 630° C. |
| C Ex 1 | AC1 | DC | 30 | 300 | 5 | 5 |
| C Ex 2 | AC2 | DC | 30 | 300 | 5 | 5 |
| C Ex 3 | AC3 | DC | 30 | 300 | 5 | 5 |
| C Ex 4 | AC4 | DC | 30 | 300 | 5 | 5 |
| C Ex 5 | AC5 | DC | 30 | 300 | 5 | 5 |
| C Ex 6 | AC6 | DC | 30 | 300 | 5 | 5 |
| C Ex 7 | AC7 | DC | 30 | 300 | 5 | 5 |
| C Ex 8 | AC8 | CC | 600 | 4 | 5 | 5 |
| C Ex 9 | AC9 | DC | 30 | 300 | 0.3 | 1 |
| C Ex 10 | AC10 | DC | 30 | 300 | 5 | 0.3 |
| C Ex 11 | AC11 | DC | 30 | 300 | 0 | 0 |
| C Ex 12 | AC12 | DC | 30 | 300 | 0.3 | 0 |
| C Ex 13 | AC13 | DC | 30 | 300 | 5 | 5 |

Note:
″C Ex″ means Comparative Example (the same will be applied herein).

### [Cooling Speed at the Time of Casting]

The DAS (dendrite arm spacing) of the ingots after casting (Step S102) was measured, and the cooling speed (° C./s) at the time of casting was calculated. The DAS was analyzed by performing an observation of the cross-sectional microstructure in the thickness direction of the ingots using an optical microscope, and analyzing the cross-sectional microstructure by a secondary branching method. The analysis was made using a cross-section at the central part in the thickness direction of an ingot.

### [The Number of Second Phase Particles, the Longest Diameter, and the Sum of Circumferences]

A cross-section of an aluminum alloy substrate obtained after grinding work (Step S108) was observed with an optical microscope at a magnification of 400× in 20 viewing fields (the area of one viewing field: 0.05 mm²), and the number of second phase particles (particles/mm²), the longest diameter, and the sum of circumferences (mm/mm²) were measured using a particle analysis software program, A-ZOKUN (trade name, manufactured by Asahi Kasei Engineering Corporation). The measurement was made using a cross-section at the central part in the thickness direction of the substrate.

### [Measurement of Disk Flutter]

Measurement of disk flutter was performed using an aluminum alloy substrate after the plating treatment polishing (Step S110) step. The measurement of disk flutter was carried out by installing aluminum alloy substrates in a commercially available hard disk drive in the presence of the air. ST2000 (trade name) manufactured by Seagate Technology PLC was used as the drive, and motor driving was achieved by directly connecting SLD102 (trade name) manufactured by Techno Alive Co., Ltd. to a motor. The speed of rotation was set to 7,200 rpm. The disks were installed such that a plurality of disks were installed in every case, and vibration of the surface was observed by installing LDV1800 (trade name) manufactured by Ono Sokki Co., Ltd., which is a laser Doppler vibrometer, on the surface of the magnetic disk at the top. The vibration thus observed was subjected to a spectral analysis using a FFT analyzer DS3200 (trade name) manufactured by Ono Sokki Co., Ltd. The observation was made by making a hole in the lid of the hard disk driver and making an observation of the disk surface through the hole. Furthermore, the evaluation was performed after eliminating the squeeze plate that was installed in the commercially available hard disk.

The evaluation of the fluttering characteristics was carded out based on the maximum displacement (disk fluttering (nm)) of a broad peak near 300 Hz to 1,500 Hz where fluttering appeared. This broad peak is referred to as NRRO (non-repeatable run out), and it is understood that this broad peak significantly affects the positioning error of the head.

Rating of the fluttering characteristics was such that the case in which the value obtained in the air was 30 nm or less was rated as A (excellent); the case in which the value was larger than 30 nm and 40 nm or less was rated as B (good); the case in which the value was larger than 40 nm and 50 nm or less was rated as C (acceptable); and the case in which the value was larger than 50 nm was rated as D (poor).

### [Average Crystal Grain Size at Surface]

The aluminum alloy substrate surface (L-LT surface, rolled surface) after the grinding work (Step S108) was subjected to Barker etching using a Barker solution (an aqueous solution obtained by mixing HBF₄ (tetrafluoroboric acid) with water at a volume ratio of 1:30), and one image of the surface was taken with a polarized microscope at a magnification of 100×. Measurement of the crystal grain size was performed using a line intersection method of counting the number of intersecting crystal grains. Drawing of five straight lines each having a length of 500 μm in the LT direction (the direction perpendicular to the rolling direction) was performed, and the average value was determined.

TABLE 7

| | | | The number | The sum of | | |
|---|---|---|---|---|---|---|
| | | | of second | circum- | | |
| | | | phase | ferences | | |
| | | | particles | of second | | |
| | | | having the | phase | | |
| | | | longest | particles | | |
| | | | diameter of | having the | | |
| | | Cooling | 4 μm or | longest | | |
| | | speed | more and | diameter of | Average | |
| | | at the | 30 μm or | 4 μm or | crystal | |
| | | time of | less | more and | grain size | |
| | Alloy | casting | (particles/ | 30 μm or less | at surface | Disk |
| | No. | (° C./s) | mm²) | (mm/mm²) | (μm) | fluttering |
| Ex 1 | A1 | 0.4 | 192 | 11.3 | 60 | B |
| Ex 2 | A2 | 0.3 | 532 | 31.0 | 43 | A |
| Ex 3 | A3 | 0.5 | 3212 | 69.0 | 19 | A |
| Ex 4 | A4 | 0.8 | 14021 | 253.0 | 15 | A |
| Ex 5 | A5 | 0.4 | 38921 | 893.3 | 6 | A |
| Ex 6 | A6 | 0.5 | 321 | 12.5 | 53 | B |
| Ex 7 | A7 | 0.3 | 1432 | 35.2 | 23 | A |
| Ex 8 | A8 | 0.5 | 24212 | 432.7 | 14 | A |
| Ex 9 | A9 | 0.5 | 42103 | 923.1 | 12 | A |
| Ex 10 | A10 | 0.3 | 171 | 11.5 | 53 | B |
| Ex 11 | A11 | 0.8 | 987 | 49.3 | 34 | A |
| Ex 12 | A12 | 0.8 | 12321 | 543.2 | 23 | A |
| Ex 13 | A13 | 0.9 | 31232 | 874.3 | 19 | A |
| Ex 14 | A14 | 0.8 | 212 | 13.5 | 82 | C |
| Ex 15 | A15 | 0.2 | 1125 | 39.2 | 39 | A |
| Ex 16 | A16 | 0.2 | 17654 | 256.8 | 20 | A |
| Ex 17 | A17 | 0.2 | 45432 | 874.2 | 19 | A |
| Ex 18 | A18 | 0.7 | 6894 | 215.1 | 23 | A |
| Ex 19 | A19 | 750.0 | 10321 | 378.1 | 18 | B |
| Ex 20 | A20 | 0.9 | 7121 | 283.4 | 15 | A |

TABLE 8

| | | | The number | The sum of | | |
|---|---|---|---|---|---|---|
| | | | of second | circum- | | |
| | | | phase | ferences | | |
| | | | particles | of second | | |
| | | | having the | phase | | |
| | | | longest | particles | | |
| | | | diameter of | having the | | |
| | | Cooling | 4 μm or | longest | | |
| | | speed | more and | diameter of | Average | |
| | | at the | 30 μm or | 4 μm or | crystal | |
| | | time of | less | more and | grain size | |
| | Alloy | casting | (particles/ | 30 μm or less | at surface | Disk |
| | No. | (° C./s) | mm²) | (mm/mm²) | (μm) | fluttering |
| Ex 21 | A21 | 1.0 | 7531 | 189.4 | 15 | A |
| Ex 22 | A22 | 654.0 | 421 | 14.6 | 29 | B |
| Ex 23 | A23 | 0.9 | 5212 | 183.5 | 14 | A |
| Ex 24 | A24 | 0.8 | 12321 | 392.1 | 15 | A |
| Ex 25 | A25 | 0.5 | 6543 | 192.3 | 19 | A |
| Ex 26 | A26 | 0.5 | 15432 | 283.5 | 12 | A |
| Ex 27 | A27 | 0.5 | 4932 | 184.3 | 13 | A |
| Ex 28 | A28 | 0.8 | 5643 | 164.6 | 11 | A |
| Ex 29 | A29 | 0.9 | 8644 | 231.4 | 12 | A |
| Ex 30 | A30 | 0.8 | 7809 | 245.3 | 14 | A |
| Ex 31 | A31 | 0.8 | 8212 | 267.1 | 13 | A |
| Ex 32 | A32 | 212.0 | 4321 | 76.4 | 13 | A |
| Ex 33 | A33 | 891.0 | 3829 | 65.1 | 15 | A |
| Ex 34 | A34 | 974.3 | 2192 | 35.1 | 14 | A |
| Ex 35 | A35 | 1.1 | 212 | 11.2 | 38 | B |
| Ex 36 | A36 | 1.2 | 199 | 11.5 | 38 | B |
| Ex 37 | A37 | 0.8 | 2012 | 133.4 | 29 | A |
| Ex 38 | A38 | 0.9 | 6743 | 143.2 | 12 | A |
| Ex 39 | A39 | 0.8 | 1532 | 75.3 | 14 | A |
| Ex 40 | A40 | 0.8 | 5421 | 134.2 | 19 | A |
| Ex 41 | A41 | 0.9 | 6573 | 205.2 | 12 | A |
| Ex 42 | A42 | 0.8 | 981 | 66.3 | 28 | A |
| Ex 43 | A43 | 0.9 | 1211 | 54.2 | 32 | A |
| Ex 44 | A44 | 0.9 | 54321 | 1,120.1 | 12 | A |
| Ex 45 | A45 | 0.9 | 61211 | 1,098.3 | 5 | A |
| Ex 46 | A46 | 0.8 | 56503 | 1,234.5 | 12 | A |
| Ex 47 | A47 | 0.8 | 57520 | 1,231.1 | 11 | A |
| Ex 48 | A48 | 0.04 | 58123 | 1,125.0 | 10 | A |

TABLE 9

| | | | The | The sum | | |
|---|---|---|---|---|---|---|
| | | | number | of | | |
| | | | of | circum- | | |
| | | | second | ferences | | |
| | | | phase | of second | | |
| | | | particles | phase | | |
| | | | having the | particles | | |
| | | | longest | having the | | |
| | | | diameter of | longest | | |
| | | Cooling | 4 μm or | diameter | | |
| | | speed | more and | of 4 μm or | Average | |
| | | at the | 30 μm or | more and | crystal | |
| | | time of | less | 30 μm or | grain size | |
| | Alloy | casting | (particles/ | less | at surface | Disk |
| | No. | (° C./s) | mm²) | (mm/mm²) | (μm) | fluttering |
| C Ex 1 | AC1 | 0.4 | 43 | 3.0 | 68 | D |
| C Ex 2 | AC2 | 0.3 | 15 | 0.8 | 65 | D |
| C Ex 3 | AC3 | 0.5 | 18 | 1.0 | 67 | D |
| C Ex 4 | AC4 | 0.5 | 121 | 2.4 | 93 | D |
| C Ex 5 | AC5 | 0.3 | 141 | 5.4 | 58 | D |
| C Ex 6 | AC6 | 0.5 | 101 | 3.2 | 65 | D |
| C Ex 7 | AC7 | 0.5 | 171 | 2.8 | 54 | D |
| C Ex 8 | AC8 | 1092.0 | 81 | 1.2 | 54 | D |
| C Ex 9 | AC9 | 0.5 | 121 | 2.1 | 61 | D |
| C Ex 10 | AC10 | 0.3 | 69 | 1.0 | 48 | D |
| C Ex 11 | AC11 | 0.5 | 110 | 2.3 | 56 | D |
| C Ex 12 | AC12 | 0.3 | 115 | 2.1 | 52 | D |
| C Ex 13 | AC13 | 0.5 | 5 | 0.2 | 54 | D |

As shown in Tables 7 to 9, satisfactory fluttering characteristics were obtained in Examples 1 to 48.

Contrary to the above, in Comparative Examples 1 to 13, the sum of the circumferences of the second phase particles having the longest diameter of 4 nm or more and 30 μm or less in the metal microstructure was less than 10 mm/mm², and the fluttering characteristics were poor.

### (Aluminum Alloy Substrate for a Magnetic Disk, as the Clad Material)

First, Examples of an aluminum alloy substrate for a magnetic disk, as a clad material, will be explained.

Various alloys having the element compositions indicated in Table 10 to Table 15 were melted according to a usual manner, and aluminum alloy molten metals for core alloys were produced (Step S201). In Table 10 to Table 15, the symbol “-” implies that the result was below the detection limit.

TABLE 10

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| B1 | 0.20 | — | — | — | — | — | — | — | — | — | — | — | — | — | — |
| B2 | 0.40 | — | — | — | — | — | — | — | — | — | — | — | — | — | — |
| B3 | 5.00 | — | — | — | — | — | — | — | — | — | — | — | — | — | — |
| B4 | 18.00 | — | — | — | — | — | — | — | — | — | — | — | — | — | — |
| B5 | 24.00 | — | — | — | — | — | — | — | — | — | — | — | — | — | — |
| B6 | — | 0.20 | — | — | — | — | — | — | — | — | — | — | — | — | — |
| B7 | — | 0.50 | — | — | — | — | — | — | — | — | — | — | — | — | — |
| B8 | — | 5.00 | — | — | — | — | — | — | — | — | — | — | — | — | — |
| B9 | — | 10.00 | — | — | — | — | — | — | — | — | — | — | — | — | — |
| B10 | — | — | 0.20 | — | — | — | — | — | — | — | — | — | — | — | — |
| B11 | — | — | 0.50 | — | — | — | — | — | — | — | — | — | — | — | — |
| B12 | — | — | 5.00 | — | — | — | — | — | — | — | — | — | — | — | — |
| B13 | — | — | 15.00 | — | — | — | — | — | — | — | — | — | — | — | — |
| B14 | — | — | — | 0.20 | — | — | — | — | — | — | — | — | — | — | — |
| B15 | — | — | — | 0.50 | — | — | — | — | — | — | — | — | — | — | — |
| B16 | — | — | — | 10.00 | — | — | — | — | — | — | — | — | — | — | — |
| B17 | — | — | — | 20.00 | — | — | — | — | — | — | — | — | — | — | — |
| B18 | 0.40 | 1.50 | 0.50 | 0.50 | 0.005 | — | — | — | — | — | — | — | — | — | — |
| B19 | 0.40 | 1.50 | 0.50 | 0.50 | 10.000 | — | — | — | — | — | — | — | — | — | — |
| B20 | 0.40 | 1.50 | 0.50 | 0.50 | — | 0.105 | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | | | unavoidable |
| No. | Cd | Bi | Ge | Zn | Ti | B | V | Si + Fe + Mn + Ni | Ti + B + V | impurities |
| B1 | — | — | — | — | — | — | — | 0.20 | 0.000 | Balance |
| B2 | — | — | — | — | — | — | — | 0.40 | 0.000 | Balance |
| B3 | — | — | — | — | — | — | — | 5.00 | 0.000 | Balance |
| B4 | — | — | — | — | — | — | — | 18.00 | 0.000 | Balance |
| B5 | — | — | — | — | — | — | — | 24.00 | 0.000 | Balance |
| B6 | — | — | — | — | — | — | — | 0.20 | 0.000 | Balance |
| B7 | — | — | — | — | — | — | — | 0.50 | 0.000 | Balance |
| B8 | — | — | — | — | — | — | — | 5.00 | 0.000 | Balance |
| B9 | — | — | — | — | — | — | — | 10.00 | 0.000 | Balance |
| B10 | — | — | — | — | — | — | — | 0.20 | 0.000 | Balance |
| B11 | — | — | — | — | — | — | — | 0.50 | 0.000 | Balance |
| B12 | — | — | — | — | — | — | — | 5.00 | 0.000 | Balance |
| B13 | — | — | — | — | — | — | — | 15.00 | 0.000 | Balance |
| B14 | — | — | — | — | — | — | — | 0.20 | 0.000 | Balance |
| B15 | — | — | — | — | — | — | — | 0.50 | 0.000 | Balance |
| B16 | — | — | — | — | — | — | — | 10.00 | 0.000 | Balance |
| B17 | — | — | — | — | — | — | — | 20.00 | 0.000 | Balance |
| B18 | — | — | — | — | — | — | — | 2.90 | 0.000 | Balance |
| B19 | — | — | — | — | — | — | — | 2.90 | 0.000 | Balance |
| B20 | — | — | — | — | — | — | — | 2.90 | 0.000 | Balance |

TABLE 11

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| B21 | 0.40 | 1.50 | 0.50 | 0.50 | — | 0.905 | — | — | — | — | — | — | — | — | — |
| B22 | 0.40 | — | — | — | — | 6.008 | — | — | — | — | — | — | — | — | — |
| B23 | 0.40 | 1.50 | — | — | — | — | 0.010 | — | — | 0.002 | — | — | — | — | — |
| B24 | 0.40 | 1.50 | — | — | — | — | 5.000 | — | — | — | 0.002 | — | — | — | — |
| B25 | 0.40 | 1.50 | — | — | — | — | — | 0.010 | — | — | — | 0.002 | — | — | — |
| B26 | 0.40 | 1.50 | — | — | — | — | — | 5.000 | — | 0.090 | — | — | — | — | — |
| B27 | 0.40 | 1.50 | — | — | — | — | — | — | 0.0001 | — | 0.090 | — | — | — | — |
| B28 | 0.40 | 1.50 | — | — | — | — | — | — | 0.1000 | — | — | 0.090 | — | — | — |
| B29 | 0.20 | 1.50 | — | — | — | — | — | — | — | — | — | — | 5.0 | — | — |
| B30 | 0.20 | 1.50 | 0.10 | — | — | — | — | — | — | — | — | — | — | 5.0 | — |
| B31 | 0.20 | 1.50 | — | 0.10 | — | — | — | — | — | — | — | — | — | — | 5.0 |
| B32 | 0.20 | 1.50 | — | — | — | — | — | — | — | — | — | — | — | — | — |
| B33 | 0.20 | 1.50 | — | — | — | — | — | — | — | — | — | — | — | — | — |
| B34 | 0.20 | 1.50 | — | — | — | — | — | — | — | — | — | — | — | — | — |
| B35 | 0.10 | 0.05 | 0.10 | 0.10 | — | — | — | — | — | — | — | — | — | — | — |
| B36 | 0.10 | 0.10 | — | — | — | — | — | — | — | — | — | — | — | — | — |
| B37 | 0.40 | 0.20 | 0.10 | 0.10 | 0.010 | 0.300 | — | — | — | — | — | — | 0.1 | — | — |
| B38 | 0.10 | 1.50 | 0.50 | 0.10 | 0.010 | 0.300 | — | — | — | — | — | — | — | 0.1 | — |
| B39 | 0.10 | 0.20 | 1.00 | — | 0.010 | 0.300 | — | — | — | — | — | — | — | — | 0.1 |
| B40 | 0.10 | 0.20 | — | 1.50 | 0.010 | 0.300 | — | — | — | — | — | — | — | — | — |
| B41 | 0.40 | 1.50 | 0.50 | 0.50 | 0.400 | — | — | — | — | — | — | — | — | — | — |
| B42 | 0.40 | 0.20 | — | — | 0.300 | 0.900 | — | — | — | — | — | — | — | — | — |
| B43 | 0.20 | 0.20 | 0.10 | 0.10 | 0.300 | 0.900 | 0.200 | 0.010 | 0.0001 | 0.001 | 0.001 | 0.001 | 0.1 | 0.1 | 0.1 |
| B44 | 25.00 | — | — | — | — | — | — | — | — | — | — | — | — | — | — |
| B45 | — | 11.00 | — | — | — | — | — | — | — | — | — | — | — | — | — |
| B46 | — | — | 16.00 | — | — | — | — | — | — | — | — | — | — | — | — |
| B47 | — | — | — | 21.00 | — | — | — | — | — | — | — | — | — | — | — |
| B48 | — | — | — | 21.00 | — | — | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | Si + Fe + Mn + | | unavoidable |
| No. | Cd | Bi | Ge | Zn | Ti | B | V | Ni | Ti + B + V | impurities |
| B21 | — | — | — | — | — | — | — | 2.90 | 0.000 | Balance |
| B22 | — | — | — | — | — | — | — | 0.40 | 0.000 | Balance |
| B23 | — | — | — | — | — | — | — | 1.90 | 0.000 | Balance |
| B24 | — | — | — | — | — | — | — | 1.90 | 0.000 | Balance |
| B25 | — | — | — | — | — | — | — | 1.90 | 0.000 | Balance |
| B26 | — | — | — | — | — | — | — | 1.90 | 0.000 | Balance |
| B27 | — | — | — | 0.005 | 0.005 | 0.001 | 0.001 | 1.90 | 0.007 | Balance |
| B28 | — | — | — | 10.000 | 0.454 | 0.023 | 0.012 | 1.90 | 0.489 | Balance |
| B29 | — | — | — | — | — | — | — | 1.70 | 0.000 | Balance |
| B30 | — | — | — | — | — | — | — | 1.80 | 0.000 | Balance |
| B31 | — | — | — | — | — | — | — | 1.80 | 0.000 | Balance |
| B32 | 5.0 | — | — | — | — | — | — | 1.70 | 0.000 | Balance |
| B33 | — | 5.0 | — | — | — | — | — | 1.70 | 0.000 | Balance |
| B34 | — | — | 1.0 | — | — | — | — | 1.70 | 0.000 | Balance |
| B35 | — | — | — | — | — | — | — | 0.35 | 0.000 | Balance |
| B36 | — | — | — | — | — | — | — | 0.20 | 0.000 | Balance |
| B37 | — | — | — | 0.300 | — | — | — | 0.80 | 0.000 | Balance |
| B38 | — | — | — | 0.300 | — | — | — | 2.20 | 0.000 | Balance |
| B39 | — | — | — | 0.300 | — | — | — | 1.30 | 0.000 | Balance |
| B40 | 0.1 | — | — | 0.300 | — | — | — | 1.80 | 0.000 | Balance |
| B41 | — | 0.1 | — | — | — | — | — | 2.90 | 0.000 | Balance |
| B42 | — | — | 0.1 | — | — | — | — | 0.60 | 0.000 | Balance |
| B43 | 0.1 | 0.1 | 0.1 | 5.500 | 0.070 | 0.001 | 0.021 | 0.60 | 0.092 | Balance |
| B44 | — | — | — | — | — | — | — | 25.00 | 0.000 | Balance |
| B45 | — | — | — | — | — | — | — | 11.00 | 0.000 | Balance |
| B46 | — | — | — | — | — | — | — | 16.00 | 0.000 | Balance |
| B47 | — | — | — | — | — | — | — | 21.00 | 0.000 | Balance |
| B48 | — | — | — | — | — | — | — | 21.00 | 0.000 | Balance |

TABLE 12

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| BC1 | 0.05 | — | — | — | — | — | — | — | — | — | — | — | — | — | — |
| BC2 | — | 0.02 | — | — | — | — | — | — | — | — | — | — | — | — | — |
| BC3 | — | — | 0.05 | — | — | — | — | — | — | — | — | — | — | — | — |
| BC4 | — | — | — | 0.05 | — | — | — | — | — | — | — | — | — | — | — |
| BC5 | 0.10 | 0.05 | — | — | — | — | — | — | — | — | — | — | — | — | — |
| BC6 | — | 0.05 | 0.10 | — | — | — | — | — | — | — | — | — | — | — | — |
| BC7 | — | 0.05 | — | 0.10 | — | — | — | — | — | — | — | — | — | — | — |
| BC8 | 0.10 | 0.10 | — | — | — | — | — | — | — | — | — | — | — | — | — |
| BC9 | 0.10 | — | 0.10 | — | — | — | — | — | — | — | — | — | — | — | — |
| BC10 | 0.10 | — | — | 0.10 | — | — | — | — | — | — | — | — | — | — | — |
| BC11 | — | — | 0.10 | 0.10 | — | — | — | — | — | — | — | — | — | — | — |
| BC12 | — | — | 0.10 | 0.10 | — | — | — | — | — | — | — | — | — | — | — |
| BC13 | 0.01 | 0.01 | — | — | 0.010 | 4.506 | — | — | — | — | — | — | — | — | — |

| | Element composition (mass %) | | | | | | | | | |
|---|---|---|---|---|---|---|---|---|---|---|
| | | | | | | | | | | Al + |
| Alloy | | | | | | | | Si + Fe + | | unavoidable |
| No. | Cd | Bi | Ge | Zn | Ti | B | V | Mn + Ni | Ti + B + V | impurities |
| BC1 | — | — | — | — | — | — | — | 0.05 | 0.000 | Balance |
| BC2 | — | — | — | — | — | — | — | 0.02 | 0.000 | Balance |
| BC3 | — | — | — | — | — | — | — | 0.05 | 0.000 | Balance |
| BC4 | — | — | — | — | — | — | — | 0.05 | 0.000 | Balance |
| BC5 | — | — | — | — | — | — | — | 0.15 | 0.000 | Balance |
| BC6 | — | — | — | — | — | — | — | 0.15 | 0.000 | Balance |
| BC7 | — | — | — | — | — | — | — | 0.15 | 0.000 | Balance |
| BC8 | — | — | — | — | — | — | — | 0.20 | 0.000 | Balance |
| BC9 | — | — | — | — | — | — | — | 0.20 | 0.000 | Balance |
| BC10 | — | — | — | — | — | — | — | 0.20 | 0.000 | Balance |
| BC11 | — | — | — | — | — | — | — | 0.20 | 0.000 | Balance |
| BC12 | — | — | — | — | — | — | — | 0.20 | 0.000 | Balance |
| BC13 | — | — | — | 0.300 | — | — | — | 0.02 | 0.000 | Balance |

TABLE 13

| | Element composition of skin alloy (mass %) | | | | | | | |
|---|---|---|---|---|---|---|---|---|
| | | | | | | | | Al + |
| Alloy | | | | | | | | unavoidable |
| No. | Mg | Cu | Zn | Cr | Fe | Si | Mn | impurities |
| C1 | — | 0.001 | 0.001 | 0.001 | 0.281 | 0.003 | — | Balance |
| C2 | — | 0.001 | 0.001 | — | 0.002 | 0.273 | — | Balance |
| C3 | 0.3 | 0.020 | 0.590 | 0.284 | 0.022 | 0.007 | — | Balance |
| C4 | 0.5 | 0.078 | 0.210 | 0.172 | 0.021 | 0.002 | — | Balance |
| C5 | 7.9 | 0.036 | 0.480 | 0.050 | 0.002 | 0.028 | — | Balance |
| C6 | 1.2 | 0.057 | 0.120 | 0.055 | 0.020 | 0.021 | — | Balance |
| C7 | 2.3 | 0.083 | 0.580 | 0.015 | 0.007 | 0.029 | — | Balance |
| C8 | 3.1 | 0.006 | 0.060 | 0.180 | 0.029 | 0.025 | — | Balance |
| C9 | 4.2 | 0.066 | 0.260 | 0.050 | 0.016 | 0.023 | 0.20 | Balance |
| C10 | 4.4 | 0.123 | 0.500 | 0.100 | 0.002 | 0.012 | 0.02 | Balance |
| C11 | 5.4 | 0.542 | 0.390 | 0.070 | 0.008 | 0.004 | — | Balance |
| C12 | 5.7 | 0.080 | 0.230 | 0.291 | 0.023 | 0.005 | — | Balance |
| C13 | 4.3 | 0.125 | 0.160 | 0.030 | 0.020 | 0.002 | — | Balance |
| C14 | 4.2 | 0.066 | 0.260 | 0.050 | 0.261 | 0.023 | — | Balance |
| C15 | 4.4 | 0.123 | 0.500 | 0.100 | 0.002 | 0.012 | — | Balance |
| C16 | 4.2 | 0.057 | 0.120 | 0.055 | 0.020 | 0.021 | — | Balance |
| C17 | 4.4 | 0.123 | 0.500 | 0.100 | 0.002 | 0.012 | — | Balance |
| C18 | 3.6 | 0.060 | 0.006 | 0.183 | 0.022 | 0.007 | — | Balance |
| C19 | 4.2 | 0.123 | 0.280 | 0.212 | 0.017 | 0.007 | — | Balance |
| C20 | 4.2 | 0.018 | 0.490 | 0.240 | 0.025 | 0.002 | — | Balance |

TABLE 14

| | Element composition of skin alloy (mass %) | | | | | | | |
|---|---|---|---|---|---|---|---|---|
| | | | | | | | | Al + |
| Alloy | | | | | | | | unavoidable |
| No. | Mg | Cu | Zn | Cr | Fe | Si | Mn | impurities |
| C21 | 4.4 | 0.123 | 0.500 | 0.100 | 0.008 | 0.012 | — | Balance |
| C22 | 4.7 | 0.043 | 0.150 | 0.020 | 0.027 | 0.223 | — | Balance |
| C23 | 3.9 | 0.088 | 0.280 | 0.190 | 0.020 | 0.020 | — | Balance |
| C24 | 4.2 | 0.057 | 0.120 | 0.055 | 0.020 | 0.021 | — | Balance |
| C25 | 4.4 | 0.123 | 0.500 | 0.100 | 0.002 | 0.012 | — | Balance |
| C26 | 4.2 | 0.057 | 0.120 | 0.055 | 0.020 | 0.021 | — | Balance |
| C27 | 3.1 | 0.006 | 0.060 | 0.180 | 0.029 | 0.025 | — | Balance |
| C28 | — | 0.532 | 0.007 | 0.001 | 0.032 | 0.003 | — | Balance |
| C29 | — | 0.007 | 0.543 | 0.001 | 0.032 | 0.010 | — | Balance |
| C30 | 3.1 | 0.142 | 0.230 | 0.100 | 0.016 | 0.029 | — | Balance |
| C31 | 4.3 | 0.123 | 0.390 | 0.291 | 0.029 | 0.023 | — | Balance |
| C32 | 4.2 | 0.083 | 0.230 | 0.180 | 0.020 | 0.002 | — | Balance |
| C33 | 3.1 | 0.006 | 0.060 | 0.180 | 0.029 | 0.025 | — | Balance |
| C34 | 4.2 | 0.057 | 0.120 | 0.055 | 0.020 | 0.021 | — | Balance |
| C35 | 3.8 | 0.067 | 0.450 | 0.110 | 0.026 | 0.013 | — | Balance |
| C36 | 5.9 | 0.043 | 0.440 | 0.183 | 0.017 | 0.020 | — | Balance |
| C37 | 3.1 | 0.006 | 0.060 | 0.180 | 0.029 | 0.025 | — | Balance |
| C38 | 3.1 | 0.006 | 0.060 | 0.180 | 0.029 | 0.025 | — | Balance |
| C39 | 3.1 | 0.006 | 0.060 | 0.180 | 0.029 | 0.025 | — | Balance |
| C40 | 3.1 | 0.006 | 0.060 | 0.180 | 0.029 | 0.025 | — | Balance |
| C41 | 3.1 | 0.006 | 0.060 | 0.180 | 0.029 | 0.025 | — | Balance |
| C42 | 3.1 | 0.006 | 0.060 | 0.180 | 0.029 | 0.025 | — | Balance |
| C43 | 3.1 | 0.006 | 0.060 | 0.180 | 0.029 | 0.025 | — | Balance |
| C44 | 3.1 | 0.006 | 0.060 | 0.180 | 0.029 | 0.025 | — | Balance |
| C45 | 3.1 | 0.006 | 0.060 | 0.180 | 0.029 | 0.025 | — | Balance |
| C46 | 3.1 | 0.006 | 0.060 | 0.180 | 0.029 | 0.025 | — | Balance |
| C47 | 3.1 | 0.006 | 0.060 | 0.180 | 0.029 | 0.025 | — | Balance |
| C48 | 3.1 | 0.006 | 0.060 | 0.180 | 0.029 | 0.025 | — | Balance |

TABLE 15

| | Element composition of skin alloy (mass %) | | | | | | | |
|---|---|---|---|---|---|---|---|---|
| | | | | | | | | Al + |
| Alloy | | | | | | | | unavoidable |
| No. | Mg | Cu | Zn | Cr | Fe | Si | Mn | impurities |
| CC1 | 5.2 | 0.056 | 0.330 | 0.080 | 0.029 | 0.015 | — | Balance |
| CC2 | 3.7 | 0.131 | 0.230 | 0.081 | 0.007 | 0.013 | — | Balance |
| CC3 | 3.7 | 0.131 | 0.230 | 0.081 | 0.007 | 0.013 | — | Balance |
| CC4 | 3.7 | 0.131 | 0.230 | 0.081 | 0.007 | 0.013 | — | Balance |
| CC5 | 3.7 | 0.131 | 0.230 | 0.081 | 0.007 | 0.013 | — | Balance |
| CC6 | 3.7 | 0.131 | 0.230 | 0.081 | 0.007 | 0.013 | — | Balance |
| CC7 | 3.7 | 0.131 | 0.230 | 0.081 | 0.007 | 0.013 | — | Balance |
| CC8 | 3.7 | 0.131 | 0.230 | 0.081 | 0.007 | 0.013 | — | Balance |
| CC9 | 3.7 | 0.131 | 0.230 | 0.081 | 0.007 | 0.013 | — | Balance |
| CC10 | 3.7 | 0.131 | 0.230 | 0.081 | 0.007 | 0.013 | — | Balance |
| CC11 | 3.7 | 0.131 | 0.230 | 0.081 | 0.007 | 0.013 | — | Balance |
| CC12 | 3.7 | 0.131 | 0.230 | 0.081 | 0.007 | 0.013 | — | Balance |
| CC13 | 3.7 | 0.131 | 0.230 | 0.081 | 0.007 | 0.013 | — | Balance |

TABLE 16

| | | | | | | | | | Clad material | |
|---|---|---|---|---|---|---|---|---|---|---|
| | | | | | | | | | Homogenization | |
| | | | | | | | | | treatment conditions | |
| | | Core alloy | | | | Skin alloy | | | Keeping | Keeping time |
| | | Casting conditions | | Ingot | | Casting conditions | | Ingot | time (hr) at | (hr) at 2nd stage |
| | | | Casting | sheet | | | Casting | sheet | 1st stage | at higher than |
| | Alloy | Casting | speed | thickness | Alloy | Casting | speed | thickness | at 400 to | 470° C. but less |
| | No. | method | (mm/min) | (mm) | No. | method | (mm/min) | (mm) | 470° C. | than 630° C. |
| Ex 49 | B1 | DC | 30 | 300 | C1 | DC | 30 | 300 | 49 | 5 |
| Ex 50 | B2 | DC | 30 | 300 | C2 | DC | 30 | 300 | 25 | 5 |
| Ex 51 | B3 | DC | 30 | 300 | C3 | DC | 30 | 300 | 0.5 | 5 |
| Ex 52 | B4 | DC | 30 | 300 | C4 | DC | 30 | 300 | 5 | 5 |
| Ex 53 | B5 | DC | 30 | 300 | C5 | DC | 30 | 300 | 5 | 5 |
| Ex 54 | B6 | DC | 30 | 300 | C6 | DC | 30 | 300 | 5 | 29 |
| Ex 55 | B7 | DC | 30 | 300 | C7 | DC | 30 | 300 | 5 | 15 |
| Ex 56 | B8 | DC | 30 | 300 | C8 | DC | 30 | 300 | 5 | 1 |
| Ex 57 | B9 | DC | 30 | 300 | C9 | DC | 30 | 300 | 5 | 5 |
| Ex 58 | B10 | DC | 30 | 300 | C10 | DC | 30 | 300 | 5 | 5 |
| Ex 59 | B11 | DC | 40 | 300 | C11 | DC | 30 | 300 | 5 | 5 |
| Ex 60 | B12 | DC | 40 | 300 | C12 | DC | 30 | 300 | 5 | 5 |
| Ex 61 | B13 | DC | 40 | 300 | C13 | DC | 30 | 300 | 5 | 5 |
| Ex 62 | B14 | DC | 40 | 300 | C14 | DC | 30 | 300 | 5 | 5 |
| Ex 63 | B15 | DC | 20 | 300 | C15 | DC | 30 | 300 | 5 | 5 |
| Ex 64 | B16 | DC | 20 | 300 | C16 | DC | 30 | 300 | 5 | 5 |
| Ex 65 | B17 | DC | 20 | 300 | C17 | DC | 30 | 300 | 5 | 5 |
| Ex 66 | B18 | DC | 40 | 300 | C18 | DC | 30 | 300 | 5 | 5 |
| Ex 67 | B19 | CC | 200 | 9 | C19 | DC | 30 | 300 | 5 | 5 |
| Ex 68 | B20 | DC | 40 | 300 | C20 | DC | 30 | 300 | 5 | 5 |

TABLE 17

| | | | | | | | | | Clad material | |
|---|---|---|---|---|---|---|---|---|---|---|
| | | | | | | | | | Homogenization | |
| | | | | | | | | | treatment conditions | |
| | | Core alloy | | | | Skin alloy | | | Keeping | Keeping time |
| | | Casting conditions | | Ingot | | Casting conditions | | Ingot | time (hr) at | (hr) at 2nd stage |
| | | | Casting | sheet | | | Casting | sheet | 1st stage | at higher than |
| | Alloy | Casting | speed | thickness | Alloy | Casting | speed | thickness | at 400 to | 470° C. but less |
| | No. | method | (mm/min) | (mm) | No. | method | (mm/min) | (mm) | 470° C. | than 630° C. |
| Ex 69 | B21 | DC | 50 | 300 | C21 | DC | 30 | 300 | 5 | 5 |
| Ex 70 | B22 | CC | 200 | 9 | C22 | DC | 30 | 300 | 5 | 5 |
| Ex 71 | B23 | DC | 50 | 300 | C23 | DC | 30 | 300 | 5 | 5 |
| Ex 72 | B24 | DC | 50 | 300 | C24 | DC | 30 | 300 | 5 | 5 |
| Ex 73 | B25 | DC | 50 | 300 | C25 | DC | 30 | 300 | 5 | 5 |
| Ex 74 | B26 | DC | 50 | 300 | C26 | DC | 30 | 300 | 5 | 5 |
| Ex 75 | B27 | DC | 50 | 300 | C27 | DC | 30 | 300 | 5 | 5 |
| Ex 76 | B28 | DC | 50 | 300 | C28 | DC | 30 | 300 | 5 | 5 |
| Ex 77 | B29 | DC | 50 | 300 | C29 | DC | 30 | 300 | 5 | 5 |
| Ex 78 | B30 | DC | 50 | 300 | C30 | DC | 30 | 300 | 5 | 5 |
| Ex 79 | B31 | DC | 50 | 300 | C31 | DC | 30 | 300 | 5 | 5 |
| Ex 80 | B32 | CC | 300 | 9 | C32 | DC | 30 | 300 | 5 | 5 |
| Ex 81 | B33 | CC | 200 | 9 | C33 | DC | 30 | 300 | 5 | 5 |
| Ex 82 | B34 | CC | 150 | 9 | C34 | DC | 30 | 300 | 5 | 5 |
| Ex 83 | B35 | DC | 60 | 300 | C35 | DC | 30 | 300 | 5 | 5 |
| Ex 84 | B36 | DC | 60 | 300 | C36 | DC | 30 | 300 | 5 | 5 |
| Ex 85 | B37 | DC | 50 | 300 | C37 | DC | 30 | 300 | 5 | 5 |
| Ex 86 | B38 | DC | 50 | 300 | C38 | DC | 30 | 300 | 5 | 5 |
| Ex 87 | B39 | DC | 50 | 300 | C39 | DC | 30 | 300 | 5 | 5 |
| Ex 88 | B40 | DC | 50 | 300 | C40 | DC | 30 | 300 | 5 | 5 |
| Ex 89 | B41 | DC | 50 | 300 | C41 | DC | 30 | 300 | 5 | 5 |
| Ex 90 | B42 | DC | 50 | 300 | C42 | DC | 30 | 300 | 5 | 5 |
| Ex 91 | B43 | DC | 50 | 300 | C43 | DC | 30 | 300 | 5 | 5 |
| Ex 92 | B44 | DC | 50 | 300 | C44 | DC | 30 | 300 | 53 | 5 |
| Ex 93 | B45 | DC | 50 | 300 | C45 | DC | 30 | 300 | 5 | 33 |
| Ex 94 | B46 | DC | 50 | 300 | C46 | DC | 30 | 300 | 0.3 | 33 |
| Ex 95 | B47 | DC | 50 | 300 | C47 | DC | 30 | 300 | 5 | 5 |
| Ex 96 | B48 | DC | 10 | 300 | C48 | DC | 30 | 300 | 5 | 5 |

TABLE 18

| | | | | | | | | | Clad material | |
|---|---|---|---|---|---|---|---|---|---|---|
| | | | | | | | | | Homogenization | |
| | | | | | | | | | treatment conditions | |
| | | Core alloy | | | | Skin alloy | | | Keeping | Keeping time |
| | | Casting conditions | | Ingot | | Casting conditions | | Ingot | time (hr) at | (hr) at 2nd stage |
| | | | Casting | sheet | | | Casting | sheet | 1st stage | at higher than |
| | Alloy | Casting | speed | thickness | Alloy | Casting | speed | thickness | at 400 to | 470° C. but less |
| | No. | method | (mm/min) | (mm) | No. | method | (mm/min) | (mm) | 470° C. | than 630° C. |
| C Ex 14 | BC1 | DC | 30 | 300 | CC1 | DC | 30 | 300 | 5 | 5 |
| C Ex 15 | BC2 | DC | 30 | 300 | CC2 | DC | 30 | 300 | 5 | 5 |
| C Ex 16 | BC3 | DC | 30 | 300 | CC3 | DC | 30 | 300 | 5 | 5 |
| C Ex 17 | BC4 | DC | 30 | 300 | CC4 | DC | 30 | 300 | 5 | 5 |
| C Ex 18 | BC5 | DC | 30 | 300 | CC5 | DC | 30 | 300 | 5 | 5 |
| C Ex 19 | BC6 | DC | 30 | 300 | CC6 | DC | 30 | 300 | 5 | 5 |
| C Ex 20 | BC7 | DC | 30 | 300 | CC7 | DC | 30 | 300 | 5 | 5 |
| C Ex 21 | BC8 | CC | 100 | 9 | CC8 | DC | 30 | 300 | 5 | 5 |
| C Ex 22 | BC9 | DC | 30 | 300 | CC9 | DC | 30 | 300 | 0.3 | 1 |
| C Ex 23 | BC10 | DC | 30 | 300 | CC10 | DC | 30 | 300 | 5 | 0.3 |
| C Ex 24 | BC11 | DC | 30 | 300 | CC11 | DC | 30 | 300 | 0 | 0 |
| C Ex 25 | BC12 | DC | 30 | 300 | CC12 | DC | 30 | 300 | 0.3 | 0 |
| C Ex 26 | BC13 | DC | 30 | 300 | CC13 | DC | 30 | 300 | 5 | 5 |

As shown in Table 16 to Table 18, ingots for core alloy were produced by casting the aluminum alloy molten metals of alloy Nos. B1 to B18, B20, B21, B23 to B31, B35 to B48, BC1 to BC7, and BC9 to BC13 by a DC casting method; and casting the aluminum alloy molten metals of alloy Nos. B19, B22, B32 to B34, and BC8 by a CC method (Step S202-1). The ingots for skin alloy were produced by a DC casting method for all of the alloys. The core alloys of alloy Nos. B1 to B18, B20, B21, B23 to B31, B35 to B48, BC1 to BC7, and BC9 to BC13 were produced into core alloys by performing face milling of 15 mm on both surfaces of the ingots (Step S202-2). The skin alloys were obtained by performing face milling of 15 mm on both surfaces of the ingots, performing a homogenization treatment for 6 hours at 520° C. in the air, and performing hot-rolling. Alloy Nos. C1 to C18, C20, C21, C23 to C31, C35 to C48, CC1 to CC7, and CC9 to CC13 were produced into hot-rolled sheets having a sheet thickness of 15 mm, and alloy Nos. C19, C22, C32 to C34, and CC8 were produced into hot-rolled sheets having a sheet thickness of 0.5 mm. Subsequently, the hot-rolled sheets were washed with caustic soda to obtain skin alloys. Each skin alloy was laminated on both surfaces of a core alloy, and thereby a laminate material was obtained.

Next, as shown in Table 16 to Table 18, a homogenization treatment was performed (Step S203). Meanwhile, the laminated material of alloy No. B47 was retained for 5 hours at 630° C. to 640° C. after the second stage homogenization treatment. Furthermore, alloy No. BC11 was retained for 5 hours at 380° C. to 390° C. Next, hot-rolling was performed at a rolling initiation temperature of 370° C. and a rolling completion temperature of 310° C., and thus hot-rolled sheets having a sheet thickness of 3.0 mm were produced (Step S204). Hot-rolled sheets other than those of alloy Nos. B1 to B6, B8 to B36, and BC1 to BC4 were annealed (batch type) under the conditions of for 2 hours at 360° C. All the sheet materials were rolled to have a final sheet thickness of 0.8 mm by cold-rolling (rolling ratio 73.3%), and thus aluminum alloy sheets were obtained (Step S205). Disk blanks were produced by punching the aluminum alloy sheets into an annular shape having an outer diameter of 96 mm and an inner diameter of 24 mm (Step S206).

The disk blanks were subjected to pressure annealing for 3 hours at 350° C. (Step S207). End surface processing was performed to adjust the outer diameter to 95 mm and the inner diameter to 25 mm, and grinding work (grinding of 10 μm from the surface) was performed (Step S208). Subsequently, degreasing was performed at 60° C. for 5 minutes by means of AD-68F (trade name, manufactured by C. Uyemura & Co., Ltd.), and then etching was performed at 65° C. for 1 minute by means of AD-107F (trade name, manufactured by C. Uyemura & Co., Ltd.). Furthermore, desmutting was performed for 20 seconds using a 30% aqueous solution of HNO₃ (room temperature). After the surface state was cleaned up as such, the disk blanks were subjected to a zincate treatment on the surface by immersing the disk blanks in a zincate treatment liquid at 20° C. of AD-301 F-3X (trade name, manufactured by C. Uyemura & Co., Ltd.) for 0.5 minutes (Step S209). The zincate treatment was performed two times in total, and the disk blanks were immersed in a 30% aqueous solution of HNO₃ at room temperature for 20 seconds between the zincate treatments so as to subject the surface to a peeling treatment. The surface that had been subjected to the zincate treatment, was subjected to electroless plating with Ni—P to a thickness of 21 μm using an electroless Ni—P plating treatment liquid (NIMUDEN HDX (trade name, manufactured by C. Uyemura & Co., Ltd.)). The plated surface thus obtained were subjected to rough polishing using an alumina slurry having an average particle size of 800 nm and a polishing pad made of foamed or expanded urethane. The working amount of the rough polishing was set to 3.8 μm. Subsequently, finish polishing work was performed using a colloidal silica having a particle size of 20 to 200 nm and a polishing pad made of foamed or expanded urethane. The working amount of the finish polishing work was set to 0.2 μm. Furthermore, removal of the polishing grains, chips, and other attached foreign materials was performed by sufficiently scrubbing and washing the surface of the plated surface using an alkali cleaner and a PVA sponge and sufficiently rinsing using deionized water having a resistivity of 18 MΩ·cm or more (Step S210).

The aluminum alloy ingots after the casting (Step S202-1) step, the aluminum alloy substrates after the grinding work (Step S208) step, and the aluminum alloy substrates after the plating treatment polishing (Step S210) step were subjected to the following evaluations. Meanwhile, ten disks of each alloy were processed up to the plating treatment. However, in some of the disks of Examples 51 to 53 and 92 to 96, peeling of the plating occurred. The number of disks in which peeling of the plating occurred was one sheet in Example 51; two sheets in Example 52; three sheets in Example 53; four sheets in Example 92; three sheets in Example 93; three sheets in Example 94; three sheets in Example 95; and three sheets in Example 96. Evaluations were performed using those disks in which peeling of the plating did not occur.

### [Cooling Speed at the Time of Casting of the Core Alloy]

The DAS (dendrite arm spacing) of the ingots after casting (Step S202-1) was measured, and the cooling speed (° C./s) at the time of casting was calculated. The DAS was analyzed by performing an observation of the cross-sectional microstructure in the thickness direction of the ingots using an optical microscope, and analyzing the cross-sectional microstructure by a secondary branching method. The analysis was made using a cross-section at the central part in the thickness direction of an ingot.

### [The Number of Second Phase Particles in the Core Alloy, the Longest Diameter, and the Sum of Circumferences]

A cross-section (core alloy part) of an aluminum alloy substrate obtained after grinding work (Step S208) was observed with an optical microscope at a magnification of 400× in 20 viewing fields (the area of one viewing field: 0.05 mm²), and the number of second phase particles (particles/mm²), the longest diameter, and the sum of circumferences (mm/mm²) were measured using a particle analysis software program, A-ZOKUN (trade name, manufactured by Asahi Kasei Engineering Corporation). The measurement was made using a cross-section at the central part in the thickness direction of the substrate.

### [Measurement of Disk Flutter]

Measurement of disk flutter was performed using an aluminum alloy substrate ater the plating treatment polishing (Step S210) step. The measurement of disk flutter was carded out by installing aluminum alloy substrates in a commercially available hard disk drive in the presence of the air. ST2000 (trade name) manufactured by Seagate Technology PLC was used as the drive, and motor driving was achieved by directly connecting SLD102 (trade name) manufactured by Techno Alive Co., Ltd. to a motor. The speed of rotation was set to 7,200 rpm. The disks were installed such that a plurality of disks were installed in every case, and vibration of the surface was observed by installing LDV1800 (trade name) manufactured by Ono Sokki Co., Ltd., which is a laser Doppler vibrometer, on the surface of the magnetic disk at the top. The vibration thus observed was subjected to a spectral analysis using a FFT analyzer DS3200 (trade name) manufactured by Ono Sokki Co., Ltd. The observation was made by making a hole in the lid of the hard disk driver and making an observation of the disk surface through the hole. Furthermore, the evaluation was performed after eliminating the squeeze plate that was installed in the commercially available hard disk.

The evaluation of the fluttering characteristics was carried out based on the maximum displacement (disk fluttering (nm)) of a broad peak near 300 Hz to 1,500 Hz where fluttering appeared. This broad peak is referred to as NRRO (non-repeatable run out), and it is understood that this broad peak significantly affects the positioning error of the head.

Rating of the fluttering characteristics was such that the case in which the value obtained in the air was 30 nm or less was rated as A (excellent); the case in which the value was larger than 30 nm and 40 nm or less was rated as B (good); the case in which the value was larger than 40 nm and 50 nm or less was rated as C (acceptable); and the case in which the value was larger than 50 nm was rated as D (poor).

### [Average Crystal Grain Size on the Core Alloy Surface]

The aluminum alloy substrate surface (L-LT surface) obtained after grinding work (Step S208) was further ground, and the surface of the core alloy was exposed. The surface was subjected to Barker etching using a Barker solution, and one image of the surface was taken with a polarized microscope at a magnification of 100×. Measurement of the crystal grain size was performed using a line intersection method of counting the number of intersecting crystal grains. Drawing of five straight lines each having a length of 500 μm in the LT direction (the direction perpendicular to the rolling direction) was performed, and the average value was determined.

TABLE 19

| | | | | The | The sum of | | |
|---|---|---|---|---|---|---|---|
| | | | | number | circum- | | |
| | | | | of | ferences | | |
| | | | | second | of second | | |
| | | | | phase | phase | | |
| | | | | particles | particles | | |
| | | | | having | having | | |
| | | | | the longest | the longest | | |
| | | | | diameter of | diameter of | Average | |
| | | | Cooling | 4 μm or | 4 μm or | crystal | |
| | | | speed | more and | more and | grain | |
| | | | at the | 30 μm | 30 μm | size | |
| | | | time of | or less | or less | at the | |
| | | | casting | in the | in the | surface | |
| | Alloy | Alloy | the | core | core | of the | |
| | No. | No. | core | alloy | alloy | core | |
| | (core | (skin | alloy | (particles/ | (mm/ | alloy | Disk |
| | alloy) | alloy) | (° C./s) | mm²) | mm²) | (μm) | fluttering |
| Ex 49 | B1 | C1 | 0.4 | 194 | 11.4 | 61 | B |
| Ex 50 | B2 | C2 | 0.3 | 542 | 32.3 | 43 | A |
| Ex 51 | B3 | C3 | 0.5 | 3129 | 69.6 | 20 | A |
| Ex 52 | B4 | C4 | 0.8 | 12891 | 253.9 | 17 | A |
| Ex 53 | B5 | C5 | 0.4 | 37281 | 893.4 | 8 | A |
| Ex 54 | B6 | C6 | 0.5 | 342 | 12.8 | 52 | B |
| Ex 55 | B7 | C7 | 0.3 | 1403 | 35.5 | 22 | A |
| Ex 56 | B8 | C8 | 0.5 | 24201 | 432.9 | 17 | A |
| Ex 57 | B9 | C9 | 0.5 | 41928 | 973.1 | 19 | A |
| Ex 58 | B10 | C10 | 0.3 | 172 | 11.9 | 53 | B |
| Ex 59 | B11 | C11 | 0.8 | 981 | 49.8 | 35 | A |
| Ex 60 | B12 | C12 | 0.8 | 12346 | 543.8 | 21 | A |
| Ex 61 | B13 | C13 | 0.9 | 31291 | 874.9 | 19 | A |
| Ex 62 | B14 | C14 | 0.8 | 210 | 13.2 | 85 | C |
| Ex 63 | B15 | C15 | 0.2 | 1173 | 39.9 | 38 | A |
| Ex 64 | B16 | C16 | 0.2 | 17543 | 257.3 | 22 | A |
| Ex 65 | B17 | C17 | 0.2 | 46322 | 876.5 | 17 | A |
| Ex 66 | B18 | C18 | 0.7 | 6948 | 212.6 | 24 | A |
| Ex 67 | B19 | C19 | 652.0 | 10432 | 391.4 | 19 | B |
| Ex 68 | B20 | C20 | 0.9 | 7211 | 234.7 | 15 | A |

TABLE 20

| | | | | The | The sum of | | |
|---|---|---|---|---|---|---|---|
| | | | | number | circum- | | |
| | | | | of | ferences | | |
| | | | | second | of second | | |
| | | | | phase | phase | | |
| | | | | particles | particles | | |
| | | | | having | having | | |
| | | | | the longest | the longest | | |
| | | | | diameter of | diameter of | Average | |
| | | | Cooling | 4 μm or | 4 μm or | crystal | |
| | | | speed | more and | more and | grain | |
| | | | at the | 30 μm | 30 μm | size | |
| | | | time of | or less | or less | at the | |
| | | | casting | in the | in the | surface | |
| | Alloy | Alloy | the | core | core | of the | |
| | No. | No. | core | alloy | alloy | core | |
| | (core | (skin | alloy | (particles/ | (mm/ | alloy | Disk |
| | alloy) | alloy) | (° C./s) | mm²) | mm²) | (μm) | fluttering |
| Ex 69 | B21 | C21 | 1.0 | 7521 | 199.6 | 16 | A |
| Ex 70 | B22 | C22 | 612.8 | 429 | 17.3 | 30 | B |
| Ex 71 | B23 | C23 | 0.9 | 5271 | 196.8 | 15 | A |
| Ex 72 | B24 | C24 | 0.8 | 11321 | 382.5 | 16 | A |
| Ex 73 | B25 | C25 | 0.5 | 6372 | 185.4 | 18 | A |
| Ex 74 | B26 | C26 | 0.5 | 14892 | 289.4 | 12 | A |
| Ex 75 | B27 | C27 | 0.5 | 4961 | 193.2 | 13 | A |
| Ex 76 | B28 | C28 | 0.8 | 5689 | 175.2 | 18 | A |
| Ex 77 | B29 | C29 | 0.9 | 8678 | 231.8 | 11 | A |
| Ex 78 | B30 | C30 | 0.8 | 7829 | 245.9 | 14 | A |
| Ex 79 | B31 | C31 | 0.8 | 8213 | 267.4 | 15 | A |
| Ex 80 | B32 | C32 | 254.3 | 4421 | 84.2 | 13 | A |
| Ex 81 | B33 | C33 | 793.5 | 3979 | 72.0 | 15 | A |
| Ex 82 | B34 | C34 | 923.1 | 2292 | 33.2 | 16 | A |
| Ex 83 | B35 | C35 | 1.1 | 210 | 11.6 | 38 | B |
| Ex 84 | B36 | C36 | 1.2 | 197 | 11.9 | 39 | B |
| Ex 85 | B37 | C37 | 0.8 | 2019 | 123.7 | 79 | A |
| Ex 86 | B38 | C38 | 0.9 | 6843 | 143.1 | 16 | A |
| Ex 87 | B39 | C39 | 0.8 | 1512 | 76.3 | 14 | A |
| Ex 88 | B40 | C40 | 0.8 | 5402 | 136.2 | 20 | A |
| Ex 89 | B41 | C41 | 0.9 | 6459 | 199.8 | 12 | A |
| Ex 90 | B42 | C42 | 0.8 | 985 | 63.3 | 29 | A |
| Ex 91 | B43 | C43 | 0.9 | 1123 | 55.2 | 33 | A |
| Ex 92 | B44 | C44 | 0.9 | 56473 | 1,123.2 | 14 | A |
| Ex 93 | B45 | C45 | 0.9 | 63672 | 1,254.3 | 5 | A |
| Ex 94 | B46 | C46 | 0.8 | 57182 | 1,123.1 | 13 | A |
| Ex 95 | B47 | C47 | 0.8 | 57726 | 1,284.1 | 12 | A |
| Ex 96 | B48 | C48 | 0.04 | 59281 | 1,225.7 | 10 | A |

TABLE 21

| | | | | | The sum | | |
|---|---|---|---|---|---|---|---|
| | | | | The | of | | |
| | | | | number | circum- | | |
| | | | | of | ferences | | |
| | | | | second | of second | | |
| | | | | phase | phase | | |
| | | | | particles | particles | | |
| | | | | having | having | | |
| | | | | the | the | | |
| | | | | longest | longest | | |
| | | | | diameter | diameter | | |
| | | | | of | of | Average | |
| | | | Cooling | 4 μm or | 4 μm or | crystal | |
| | | | speed | more and | more and | grain | |
| | | | at the | 30 μm | 30 μm | size | |
| | | | time of | or less | or less | at the | |
| | | | casting | in the | in the | surface | |
| | Alloy | Alloy | the | core | core | of the | |
| | No. | No. | core | alloy | alloy | core | Disk |
| | (core | (skin | alloy | (particles/ | (mm/ | alloy | flutter- |
| | alloy) | alloy) | (° C./s) | mm²) | mm²) | (μm) | ing |
| C Ex 14 | BC1 | CC1 | 0.4 | 41 | 3.3 | 69 | D |
| C Ex 15 | BC2 | CC2 | 0.3 | 12 | 0.9 | 62 | D |
| C Ex 16 | BC3 | CC3 | 0.5 | 19 | 1.1 | 67 | D |
| C Ex 17 | BC4 | CC4 | 0.5 | 121 | 2.4 | 98 | D |
| C Ex 18 | BC5 | CC5 | 0.3 | 142 | 5.3 | 59 | D |
| C Ex 19 | BC6 | CC6 | 0.5 | 105 | 4.3 | 66 | D |
| C Ex 20 | BC7 | CC7 | 0.5 | 169 | 3.2 | 54 | D |
| C Ex 21 | BC8 | CC8 | 1056.4 | 82 | 1.2 | 57 | D |
| C Ex 22 | BC9 | CC9 | 0.5 | 122 | 2.2 | 63 | D |
| C Ex 23 | BC10 | CC10 | 0.3 | 71 | 1.1 | 50 | D |
| C Ex 24 | BC11 | CC11 | 0.5 | 111 | 2.4 | 58 | D |
| C Ex 25 | BC12 | CC12 | 0.3 | 115 | 2.2 | 52 | D |
| C Ex 26 | BC13 | CC13 | 0.5 | 5 | 0.2 | 54 | D |

As shown in Tables 19 to 21, satisfactory fluttering characteristics were obtained in Examples 49 to 96.

Contrary to the above, in Comparative Examples 14 to 26, the sum of the circumferences of the second phase particles having the longest diameter of 4 nm or more and 30 μm or less in the metal microstructure was less than 10 mm/mm², and the fluttering characteristics were poor.

### (Aluminum Alloy Substrate for Magnetic Disk Having Pure Al Coating Film or Al—Mg-Based Alloy Coating Film on Both Surfaces)

Next, Examples of an aluminum alloy substrate for a magnetic disk having a pure Al coating film or an Al—Mg-based alloy coating film on both surfaces will be described.

Various alloy raw materials having the element compositions indicated in Table 22 to Table 24 were melted according to a usual manner, and aluminum alloy molten metals were produced (Step S301). In Table 22 to Table 24, the symbol “-” implies that the result was below the detection limit.

TABLE 22

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| A1-1 | 0.20 | — | — | — | — | — | — | — | — | — | — | — | — | — | — |
| A1-2 | 0.40 | — | — | — | — | — | — | — | — | — | — | — | — | — | — |
| A1-3 | 5.00 | — | — | — | — | — | — | — | — | — | — | — | — | — | — |
| A1-4 | 18.00 | — | — | — | — | — | — | — | — | — | — | — | — | — | — |
| A1-5 | 24.00 | — | — | — | — | — | — | — | — | — | — | — | — | — | — |
| A1-6 | — | 0.20 | — | — | — | — | — | — | — | — | — | — | — | — | — |
| A1-7 | — | 0.50 | — | — | — | — | — | — | — | — | — | — | — | — | — |
| A1-8 | — | 5.00 | — | — | — | — | — | — | — | — | — | — | — | — | — |
| A1-9 | — | 10.00 | — | — | — | — | — | — | — | — | — | — | — | — | — |
| A1-10 | — | — | 0.20 | — | — | — | — | — | — | — | — | — | — | — | — |
| A1-11 | — | — | 0.50 | — | — | — | — | — | — | — | — | — | — | — | — |
| A1-12 | — | — | 5.00 | — | — | — | — | — | — | — | — | — | — | — | — |
| A1-13 | — | — | 15.00 | — | — | — | — | — | — | — | — | — | — | — | — |
| A1-14 | — | — | — | 0.20 | — | — | — | — | — | — | — | — | — | — | — |
| A1-15 | — | — | — | 0.50 | — | — | — | — | — | — | — | — | — | — | — |
| A1-16 | — | — | — | 10.00 | — | — | — | — | — | — | — | — | — | — | — |
| A1-17 | — | — | — | 20.00 | — | — | — | — | — | — | — | — | — | — | — |
| A1-18 | 0.40 | 1.50 | 0.50 | 0.50 | 0.005 | — | — | — | — | — | — | — | — | — | — |
| A1-19 | 0.40 | 1.50 | 0.50 | 0.50 | 10.000 | — | — | — | — | — | — | — | — | — | — |
| A1-20 | 0.40 | 1.50 | 0.50 | 0.50 | — | 0.105 | — | — | — | — | — | — | — | — | — |

| | Element composition (mass %) | | | | | | | | | |
|---|---|---|---|---|---|---|---|---|---|---|
| Alloy | | | | | | | | Si + Fe + | Ti + | Al + unavoidable |
| No. | Cd | Bi | Ge | Zn | Ti | B | V | Mn + Ni | B + V | impurities |
| A1-1 | — | — | — | — | — | — | — | 0.20 | 0.000 | Balance |
| A1-2 | — | — | — | — | — | — | — | 0.40 | 0.000 | Balance |
| A1-3 | — | — | — | — | — | — | — | 5.00 | 0.000 | Balance |
| A1-4 | — | — | — | — | — | — | — | 18.00 | 0.000 | Balance |
| A1-5 | — | — | — | — | — | — | — | 24.00 | 0.000 | Balance |
| A1-6 | — | — | — | — | — | — | — | 0.20 | 0.000 | Balance |
| A1-7 | — | — | — | — | — | — | — | 0.50 | 0.000 | Balance |
| A1-8 | — | — | — | — | — | — | — | 5.00 | 0.000 | Balance |
| A1-9 | — | — | — | — | — | — | — | 10.00 | 0.000 | Balance |
| A1-10 | — | — | — | — | — | — | — | 0.20 | 0.000 | Balance |
| A1-11 | — | — | — | — | — | — | — | 0.50 | 0.000 | Balance |
| A1-12 | — | — | — | — | — | — | — | 5.00 | 0.000 | Balance |
| A1-13 | — | — | — | — | — | — | — | 15.00 | 0.000 | Balance |
| A1-14 | — | — | — | — | — | — | — | 0.20 | 0.000 | Balance |
| A1-15 | — | — | — | — | — | — | — | 0.50 | 0.000 | Balance |
| A1-16 | — | — | — | — | — | — | — | 10.00 | 0.000 | Balance |
| A1-17 | — | — | — | — | — | — | — | 20.00 | 0.000 | Balance |
| A1-18 | — | — | — | — | — | — | — | 2.90 | 0.000 | Balance |
| A1-19 | — | — | — | — | — | — | — | 2.90 | 0.000 | Balance |
| A1-20 | — | — | — | — | — | — | — | 2.90 | 0.000 | Balance |

TABLE 23

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| A1-21 | 0.40 | 1.50 | 0.50 | 0.50 | — | 0.905 | — | — | — | — | — | — | — | — | — |
| A1-22 | 0.40 | — | — | — | — | 6.008 | — | — | — | — | — | — | — | — | — |
| A1-23 | 0.40 | 1.50 | — | — | — | — | 0.010 | — | — | 0.002 | — | — | — | — | — |
| A1-24 | 0.40 | 1.50 | — | — | — | — | 5.000 | — | — | — | 0.002 | — | — | — | — |
| A1-25 | 0.40 | 1.50 | — | — | — | — | — | 0.010 | — | — | — | 0.002 | — | — | — |
| A1-26 | 0.40 | 1.50 | — | — | — | — | — | 5.000 | — | 0.090 | — | — | — | — | — |
| A1-27 | 0.40 | 1.50 | — | — | — | — | — | — | 0.0001 | — | 0.090 | — | — | — | — |
| A1-28 | 0.40 | 1.50 | — | — | — | — | — | — | 0.1000 | — | — | 0.090 | — | — | — |
| A1-29 | 0.20 | 1.50 | — | — | — | — | — | — | — | — | — | — | 5.0 | — | — |
| A1-30 | 0.20 | 1.50 | 0.10 | — | — | — | — | — | — | — | — | — | — | 5.0 | — |
| A1-31 | 0.20 | 1.50 | — | 0.10 | — | — | — | — | — | — | — | — | — | — | 5.0 |
| A1-32 | 0.20 | 1.50 | — | — | — | — | — | — | — | — | — | — | — | — | — |
| A1-33 | 0.20 | 1.50 | — | — | — | — | — | — | — | — | — | — | — | — | — |
| A1-34 | 0.20 | 1.50 | — | — | — | — | — | — | — | — | — | — | — | — | — |
| A1-35 | 0.10 | 0.05 | 0.10 | 0.10 | — | — | — | — | — | — | — | — | — | — | — |
| A1-36 | 0.10 | 0.10 | — | — | — | — | — | — | — | — | — | — | — | — | — |
| A1-37 | 0.40 | 0.20 | 0.10 | 0.10 | 0.010 | 0.300 | — | — | — | — | — | — | 0.1 | — | — |
| A1-38 | 0.10 | 1.50 | 0.50 | 0.10 | 0.010 | 0.300 | — | — | — | — | — | — | — | 0.1 | — |
| A1-39 | 0.10 | 0.20 | 1.00 | — | 0.010 | 0.300 | — | — | — | — | — | — | — | — | 0.1 |
| A1-40 | 0.10 | 0.20 | — | 1.50 | 0.010 | 0.300 | — | — | — | — | — | — | — | — | — |
| | Element composition (mass %) | | | | | | | | | | | | | | |
| Alloy | | | | | | | | Si + Fe + | Ti + | Al + unavoidable | | | | | |
| No. | Cd | Bi | Ge | Zn | Ti | B | V | Mn + Ni | B + V | impurities | | | | | |
| A1-21 | — | — | — | — | — | — | — | 2.90 | 0.000 | Balance | | | | | |
| A1-22 | — | — | — | — | — | — | — | 0.40 | 0.000 | Balance | | | | | |
| A1-23 | — | — | — | — | — | — | — | 1.90 | 0.000 | Balance | | | | | |
| A1-24 | — | — | — | — | — | — | — | 1.90 | 0.000 | Balance | | | | | |
| A1-25 | — | — | — | — | — | — | — | 1.90 | 0.000 | Balance | | | | | |
| A1-26 | — | — | — | — | — | — | — | 1.90 | 0.000 | Balance | | | | | |
| A1-27 | — | — | — | 0.005 | 0.005 | 0.001 | 0.001 | 1.90 | 0.007 | Balance | | | | | |
| A1-28 | — | — | — | 10.000 | 0.454 | 0.023 | 0.012 | 1.90 | 0.489 | Balance | | | | | |
| A1-29 | — | — | — | — | — | — | — | 1.70 | 0.000 | Balance | | | | | |
| A1-30 | — | — | — | — | — | — | — | 1.80 | 0.000 | Balance | | | | | |
| A1-31 | — | — | — | — | — | — | — | 1.80 | 0.000 | Balance | | | | | |
| A1-32 | 5.0 | — | — | — | — | — | — | 1.70 | 0.000 | Balance | | | | | |
| A1-33 | — | 5.0 | — | — | — | — | — | 1.70 | 0.000 | Balance | | | | | |
| A1-34 | — | — | 1.0 | — | — | — | — | 1.70 | 0.000 | Balance | | | | | |
| A1-35 | — | — | — | — | — | — | — | 0.35 | 0.000 | Balance | | | | | |
| A1-36 | — | — | — | — | — | — | — | 0.20 | 0.000 | Balance | | | | | |
| A1-37 | — | — | — | 0.300 | — | — | — | 0.80 | 0.000 | Balance | | | | | |
| A1-38 | — | — | — | 0.300 | — | — | — | 2.20 | 0.000 | Balance | | | | | |
| A1-39 | — | — | — | 0.300 | — | — | — | 1.30 | 0.000 | Balance | | | | | |
| A1-40 | 0.1 | — | — | 0.300 | — | — | — | 1.80 | 0.000 | Balance | | | | | |
| Alloy | Element composition (mass %) | | | | | | | | | | | | | | |
| No. | Si | Fe | Mn | Ni | Cu | Mg | Cr | Zr | Be | Na | Sr | P | Pb | Sn | In |
| A1-41 | 0.40 | 1.50 | 0.50 | 0.50 | 0.400 | — | — | — | — | — | — | — | — | — | — |
| A1-42 | 0.40 | 0.20 | — | — | 0.300 | 0.900 | — | — | — | — | — | — | — | — | — |
| A1-43 | 0.20 | 0.20 | 0.10 | 0.10 | 0.300 | 0.900 | 0.200 | 0.010 | 0.0001 | 0.001 | 0.001 | 0.001 | 0.1 | 0.1 | 0.1 |
| A1-44 | 25.00 | — | — | — | — | — | — | — | — | — | — | — | — | — | — |
| A1-45 | — | 11.00 | — | — | — | — | — | — | — | — | — | — | — | — | — |
| A1-46 | — | — | 16.00 | — | — | — | — | — | — | — | — | — | — | — | — |
| A1-47 | — | — | — | 21.00 | — | — | — | — | — | — | — | — | — | — | — |
| A1-48 | — | — | — | 21.00 | — | — | — | — | — | — | — | — | — | — | — |
| A1-49 | 0.20 | 1.50 | — | — | — | — | — | — | — | — | — | — | — | — | — |
| A1-50 | 0.20 | 1.50 | — | — | — | — | — | — | — | — | — | — | — | — | — |
| A1-51 | 0.20 | 1.50 | — | — | — | — | — | — | — | — | — | — | — | — | — |
| A1-52 | 0.20 | 1.50 | — | — | — | — | — | — | — | — | — | — | — | — | — |
| A1-53 | 0.20 | 1.50 | — | — | — | — | — | — | — | — | — | — | — | — | — |
| A1-54 | 0.20 | 1.50 | — | — | — | — | — | — | — | — | — | — | — | — | — |
| A1-55 | 0.20 | 1.50 | — | — | — | — | — | — | — | — | — | — | — | — | — |
| A1-56 | — | — | 16.00 | — | — | — | — | — | — | — | — | — | — | — | — |
| A1-57 | — | — | 16.00 | — | — | — | — | — | — | — | — | — | — | — | — |

| | Element composition (mass %) | | | | | | | | | |
|---|---|---|---|---|---|---|---|---|---|---|
| Alloy | | | | | | | | Si + Fe + | Ti + | Al + unavoidable |
| No. | Cd | Bi | Ge | Zn | Ti | B | V | Mn + Ni | B + V | impurities |
| A1-41 | — | 0.1 | — | — | — | — | — | 2.90 | 0.000 | Balance |
| A1-42 | — | — | 0.1 | — | — | — | — | 0.60 | 0.000 | Balance |
| A1-43 | 0.1 | 0.1 | 0.1 | 5.500 | 0.070 | 0.001 | 0.021 | 0.60 | 0.092 | Balance |
| A1-44 | — | — | — | — | — | — | — | 25.00 | 0.000 | Balance |
| A1-45 | — | — | — | — | — | — | — | 11.00 | 0.000 | Balance |
| A1-46 | — | — | — | — | — | — | — | 16.00 | 0.000 | Balance |
| A1-47 | — | — | — | — | — | — | — | 21.00 | 0.000 | Balance |
| A1-48 | — | — | — | — | — | — | — | 21.00 | 0.000 | Balance |
| A1-49 | — | — | — | — | — | — | — | 1.70 | 0.000 | Balance |
| A1-50 | — | — | — | — | — | — | — | 1.70 | 0.000 | Balance |
| A1-51 | — | — | — | — | — | — | — | 1.70 | 0.000 | Balance |
| A1-52 | — | — | — | — | — | — | — | 1.70 | 0.000 | Balance |
| A1-53 | — | — | — | — | — | — | — | 1.70 | 0.000 | Balance |
| A1-54 | — | — | — | — | — | — | — | 1.70 | 0.000 | Balance |
| A1-55 | — | — | — | — | — | — | — | 1.70 | 0.000 | Balance |
| A1-56 | — | — | — | — | — | — | — | 16.00 | 0.000 | Balance |
| A1-57 | — | — | — | — | — | — | — | 16.00 | 0.000 | Balance |

TABLE 24

| Alloy | Element composition (mass %) | | | | | | | | | | | | | | |
|---|---|---|---|---|---|---|---|---|---|---|---|---|---|---|---|
| No. | Si | Fe | Mn | Ni | Cu | Mg | Cr | Zr | Be | Na | Sr | P | Pb | Sn | In |
| AC1-1 | 0.05 | — | — | — | — | — | — | — | — | — | — | — | — | — | — |
| AC1-2 | — | 0.02 | — | — | — | — | — | — | — | — | — | — | — | — | — |
| AC1-3 | — | — | 0.05 | — | — | — | — | — | — | — | — | — | — | — | — |
| AC1-4 | — | — | — | 0.05 | — | — | — | — | — | — | — | — | — | — | — |
| AC1-5 | 0.10 | 0.05 | — | — | — | — | — | — | — | — | — | — | — | — | — |
| AC1-6 | — | 0.05 | 0.10 | — | — | — | — | — | — | — | — | — | — | — | — |
| AC1-7 | — | 0.05 | — | 0.10 | — | — | — | — | — | — | — | — | — | — | — |
| AC1-8 | 0.10 | 0.10 | — | — | — | — | — | — | — | — | — | — | — | — | — |
| AC1-9 | 0.10 | — | 0.10 | — | — | — | — | — | — | — | — | — | — | — | — |
| AC1-10 | 0.10 | — | — | 0.10 | — | — | — | — | — | — | — | — | — | — | — |
| AC1-11 | — | — | 0.10 | 0.10 | — | — | — | — | — | — | — | — | — | — | — |
| AC1-12 | — | — | 0.10 | 0.10 | — | — | — | — | — | — | — | — | — | — | — |
| AC1-13 | 0.01 | 0.01 | — | — | 0.010 | 4.506 | — | — | — | — | — | — | — | — | — |

| | Element composition (mass %) | | | | | | | | | |
|---|---|---|---|---|---|---|---|---|---|---|
| Alloy | | | | | | | | Si + Fe + | Ti + | Al + unavoidable |
| No. | Cd | Bi | Ge | Zn | Ti | B | V | Mn + Ni | B + V | impurities |
| AC1-1 | — | — | — | — | — | — | — | 0.05 | 0.000 | Balance |
| AC1-2 | — | — | — | — | — | — | — | 0.02 | 0.000 | Balance |
| AC1-3 | — | — | — | — | — | — | — | 0.05 | 0.000 | Balance |
| AC1-4 | — | — | — | — | — | — | — | 0.05 | 0.000 | Balance |
| AC1-5 | — | — | — | — | — | — | — | 0.15 | 0.000 | Balance |
| AC1-6 | — | — | — | — | — | — | — | 0.15 | 0.000 | Balance |
| AC1-7 | — | — | — | — | — | — | — | 0.15 | 0.000 | Balance |
| AC1-8 | — | — | — | — | — | — | — | 0.20 | 0.000 | Balance |
| AC1-9 | — | — | — | — | — | — | — | 0.20 | 0.000 | Balance |
| AC1-10 | — | — | — | — | — | — | — | 0.20 | 0.000 | Balance |
| AC1-11 | — | — | — | — | — | — | — | 0.20 | 0.000 | Balance |
| AC1-12 | — | — | — | — | — | — | — | 0.20 | 0.000 | Balance |
| AC1-13 | — | — | — | 0.300 | — | — | — | 0.02 | 0.000 | Balance |

Next, as shown in Table 25 to Table 27, ingots were produced by casting alloy Nos. A1-1 to A1-18, A1-20, A1-21, A1-23 to A1-31, A1-35 to A1-57, AC1-1 to AC1-7, and AC1-9 to AC1-13 by subjecting aluminum alloy molten metals to a DC casting method, and by casting alloy Nos. A1-19, A1-22, A1-32 to A1-34, and AC1-8 by subjecting aluminum alloy molten metals to a CC casting method (Step S302).

The ingots of alloy Nos. A1-1 to A1-18, A1-20, A1-21, A1-23 to A1-31, A1-35 to A1-57, AC1-1 to A1-C7, and AC1-9 to AC1-13 were subjected to face milling of 15 mm on both surfaces. Next, a homogenization treatment was applied under the conditions indicated in Table 25 to Table 27 (Step S303). Meanwhile, alloy No. A47 was retained for 5 hours at 630° C. to 640° C. after the second stage homogenization treatment. Furthermore, alloy No. AC1-11 was retained for 5 hours at 380° C. to 390° C. Next, hot-rolling was performed at a rolling initiation temperature of 370° C. and a rolling completion temperature of 310° C., and thus hot-rolled sheets having a sheet thickness of 3.0 mm were produced (Step S304). The hot-rolled sheets of alloy Nos. A1-1 to A1-6, A1-8 to A1-36, and AC1-1 to AC1-4 were subjected to annealing (batch type) under the conditions of 360° C. and for 2 hours. All of the sheet materials were rolled to a final sheet thickness of 0.8 mm by cold-rolling (rolling ratio 73.3%), and thus aluminum alloy sheets were obtained (Step S305). The aluminum alloy sheets were punched into an annular shape having an outer diameter of 96 mm and an inner diameter of 24 mm, and disk blanks were produced (Step S306).

The disk blanks were subjected to pressure annealing for 3 hours at 350° C. (Step S307). End surface processing was performed to adjust the outer diameter to 95 mm and the inner diameter to 25 mm, and grinding work (grinding of 10 μm from the surface) was performed (Step S308).

Next, as shown in Table 28 to Table 30, coating films of metals or alloys C1-1 to C1-57 and CC1-1 to CC1-13 were formed by sputtering over the entire periphery of the disk blank (Step S309).

Subsequently, degreasing was performed at 60° C. by means of AD-68F (trade name, manufactured by C. Uyemura & Co., Ltd.), and then etching was performed at 65° C. by means of AD-107F (trade name, manufactured by C. Uyemura & Co., Ltd.). Furthermore, desmutting was performed using a 30% aqueous solution of HNO₃ (room temperature) (Step S309). After the surface state was cleaned up as such, the disk blanks were subjected to a zincate treatment on the surface by immersing the disk blanks in a zincate treatment liquid at 20° C. of AD-301 F-3X (trade name, manufactured by C. Uyemura & Co., Ltd.) for 0.5 minutes (Step S309). The zincate treatment was performed two times in total, and the disk blanks were immersed in a 30% aqueous solution of HNO₃ at room temperature for 20 seconds between the zincate treatments so as to subject the surface to a peeling treatment.

The surface that had been subjected to two times of a zincate treatment, was subjected to electroless plating with Ni—P to a thickness of 21 μm using an electroless Ni—P plating treatment liquid (NIMUDEN HDX (trade name, manufactured by C. Uyemura & Co., Ltd.)). The plated surface thus obtained were subjected to rough polishing using an alumina slurry having an average particle size of 800 nm and a polishing pad made of foamed or expanded urethane. The working amount of the rough polishing was set to 3.8 μm. Subsequently, finish polishing work was performed using a colloidal silica having a particle size of 20 to 200 nm and a polishing pad made of foamed or expanded urethane. The working amount of the finish polishing work was set to 0.2 μm. Furthermore, removal of the polishing grains, chips, and other attached foreign materials was performed by sufficiently scrubbing and washing the surface of the plated surface using an alkali cleaner and a PVA sponge, and sufficiently rinsing using deionized water having a resistivity of 18 MΩ·cm or more (Step S310).

The aluminum alloy ingots after the casting (Step S302) step, the aluminum alloy substrates after the grinding work (Step S308) step, and the aluminum alloy substrates after the plating treatment polishing (Step S310) step were subjected to the following evaluations. Meanwhile, ten disks of each alloy were processed up to the plating treatment. However, in some of the disks of Examples 1-3 to 1-5, 1-44 to 1-48, 1-56, and 1-57, peeling of the plating occurred. The number of disks in which peeling of the plating occurred was one sheet in Example 1-3; two sheets in Example 1-4; three sheets in Example 1-5; four sheets in Example 1-44; five sheets in Example 1-45; five sheets in Example 1-46; five sheets in Example 1-47; four sheets in Example 1-48; four sheets in Example 1-56; and four sheets in Example 1-57. In those Examples, evaluations were performed using the disks in which peeling of the plating did not occur.

TABLE 25

| | | | | | Homogenization treatment conditions | |
|---|---|---|---|---|---|---|
| | | | | | | Keeping |
| | | | | | | time |
| | | | | | | (hr) at |
| | | | | | | 2nd stage |
| | | | | | Keeping | at higher |
| | | Casting conditions | | | time (hr) | than 470° |
| | | | Casting | Ingot sheet | at 1st stage | C. but less |
| | Alloy | Casting | speed | thickness | at 400 | than |
| | No. | method | (mm/min) | (mm) | to 470° C. | 630° C. |
| Ex 1-1 | A1-1 | DC | 30 | 300 | 49 | 5 |
| Ex 1-2 | A1-2 | DC | 30 | 300 | 25 | 5 |
| Ex 1-3 | A1-3 | DC | 30 | 300 | 0.5 | 5 |
| Ex 1-4 | A1-4 | DC | 30 | 300 | 5 | 5 |
| Ex 1-5 | A1-5 | DC | 30 | 300 | 5 | 5 |
| Ex 1-6 | A1-6 | DC | 30 | 300 | 5 | 29 |
| Ex 1-7 | A1-7 | DC | 30 | 300 | 5 | 15 |
| Ex 1-8 | A1-8 | DC | 30 | 300 | 5 | 1 |
| Ex 1-9 | A1-9 | DC | 30 | 300 | 5 | 5 |
| Ex 1-10 | A1-10 | DC | 30 | 300 | 5 | 5 |
| Ex 1-11 | A1-11 | DC | 40 | 300 | 5 | 5 |
| Ex 1-12 | A1-12 | DC | 40 | 300 | 5 | 5 |
| Ex 1-13 | A1-13 | DC | 40 | 300 | 5 | 5 |
| Ex 1-14 | A1-14 | DC | 40 | 300 | 5 | 5 |
| Ex 1-15 | A1-15 | DC | 20 | 300 | 5 | 5 |
| Ex 1-16 | A1-16 | DC | 70 | 300 | 5 | 5 |
| Ex 1-17 | A1-17 | DC | 70 | 300 | 5 | 5 |
| Ex 1-18 | A1-18 | DC | 40 | 300 | 5 | 5 |
| Ex 1-19 | A1-19 | CC | 1000 | 3 | 5 | 5 |
| Ex 1-20 | A1-20 | DC | 40 | 300 | 5 | 5 |

TABLE 26

| | | | | | Homogenization treatment conditions | |
|---|---|---|---|---|---|---|
| | | | | | | Keeping |
| | | | | | | time |
| | | | | | | (hr) at |
| | | | | | | 2nd stage |
| | | | | | Keeping | at higher |
| | | Casting conditions | | | time (hr) | than 470° |
| | | | Casting | Ingot sheet | at 1st stage | C. but less |
| | Alloy | Casting | speed | thickness | at 400 | than |
| | No. | method | (mm/min) | (mm) | to 470° C. | 630° C. |
| Ex 1-21 | A1-21 | DC | 50 | 300 | 5 | 5 |
| Ex 1-22 | A1-22 | CC | 1000 | 3 | 5 | 5 |
| Ex 1-23 | A1-23 | DC | 50 | 300 | 5 | 5 |
| Ex 1-24 | A1-24 | DC | 50 | 300 | 5 | 5 |
| Ex 1-25 | A1-25 | DC | 50 | 300 | 5 | 5 |
| Ex 1-26 | A1-26 | DC | 50 | 300 | 5 | 5 |
| Ex 1-27 | A1-27 | DC | 50 | 300 | 5 | 5 |
| Ex 1-28 | A1-28 | DC | 50 | 300 | 5 | 5 |
| Ex 1-29 | A1-29 | DC | 50 | 300 | 5 | 5 |
| Ex 1-30 | A1-30 | DC | 50 | 300 | 5 | 5 |
| Ex 1-31 | A1-31 | DC | 50 | 300 | 5 | 5 |
| Ex 1-32 | A1-32 | CC | 1400 | 6 | 5 | 5 |
| Ex 1-33 | A1-33 | CC | 1000 | 3 | 5 | 5 |
| Ex 1-34 | A1-34 | CC | 800 | 3 | 5 | 5 |
| Ex 1-35 | A1-35 | DC | 60 | 300 | 5 | 5 |
| Ex 1-36 | A1-36 | DC | 60 | 300 | 5 | 5 |
| Ex 1-37 | A1-37 | DC | 50 | 300 | 5 | 5 |
| Ex 1-38 | A1-38 | DC | 50 | 300 | 5 | 5 |
| Ex 1-39 | A1-39 | DC | 50 | 300 | 5 | 5 |
| Ex 1-40 | A1-40 | DC | 50 | 300 | 5 | 5 |
| Ex 1-41 | A1-41 | DC | 50 | 300 | 5 | 5 |
| Ex 1-42 | A1-42 | DC | 50 | 300 | 5 | 5 |
| Ex 1-43 | A1-43 | DC | 50 | 300 | 5 | 5 |
| Ex 1-44 | A1-44 | DC | 50 | 300 | 53 | 5 |
| Ex 1-45 | A1-45 | DC | 50 | 300 | 5 | 33 |
| Ex 1-46 | A1-46 | DC | 50 | 300 | 0.3 | 33 |
| Ex 1-47 | A1-47 | DC | 50 | 300 | 5 | 5 |
| Ex 1-48 | A1-48 | DC | 10 | 300 | 5 | 5 |
| Ex 1-49 | A1-49 | DC | 50 | 300 | 5 | 5 |
| Ex 1-50 | A1-50 | DC | 50 | 300 | 5 | 5 |
| Ex 1-51 | A1-51 | DC | 50 | 300 | 5 | 5 |
| Ex 1-52 | A1-52 | DC | 50 | 300 | 5 | 5 |
| Ex 1-53 | A1-53 | DC | 50 | 300 | 5 | 5 |
| Ex 1-54 | A1-54 | DC | 50 | 300 | 5 | 5 |
| Ex 1-55 | A1-55 | DC | 50 | 300 | 5 | 5 |
| Ex 1-56 | A1-56 | DC | 50 | 300 | 5 | 5 |
| Ex 1-57 | A1-57 | DC | 50 | 300 | 5 | 5 |

TABLE 27

| | | | | | Homogenization treatment conditions | |
|---|---|---|---|---|---|---|
| | | | | | | Keeping |
| | | | | | | time |
| | | | | | | (hr) at |
| | | | | | | 2nd stage |
| | | | | | Keeping | at higher |
| | | Casting conditions | | | time (hr) | than 470° |
| | | | Casting | Ingot sheet | at 1st stage | C. but less |
| | Alloy | Casting | speed | thickness | at 400 | than |
| | No. | method | (mm/min) | (mm) | to 470° C. | 630° C. |
| C Ex 1-1 | AC1-1 | DC | 30 | 300 | 5 | 5 |
| C Ex 1-2 | AC1-2 | DC | 30 | 300 | 5 | 5 |
| C Ex 1-3 | AC1-3 | DC | 30 | 300 | 5 | 5 |
| C Ex 1-4 | AC1-4 | DC | 30 | 300 | 5 | 5 |
| C Ex 1-5 | AC1-5 | DC | 30 | 300 | 5 | 5 |
| C Ex 1-6 | AC1-6 | DC | 30 | 300 | 5 | 5 |
| C Ex 1-7 | AC1-7 | DC | 30 | 300 | 5 | 5 |
| C Ex 1-8 | AC1-8 | CC | 600 | 3 | 5 | 5 |
| C Ex 1-9 | AC1-9 | DC | 30 | 300 | 0.3 | 1 |
| C Ex 1-10 | AC1-10 | DC | 30 | 300 | 5 | 0.3 |
| C Ex 1-11 | AC1-11 | DC | 30 | 300 | 0 | 0 |
| C Ex 1-12 | AC1-12 | DC | 30 | 300 | 0.3 | 0 |
| C Ex 1-13 | AC1-13 | DC | 30 | 300 | 5 | 5 |

### [Cooling Speed at the Time of Casting]

The DAS (dendrite arm spacing) of the ingots after casting (Step S302) was measured, and the cooling speed (° C./s) at the time of casting was calculated. The DAS was analyzed by performing an observation of the cross-sectional microstructure in the thickness direction of the ingots using an optical microscope, and analyzing the cross-sectional microstructure by a secondary branching method. The analysis was made using a cross-section at the central part in the thickness direction of an ingot.

### [The Number of Second Phase Particles, the Longest Diameter, and the Sum of Circumferences]

A cross-section of an aluminum alloy substrate obtained after grinding work (Step S308) was observed with an optical microscope at a magnification of 400× in 20 viewing fields (the area of one viewing field: 0.05 mm²), and the number of second phase particles (particles/mm²), the longest diameter, and the sum of circumferences (mm/mm²) were measured using a particle analysis software program, A-ZOKUN (trade name, manufactured by Asahi Kasei Engineering Corporation). The measurement was made using a cross-section at the central part in the thickness direction of the substrate.

### [Measurement of Disk Flutter]

Measurement of disk flutter was performed using an aluminum alloy substrate after the plating treatment polishing (Step S310) step. The measurement of disk flutter was carried out by installing aluminum alloy substrates in a commercially available hard disk drive in the presence of the air. ST2000 (trade name) manufactured by Seagate Technology PLC was used as the drive, and motor driving was achieved by directly connecting SLD102 (trade name) manufactured by Techno Alive Co., Ltd. to a motor. The speed of rotation was set to 7,200 rpm. The disks were installed such that a plurality of disks were installed in every case, and vibration of the surface was observed by installing LDV1800 (trade name) manufactured by Ono Sokki Co., Ltd., which is a laser Doppler vibrometer, on the surface of the magnetic disk at the top. The vibration thus observed was subjected to a spectral analysis using a FFT analyzer DS3200 (trade name) manufactured by Ono Sokki Co., Ltd. The observation was made by making a hole in the lid of the hard disk driver and making an observation of the disk surface through the hole. Furthermore, the evaluation was performed after eliminating the squeeze plate that was installed in the commercially available hard disk.

The evaluation of the fluttering characteristics was carded out based on the maximum displacement (disk fluttering (nm)) of a broad peak near 300 Hz to 1,500 Hz where fluttering appeared. This broad peak is referred to as NRRO (non-repeatable run out), and it is understood that this broad peak significantly affects the positioning error of the head.

Rating of the fluttering characteristics was such that the case in which the value obtained in the air was 30 nm or less was rated as A (excellent); the case in which the value was larger than 30 nm and 40 nm or less was rated as B (good); the case in which the value was larger than 40 nm and 50 nm or less was rated as C (acceptable); and the case in which the value was larger than 50 nm was rated as D (poor).

### [Average Crystal Grain Size at Surface]

The aluminum alloy substrate surface (L-LT surface, rolled surface) after the grinding work (Step S308) was subjected to Barker etching using a Barker solution (an aqueous solution obtained by mixing HBF₄ (tetrafluoroboric acid) with water at a volume ratio of 1:30), and one image of the surface was taken with a polarized microscope at a magnification of 100×. Measurement of the crystal grain size was performed using a line intersection method of counting the number of intersecting crystal grains. Drawing of five straight lines each having a length of 500 pin in the LT direction (the direction perpendicular to the rolling direction) was performed, and the average value was determined.

These results are shown in Tables 34 to 36.

TABLE 28

| | Metal coating film element composition (mass %) | | | | | | | |
|---|---|---|---|---|---|---|---|---|
| Alloy | | | | | | | | Al + unavoidable |
| No. | Mg | Cu | Zn | Cr | Fe | Si | Mn | impurities |
| C1-1 | — | 0.001 | 0.001 | 0.001 | 0.281 | 0.003 | — | Balance |
| C1-2 | — | 0.001 | 0.001 | — | 0.002 | 0.273 | — | Balance |
| C1-3 | 0.3 | 0.020 | 0.590 | 0.284 | 0.022 | 0.007 | — | Balance |
| C1-4 | 0.5 | 0.078 | 0.210 | 0.172 | 0.021 | 0.002 | — | Balance |
| C1-5 | 7.9 | 0.036 | 0.480 | 0.050 | 0.002 | 0.028 | — | Balance |
| C1-6 | 1.2 | 0.057 | 0.120 | 0.055 | 0.020 | 0.021 | — | Balance |
| C1-7 | 2.3 | 0.083 | 0.580 | 0.015 | 0.007 | 0.029 | — | Balance |
| C1-8 | 3.1 | 0.006 | 0.060 | 0.180 | 0.029 | 0.025 | — | Balance |
| C1-9 | 4.2 | 0.066 | 0.260 | 0.050 | 0.016 | 0.023 | 0.20 | Balance |
| C1-10 | 4.4 | 0.123 | 0.500 | 0.100 | 0.002 | 0.012 | 0.02 | Balance |
| C1-11 | 5.4 | 0.542 | 0.390 | 0.070 | 0.008 | 0.004 | — | Balance |
| C1-12 | 5.7 | 0.080 | 0.230 | 0.291 | 0.023 | 0.005 | — | Balance |
| C1-13 | 4.3 | 0.125 | 0.160 | 0.030 | 0.020 | 0.002 | — | Balance |
| C1-14 | 4.2 | 0.066 | 0.260 | 0.050 | 0.261 | 0.023 | — | Balance |
| C1-15 | 4.4 | 0.123 | 0.500 | 0.100 | 0.002 | 0.012 | — | Balance |
| C1-16 | 4.2 | 0.057 | 0.120 | 0.055 | 0.020 | 0.021 | — | Balance |
| C1-17 | 4.4 | 0.123 | 0.500 | 0.100 | 0.002 | 0.012 | — | Balance |
| C1-18 | 3.6 | 0.060 | 0.006 | 0.183 | 0.022 | 0.007 | — | Balance |
| C1-19 | 4.2 | 0.123 | 0.280 | 0.212 | 0.017 | 0.007 | — | Balance |
| C1-20 | 4.2 | 0.018 | 0.490 | 0.240 | 0.025 | 0.002 | — | Balance |

TABLE 29

| | Metal coating film element composition (mass %) | | | | | | | |
|---|---|---|---|---|---|---|---|---|
| | | | Zn + | | | | | Al + |
| | | | unavoidable | | | | | unavoidable |
| | | | impurities | | | | | impurities |
| | | | (C1-51, | | | | | (C1-21 |
| | | | C1-52, | | | | | to |
| Alloy | | | C1-54, | | | | | C1-50, |
| No. | Mg | Cu | C1-55) | Cr | Fe | Si | Mn | C1-53) |
| C1-21 | 4.4 | 0.123 | 0.500 | 0.100 | 0.008 | 0.012 | — | Balance |
| C1-22 | 4.7 | 0.043 | 0.150 | 0.020 | 0.027 | 0.223 | — | Balance |
| C1-23 | 3.9 | 0.088 | 0.280 | 0.190 | 0.020 | 0.020 | — | Balance |
| C1-24 | 4.2 | 0.057 | 0.120 | 0.055 | 0.020 | 0.021 | — | Balance |
| C1-25 | 4.4 | 0.123 | 0.500 | 0.100 | 0.002 | 0.012 | — | Balance |
| C1-26 | 4.2 | 0.057 | 0.120 | 0.055 | 0.020 | 0.021 | — | Balance |
| C1-27 | 3.1 | 0.006 | 0.060 | 0.180 | 0.029 | 0.025 | — | Balance |
| C1-28 | — | 0.532 | 0.007 | 0.001 | 0.032 | 0.003 | — | Balance |
| C1-29 | — | 0.007 | 0.543 | 0.001 | 0.032 | 0.010 | — | Balance |
| C1-30 | 3.1 | 0.142 | 0.230 | 0.100 | 0.016 | 0.029 | — | Balance |
| C1-31 | 4.3 | 0.123 | 0.390 | 0.291 | 0.029 | 0.023 | — | Balance |
| C1-32 | 4.2 | 0.083 | 0.230 | 0.180 | 0.020 | 0.002 | — | Balance |
| C1-33 | 3.1 | 0.006 | 0.060 | 0.180 | 0.029 | 0.025 | — | Balance |
| C1-34 | 4.2 | 0.057 | 0.120 | 0.055 | 0.020 | 0.021 | — | Balance |
| C1-35 | 3.8 | 0.067 | 0.450 | 0.110 | 0.026 | 0.013 | — | Balance |
| C1-36 | 5.9 | 0.043 | 0.440 | 0.183 | 0.017 | 0.020 | — | Balance |
| C1-37 | 3.1 | 0.006 | 0.060 | 0.180 | 0.029 | 0.025 | — | Balance |
| C1-38 | 3.1 | 0.006 | 0.060 | 0.180 | 0.029 | 0.025 | — | Balance |
| C1-39 | 3.1 | 0.006 | 0.060 | 0.180 | 0.029 | 0.025 | — | Balance |
| C1-40 | 3.1 | 0.006 | 0.060 | 0.180 | 0.029 | 0.025 | — | Balance |
| C1-41 | 3.1 | 0.006 | 0.060 | 0.180 | 0.029 | 0.025 | — | Balance |
| C1-42 | 3.1 | 0.006 | 0.060 | 0.180 | 0.029 | 0.025 | — | Balance |
| C1-43 | 3.1 | 0.006 | 0.060 | 0.180 | 0.029 | 0.025 | — | Balance |
| C1-44 | 3.1 | 0.006 | 0.060 | 0.180 | 0.029 | 0.025 | — | Balance |
| C1-45 | 3.1 | 0.006 | 0.060 | 0.180 | 0.029 | 0.023 | — | Balance |
| C1-46 | 3.1 | 0.006 | 0.060 | 0.180 | 0.029 | 0.025 | — | Balance |
| C1-47 | 3.1 | 0.006 | 0.060 | 0.180 | 0.029 | 0.025 | — | Balance |
| C1-48 | 3.1 | 0.006 | 0.060 | 0.180 | 0.029 | 0.025 | — | Balance |
| C1-49 | 3.1 | 0.006 | 0.060 | 0.180 | 0.029 | 0.025 | — | Balance |
| C1-50 | 3.1 | 0.006 | 0.060 | 0.180 | 0.029 | 0.025 | — | Balance |
| C1-51 | — | — | Balance | — | — | — | — | 0.1 |
| C1-52 | — | — | Balance | — | — | — | — | 0.1 |
| C1-53 | 3.1 | 0.006 | 0.060 | 0.180 | 0.029 | 0.025 | — | Balance |
| C1-54 | — | — | Balance | — | — | — | — | 0.1 |
| C1-55 | — | — | Balance | — | — | — | — | 0.1 |
| C1-56 | 3.1 | 0.006 | 0.060 | 0.180 | 0.029 | 0.025 | — | Balance |
| C1-57 | 3.1 | 0.006 | 0.060 | 0.180 | 0.029 | 0.025 | — | Balance |

TABLE 30

| | Metal coating film element composition (mass %) | | | | | | | |
|---|---|---|---|---|---|---|---|---|
| Alloy | | | | | | | | Al + unavoidable |
| No. | Mg | Cu | Zn | Cr | Fe | Si | Mn | impurities |
| CC1-1 | 5.2 | 0.056 | 0.330 | 0.080 | 0.029 | 0.015 | — | Balance |
| CC1-2 | 3.7 | 0.131 | 0.230 | 0.081 | 0.007 | 0.013 | — | Balance |
| CC1-3 | 3.7 | 0.131 | 0.230 | 0.081 | 0.007 | 0.013 | — | Balance |
| CC1-4 | 3.7 | 0.131 | 0.230 | 0.081 | 0.007 | 0.013 | — | Balance |
| CC1-5 | 3.7 | 0.131 | 0.230 | 0.081 | 0.007 | 0.013 | — | Balance |
| CC1-6 | 3.7 | 0.131 | 0.230 | 0.081 | 0.007 | 0.013 | — | Balance |
| CC1-7 | 3.7 | 0.131 | 0.230 | 0.081 | 0.007 | 0.013 | — | Balance |
| CC1-8 | 3.7 | 0.131 | 0.230 | 0.081 | 0.007 | 0.013 | — | Balance |
| CC1-9 | 3.7 | 0.131 | 0.230 | 0.081 | 0.007 | 0.013 | — | Balance |
| CC1-10 | 3.7 | 0.131 | 0.230 | 0.081 | 0.007 | 0.013 | — | Balance |
| CC1-11 | 3.7 | 0.131 | 0.230 | 0.081 | 0.007 | 0.013 | — | Balance |
| CC1-12 | 3.7 | 0.131 | 0.230 | 0.081 | 0.007 | 0.013 | — | Balance |
| CC1-13 | 3.7 | 0.131 | 0.230 | 0.081 | 0.007 | 0.013 | — | Balance |

TABLE 31

| | Al disk alloy substrate | | Metal coating film | |
|---|---|---|---|---|
| | | Casting | | Film thickness |
| | Alloy No. | conditions | Alloy No. | (nm) |
| Ex 1-1 | A1-1 | DC | C1-1 | 300 |
| Ex 1-2 | A1-2 | DC | C1-2 | 300 |
| Ex 1-3 | A1-3 | DC | C1-3 | 300 |
| Ex 1-4 | A1-4 | DC | C1-4 | 300 |
| Ex 1-5 | A1-5 | DC | C1-5 | 300 |
| Ex 1-6 | A1-6 | DC | C1-6 | 300 |
| Ex 1-7 | A1-7 | DC | C1-7 | 300 |
| Ex 1-8 | A1-8 | DC | C1-8 | 300 |
| Ex 1-9 | A1-9 | DC | C1-9 | 300 |
| Ex 1-10 | A1-10 | DC | C1-10 | 300 |
| Ex 1-11 | A1-11 | DC | C1-11 | 300 |
| Ex 1-12 | A1-12 | DC | C1-12 | 300 |
| Ex 1-13 | A1-13 | DC | C1-13 | 300 |
| Ex 1-14 | A1-14 | DC | C1-14 | 300 |
| Ex 1-15 | A1-15 | DC | C1-15 | 300 |
| Ex 1-16 | A1-16 | DC | C1-16 | 300 |
| Ex 1-17 | A1-17 | DC | C1-17 | 300 |
| Ex 1-18 | A1-18 | DC | C1-18 | 300 |
| Ex 1-19 | A1-19 | CC | C1-19 | 300 |
| Ex 1-20 | A1-20 | DC | C1-20 | 300 |

TABLE 32

| | Al disk alloy substrate | | Metal coating film | |
|---|---|---|---|---|
| | | Casting | | Film thickness |
| | Alloy No. | conditions | Alloy No. | (nm) |
| Ex 1-21 | A1-21 | DC | C1-21 | 300 |
| Ex 1-22 | A1-22 | CC | C1-22 | 300 |
| Ex 1-23 | A1-23 | DC | C1-23 | 300 |
| Ex 1-24 | A1-24 | DC | C1-24 | 300 |
| Ex 1-25 | A1-25 | DC | C1-25 | 300 |
| Ex 1-26 | A1-26 | DC | C1-26 | 300 |
| Ex 1-27 | A1-27 | DC | C1-27 | 300 |
| Ex 1-28 | A1-28 | DC | C1-28 | 300 |
| Ex 1-29 | A1-29 | DC | C1-29 | 300 |
| Ex 1-30 | A1-30 | DC | C1-30 | 300 |
| Ex 1-31 | A1-31 | DC | C1-31 | 300 |
| Ex 1-32 | A1-32 | CC | C1-32 | 300 |
| Ex 1-33 | A1-33 | CC | C1-33 | 300 |
| Ex 1-34 | A1-34 | CC | C1-34 | 300 |
| Ex 1-35 | A1-35 | DC | C1-35 | 300 |
| Ex 1-36 | A1-36 | DC | C1-36 | 300 |
| Ex 1-37 | A1-37 | DC | C1-37 | 300 |
| Ex 1-38 | A1-38 | DC | C1-38 | 300 |
| Ex 1-39 | A1-39 | DC | C1-39 | 300 |
| Ex 1-40 | A1-40 | DC | C1-40 | 300 |
| Ex 1-41 | A1-41 | DC | C1-41 | 300 |
| Ex 1-42 | A1-42 | DC | C1-42 | 300 |
| Ex 1-43 | A1-43 | DC | C1-43 | 300 |
| Ex 1-44 | A1-44 | DC | C1-44 | 300 |
| Ex 1-45 | A1-45 | DC | C1-45 | 300 |
| Ex 1-46 | A1-46 | DC | C1-46 | 300 |
| Ex 1-47 | A1-47 | DC | C1-47 | 300 |
| Ex 1-48 | A1-48 | DC | C1-48 | 300 |
| Ex 1-49 | A1-49 | DC | C1-49 | 10 |
| Ex 1-50 | A1-50 | DC | C1-50 | 3000 |
| Ex 1-51 | A1-51 | DC | C1-51 | 10 |
| Ex 1-52 | A1-52 | DC | C1-52 | 3000 |
| Ex 1-53 | A1-53 | DC | C1-53 | 20 |
| Ex 1-54 | A1-54 | DC | C1-54 | 20 |
| Ex 1-55 | A1-55 | DC | C1-55 | 300 |
| Ex 1-56 | A1-56 | DC | C1-56 | 5 |
| Ex 1-57 | A1-57 | DC | C1-57 | 5000 |

TABLE 33

| | Al disk alloy substrate | | Metal coating film | |
|---|---|---|---|---|
| | | Casting | | Film thickness |
| | Alloy No. | conditions | Alloy No. | (nm) |
| C Ex 1-1 | AC1-1 | DC | CC1-1 | 300 |
| C Ex 1-2 | AC1-2 | DC | CC1-2 | 300 |
| C Ex 1-3 | AC1-3 | DC | CC1-3 | 300 |
| C Ex 1-4 | AC1-4 | DC | CC1-4 | 300 |
| C Ex 1-5 | AC1-5 | DC | CC1-5 | 300 |
| C Ex 1-6 | AC1-6 | DC | CC1-6 | 300 |
| C Ex 1-7 | AC1-7 | DC | CC1-7 | 300 |
| C Ex 1-8 | AC1-8 | CC | CC1-8 | 300 |
| C Ex 1-9 | AC1-9 | DC | CC1-9 | 300 |
| C Ex 1-10 | AC1-10 | DC | CC1-10 | 300 |
| C Ex 1-11 | AC1-11 | DC | CC1-11 | 300 |
| C Ex 1-12 | AC1-12 | DC | CC1-12 | 300 |
| C Ex 1-13 | AC1-13 | DC | CC1-13 | 300 |

TABLE 34

| | | | | The | | | |
|---|---|---|---|---|---|---|---|
| | | | | number | The sum of | | |
| | | | | of | circumferences | | |
| | | | | second | of second | | |
| | | | | phase | phase | | |
| | | | | particles | particles | | |
| | | | | having | having | | |
| | | | | the longest | the longest | | |
| | | | | diameter of | diameter of | Average | |
| | | | Cooling | 4 μm or | 4 μm or | crystal | |
| | | Alloy | speed | more and | more and | grain | |
| | | No. | at the | 30 μm | 30 μm | size | |
| | Alloy | (metal | time of | or less | or less | at the | |
| | No. | coating | casting | (particles/ | (mm/ | surface | Disk |
| | (substrate) | film) | (° C./s) | mm²) | mm²) | (μm) | fluttering |
| Ex 1-1 | A1-1 | C1 | 0.4 | 192 | 11.3 | 60 | B |
| Ex 1-2 | A1-2 | C2 | 0.3 | 532 | 31.0 | 43 | A |
| Ex 1-3 | A1-3 | C3 | 0.5 | 3212 | 69.0 | 19 | A |
| Ex 1-4 | A1-4 | C4 | 0.8 | 14021 | 253.0 | 15 | A |
| Ex 1-5 | A1-5 | C5 | 0.4 | 38921 | 893.3 | 6 | A |
| Ex 1-6 | A1-6 | C6 | 0.5 | 321 | 12.5 | 53 | B |
| Ex 1-7 | A1-7 | C7 | 0.3 | 1432 | 35.2 | 23 | A |
| Ex 1-8 | A1-8 | C8 | 0.5 | 24212 | 432.7 | 14 | A |
| Ex 1-9 | A1-9 | C9 | 0.5 | 42103 | 923.1 | 12 | A |
| Ex 1-10 | A1-10 | C10 | 0.3 | 171 | 11.5 | 53 | B |
| Ex 1-11 | A1-11 | C11 | 0.8 | 987 | 49.3 | 34 | A |
| Ex 1-12 | A1-12 | C12 | 0.8 | 12321 | 543.2 | 23 | A |
| Ex 1-13 | A1-13 | C13 | 0.9 | 31232 | 874.3 | 19 | A |
| Ex 1-14 | A1-14 | C14 | 0.8 | 212 | 13.5 | 82 | C |
| Ex 1-15 | A1-15 | C15 | 0.2 | 1125 | 39.2 | 39 | A |
| Ex 1-16 | A1-16 | C16 | 0.2 | 17654 | 256.8 | 20 | A |
| Ex 1-17 | A1-17 | C17 | 0.2 | 45432 | 874.2 | 19 | A |
| Ex 1-18 | A1-18 | C18 | 0.7 | 6894 | 215.1 | 23 | A |
| Ex 1-19 | A1-19 | C19 | 652.0 | 10321 | 378.1 | 18 | B |
| Ex 1-20 | A1-20 | C20 | 0.9 | 7121 | 283.4 | 15 | A |

TABLE 35

| | | | | The | | | |
|---|---|---|---|---|---|---|---|
| | | | | number | The sum of | | |
| | | | | of | circumferences | | |
| | | | | second | of second | | |
| | | | | phase | phase | | |
| | | | | particles | particles | | |
| | | | | having | having | | |
| | | | | the longest | the longest | | |
| | | | | diameter of | diameter of | Average | |
| | | | Cooling | 4 μm or | 4 μm or | crystal | |
| | | Alloy | speed | more and | more and | grain | |
| | | No. | at the | 30 μm | 30 μm | size | |
| | Alloy | (metal | time of | or less | or less | at the | |
| | No. | coating | casting | (particles/ | (mm/ | surface | Disk |
| | (substrate) | film) | (° C./s) | mm²) | mm²) | (μm) | fluttering |
| Ex 1-21 | A1-21 | C1-21 | 1.0 | 7531 | 189.4 | 15 | A |
| Ex 1-22 | A1-22 | C1-22 | 612.8 | 421 | 14.6 | 29 | B |
| Ex 1-23 | A1-23 | C1-23 | 0.9 | 5212 | 183.5 | 14 | A |
| Ex 1-24 | A1-24 | C1-24 | 0.8 | 12321 | 392.1 | 15 | A |
| Ex 1-25 | A1-25 | C1-25 | 0.5 | 6543 | 192.3 | 19 | A |
| Ex 1-26 | A1-26 | C1-26 | 0.5 | 15432 | 283.5 | 12 | A |
| Ex 1-27 | A1-27 | C1-27 | 0.5 | 4932 | 184.3 | 13 | A |
| Ex 1-28 | A1-28 | C1-28 | 0.8 | 5643 | 164.6 | 11 | A |
| Ex 1-29 | A1-29 | C1-29 | 0.9 | 8644 | 231.4 | 12 | A |
| Ex 1-30 | A1-30 | C1-30 | 0.8 | 7809 | 245.3 | 14 | A |
| Ex 1-31 | A1-31 | C1-31 | 0.8 | 8212 | 267.1 | 13 | A |
| Ex 1-32 | A1-32 | C1-32 | 254.3 | 4321 | 76.4 | 13 | A |
| Ex 1-33 | A1-33 | C1-33 | 793.5 | 3829 | 65.1 | 15 | A |
| Ex 1-34 | A1-34 | C1-34 | 923.1 | 2192 | 35.1 | 14 | A |
| Ex 1-35 | A1-35 | C1-35 | 1.1 | 212 | 11.2 | 38 | B |
| Ex 1-36 | A1-36 | C1-36 | 1.2 | 199 | 11.5 | 38 | B |
| Ex 1-37 | A1-37 | C1-37 | 0.8 | 2012 | 133.4 | 29 | A |
| Ex 1-38 | A1-38 | C1-38 | 0.9 | 6743 | 143.2 | 12 | A |
| Ex 1-39 | A1-39 | C1-39 | 0.8 | 1532 | 75.3 | 14 | A |
| Ex 1-40 | A1-40 | C1-40 | 0.8 | 5421 | 134.2 | 19 | A |
| Ex 1-41 | A1-41 | C1-41 | 0.9 | 6573 | 205.2 | 12 | A |
| Ex 1-42 | A1-42 | C1-42 | 0.8 | 981 | 66.3 | 28 | A |
| Ex 1-43 | A1-43 | C1-43 | 0.9 | 1211 | 54.2 | 32 | A |
| Ex 1-44 | A1-44 | C1-44 | 0.9 | 54321 | 1,120.1 | 12 | A |
| Ex 1-45 | A1-45 | C1-45 | 0.9 | 61211 | 1,098.3 | 5 | A |
| Ex 1-46 | A1-46 | C1-46 | 0.8 | 56503 | 1,234.5 | 12 | A |
| Ex 1-47 | A1-47 | C1-47 | 0.8 | 57520 | 1,231.1 | 11 | A |
| Ex 1-48 | A1-48 | C1-48 | 0.04 | 58123 | 1,125.0 | 10 | A |
| Ex 1-49 | A1-49 | C1-49 | 0.9 | 5211 | 184.3 | 13 | A |
| Ex 1-50 | A1-50 | C1-50 | 0.9 | 5021 | 172.3 | 9 | A |
| Ex 1-51 | A1-51 | C1-51 | 0.9 | 5198 | 185.6 | 15 | A |
| Ex 1-52 | A1-52 | C1-52 | 0.9 | 5321 | 189.3 | 12 | A |
| Ex 1-53 | A1-53 | C1-53 | 0.9 | 5438 | 180.6 | 13 | A |
| Ex 1-54 | A1-54 | C1-54 | 0.9 | 5032 | 179.5 | 13 | A |
| Ex 1-55 | A1-55 | C1-55 | 0.9 | 5114 | 184.5 | 12 | A |
| Ex 1-56 | A1-56 | C1-56 | 0.9 | 58471 | 1,201.2 | 12 | A |
| Ex 1-57 | A1-57 | C1-57 | 0.9 | 59382 | 1,108.3 | 12 | A |

TABLE 36

| | | | | The | | | |
|---|---|---|---|---|---|---|---|
| | | | | number | The sum of | | |
| | | | | of | circumferences | | |
| | | | | second | of second | | |
| | | | | phase | phase | | |
| | | | | particles | particles | | |
| | | | | having | having | | |
| | | | | the longest | the longest | | |
| | | | | diameter of | diameter of | Average | |
| | | | Cooling | 4 μm or | 4 μm or | crystal | |
| | | Alloy | speed | more and | more and | grain | |
| | | No. | at the | 30 μm | 30 μm | size | |
| | Alloy | (metal | time of | or less | or less | at the | |
| | No. | coating | casting | (particles/ | (mm/ | surface | Disk |
| | (substrate) | film) | (° C./s) | mm²) | mm²) | (μm) | fluttering |
| C Ex 1-1 | AC1-1 | CC1-1 | 0.4 | 43 | 3.0 | 68 | D |
| C Ex 1-2 | AC1-2 | CC1-2 | 0.3 | 15 | 0.8 | 65 | D |
| C Ex 1-3 | AC1-3 | CC1-3 | 0.5 | 18 | 1.0 | 67 | D |
| C Ex 1-4 | AC1-4 | CC1-4 | 0.5 | 121 | 2.4 | 93 | D |
| C Ex 1-5 | AC1-5 | CC1-5 | 0.3 | 141 | 5.4 | 58 | D |
| C Ex 1-6 | AC1-6 | CC1-6 | 0.5 | 101 | 3.2 | 65 | D |
| C Ex 1-7 | AC1-7 | CC1-7 | 0.5 | 171 | 2.8 | 54 | D |
| C Ex 1-8 | AC1-8 | CC1-8 | 1056.4 | 81 | 1.2 | 54 | D |
| C Ex 1-9 | AC1-9 | CC1-9 | 0.5 | 121 | 2.1 | 61 | D |
| C Ex 1-10 | AC1-10 | CC1-10 | 0.3 | 69 | 1.0 | 48 | D |
| C Ex 1-11 | AC1-11 | CC1-11 | 0.5 | 110 | 2.3 | 56 | D |
| C Ex 1-12 | AC1-12 | CC1-17 | 0.3 | 115 | 2.1 | 52 | D |
| C Ex 1-13 | AC1-13 | CC1-13 | 0.5 | 5 | 0.2 | 54 | D |

In Comparative Examples 1-1 to 1-13, the sum of the circumferences of the second phase particles having the longest diameter of 4 μm or more and 30 μm or less in the metal microstructure was less than 10 mm/mm², and the fluttering characteristics were poor.

Contrary to the above, as shown in Tables 34 to 36, satisfactory fluttering characteristics were obtained in Examples 1-1 to 1-57.

Having described our invention as related to the present embodiments, it is our intention that the invention not be limited by any of the details of the description, unless otherwise specified, but rather be construed broadly within its spirit and scope as set out in the accompanying claims.

This application claims priority on Patent Application No. 2016-088719 filed in Japan on Apr. 27, 2016, and Patent Application No. 2016-097439 filed in Japan on May 13, 2016, each of which is entirely herein incorporated by reference.

1. An aluminum alloy substrate for a magnetic disk,
wherein the sum of the circumferences of second phase particles having the longest diameter of 4 μm or more and 30 μm or less in the metal microstructure is 10 mm/mm² or more.

2. The aluminum alloy substrate for a magnetic disk according to claim 1, which contains at least one or two or more elements selected from the group consisting of:
0.10 mass % or more and 24.00 mass % or less of Si,
0.05 mass % or more and 10.00 mass % or less of Fe,
0.10 mass % or more and 15.00 mass % or less of Mn, and
0.10 mass % or more and 20.00 mass % or less of Ni,
with the balance being aluminum and inevitable impurities; and
which satisfies the relationship of (Si+Fe+Mn+Ni)≥0.20 mass %.

3. The aluminum alloy substrate for a magnetic disk according to claim 2, which further contains one or two or more elements selected from the group consisting of:
0.005% by mass or more and 10.000% by mass or less of Cu,
0.100% by mass or more and 6.000% by mass or less of Mg,
0.010% by mass or more and 5.000% by mass or less of Cr, and
0.010% by mass or more and 5.000% by mass or less of Zr.

4. The aluminum alloy substrate for a magnetic disk according to claim 2, which further contains:
0.0001% by mass or more and 0.1000% by mass or less of Be.

5. The aluminum alloy substrate for a magnetic disk according to claim 2, which further contains one or two or more elements selected from the group consisting of:
0.001% by mass or more and 0.100% by mass or less of Na,
0.001% by mass or more and 0.100% by mass or less of Sr, and
0.001% by mass or more and 0.100% by mass or less of P.

6. The aluminum alloy substrate for a magnetic disk according to claim 2, which further contains one or two or more elements selected from the group consisting of:
Pb, Sn, In, Cd, Bi, and Ge, each at a content of 0.1% by mass or more and 5.0% by mass or less;

7. The aluminum alloy substrate for a magnetic disk according to claim 2, which further contains:
0.005% by mass or more and 10.000% by mass or less of Zn.

8. The aluminum alloy substrate for a magnetic disk according to claim 2, which further contains one or two or more elements selected from the group consisting of:
Ti, B, and V at a total content of 0.005% by mass or more and 0.500% by mass or less.

9. The aluminum alloy substrate for a magnetic disk according to claim 1,
wherein the average value of the crystal grain size at the surface is 70 μm or less.

10. The aluminum alloy substrate for a magnetic disk according to claim 1,
which has a pure Al coating film or an Al—Mg-based alloy coating film on both surfaces.

11. The aluminum alloy substrate for a magnetic disk according to claim 10,
which has a metal coating film having a thickness of 10 nm or more and 3,000 nm or less on both surfaces.

12. The aluminum alloy substrate for a magnetic disk according to claim 1,
which has an electroless Ni—P plating-treated layer and a magnetic layer thereon, on the surface.

13. A method of producing the aluminum alloy substrate for a magnetic disk according to claim 1, which includes:
a casting step of casting an ingot using the aluminum alloy;
a hot-rolling step of subjecting the ingot to hot-rolling;
a cold-rolling step of subjecting the thus hot-rolled sheet to cold-rolling;
a disk blank punching step of punching the thus cold-rolled sheet into an annular shape; and
a compressed annealing step of subjecting the thus punched disk blank to compressed annealing.

14. The method of producing the aluminum alloy substrate for a magnetic disk according to claim 13, which further includes:
a homogenization heat treatment step of subjecting the ingot to a homogenization heat treatment, between the casting step and the hot-rolling step.

15. The method of producing the aluminum alloy substrate for a magnetic disk according to claim 13, which further includes:
an annealing treatment step of annealing the thus rolled sheet before or in the middle of the cold-rolling.

16. A method of producing the aluminum alloy substrate for a magnetic disk according to claim 10, which includes:
a core alloy casting step of casting an ingot for a core alloy using the aluminum alloy;
a skin alloy casting step of casting an ingot for a skin alloy using pure Al or an Al—Mg-based alloy;
a skin alloy step of subjecting the ingot for the skin alloy to a homogenization treatment and then to hot-rolling, and thereby obtaining the skin alloy;
a laminated material step of cladding both surfaces of the ingot for the core alloy respectively with the skin alloy, and thereby obtaining a laminated material;
a hot-rolling step of hot-rolling the thus laminated material;
a cold-rolling step of cold-rolling the thus hot-rolled sheet;
a disk blank punching step of punching the thus cold-rolled sheet into an annular shape; and
a compressed annealing step of subjecting the thus punched blank to compressed annealing.

17. The method of producing the aluminum alloy substrate for a magnetic disk according to claim 16, which further includes:
a homogenization heat treatment step of subjecting the thus laminated material to a homogenization heat treatment, between the laminated material step and the hot-rolling step.

18. The method of producing the aluminum alloy substrate for a magnetic disk according to claim 16, which further includes:
an annealing treatment step of annealing the thus rolled plate before or in the middle of the cold-rolling.
